(19) United States
(12) Patent Application Publication
(10) Pub. No.: US 2016/0202863 A1
(43) Pub. Date: Jul. 14, 2016

(54) SYSTEMS, METHODS AND APPARATUS FOR PROVIDING TO A MOBILE COMMUNICATION DEVICE A GRAPHICAL REPRESENTATION OF COMPARATIVE PERFORMANCE DATA FOR ONE OR MORE PRODUCTION FACILITIES IN A CLOSED-LOOP PRODUCTION MANAGEMENT SYSTEM

(71) Applicant: QuipIP, LLC, Pittsburgh, PA (US)

(72) Inventors: Farrokh F. RADJY, Pittsburgh, PA (US); Anousha RADJY, Pittsburgh, PA (US)

(21) Appl. No.: 14/992,767

(22) Filed: Jan. 11, 2016

Related U.S. Application Data
(60) Provisional application No. 62/102,325, filed on Jan. 12, 2015.

(51) Int. Cl. G06F 3/0484; G05B 15/02

(52) U.S. Cl. CPC G06F 3/0484; G05B 15/02

(57) ABSTRACT

An identifier of a first production facility is received. Information related a plurality of production facilities that includes the first production facility is retrieved from a memory. A device is caused to display a first indicator indicating a percentage of batches of concrete produced at the first production facility in which a first quantity of a selected component is within a specified tolerance. A selected color is caused to appear in at least a portion of the first indicator, the selected color being selected based on the percentage. The device is caused to display, proximate the first indicator, a second indicator identifying a second production facility having a highest percentage of batches produced in which a second quantity of the selected component is within the specified tolerance, among the plurality of production facilities.

### CROSS REFERENCE TO RELATED APPLICATION

This application claims the benefit of U.S. Provisional Patent Application No. 62/102,325 filed on Jan. 12, 2015, which is incorporated by reference herein in its entirety for all purposes.

### TECHNICAL FIELD

This specification relates generally to real-time systems and methods for managing a production system, and more particularly to real-time systems and methods for providing a graphical representation of statistical performance data for one or more production facilities in a production management system.

### BACKGROUND

In many industries, consumers order a product based on a specification, and subsequent to their order, the product is manufactured based on a formulation that specifies a plurality of components and a particular method, procedure, or recipe to be followed. Once the product is made, it is shipped by the producer to the consumer. In such industries where an order is placed prior to manufacturing, orders are based on expected characteristics and costs of the product. When the product is made at a later date, it is important that the product be made and delivered according to the expected characteristics and costs.

In practice, however, changes often occur during the manufacturing and shipping process due to a variety of factors, such as an unavailability of components, a failure to include the correct quantity of a component specified in the recipe, or the addition of a component that is not listed in or is consistent with the formulation. Such changes may occur due to human error, either accidental or deliberate, or due to formulations being maintained in a non-normalized fashion such as in multiple disconnected systems, or due to malfunction of a device involved in the production system, or due to unforeseen events. Furthermore, a component specified in the formulation may be incorrectly batched, or knowingly or unknowingly replaced with assumed equivalent components because the raw materials are not available, or for other reasons. One well known example is the use of either sucrose or high fructose corn syrup in soft drinks. Typically, during production of a soft drink, one of these two sweeteners is selected and used depending upon the cost and availability of the sweetener at the time when the soft drink product is manufactured.

Similar practices are used in the ready mix concrete industry. A given mixture of concrete, defined by a particular formulation (specifying types of components and quantities thereof), may be produced differently at different production facilities and/or at different times, depending on a variety of factors. For example, the types and quantities of cement and Pozzolanic cementitious materials, chemicals, different types of aggregates used often varies between batches, due to human error, or for reasons which may be specific to the time and location of production. Some components may not be available in all parts of the world, a component may be incorrectly batched, components may be replaced deliberately or accidentally, etc. Furthermore, in the ready mix concrete industry, it is common for changes in the mixed composition to occur during transport of the product. For example, water and/or chemicals may be added due to weather, or due to the length of time spent in transit to the site where the ready mix concrete is poured, or due to customer demands. Changes to a mixture may also occur during the batching process. For example, an incorrect amount of a critical component such as water or cementitious may be added. Similarly, an incorrect amount of fly ash or other pozzolans, such as slag, may be used to make the cementitious portion.

Due to the reasons set forth above, a customer often receives a product which differs from the product ordered. The quality of the product may not meet expectations. Furthermore, any change made to a product may impact the producer's cost and profits.

In addition, in many industries, various activities important to a producer's business, such as sales, purchasing of raw materials, production, and transport, are conducted independently of one another. The disjointed nature of the sales, purchasing of raw materials, production, and transport creates an additional hindrance to the producer's, and the customer's, ability to control the quality and cost of the final product.

Accordingly, there is a need for improved production management systems that provide, to producers and to customers, greater control over various aspects of the production system used to produce a product, and thereby provide greater control over quality and costs.

### SUMMARY

In accordance with various embodiments, real-time operational systems, and related methods and apparatus, are provided which benchmark production and/or manufacturing accuracy and/or consistency data, quality and cost, scores various production processes, and provide a variety of real-time gauges for selected metrics for use by producers, customers, and/or operating personnel. The systems, methods, and apparatus described herein are applicable to any production or transportation system in which a formulation-based product may be modified during production and/or transport/delivery.

In accordance with an embodiment, a production management system is provided. The production management system is used in the production of a product made from a formulation specifying a mixture of individual components, where the customer orders the product prior to its manufacture. System and methods described herein allow a user to manage costs, and the quality of the product, from the point of order, through the production process, transport of the product, and delivery of the product to the customer. In one embodiment, a master database module communicates with the sales, purchasing, manufacturing and shipping systems to monitor and control costs and quality of the product at various stages in the sales, production, and delivery cycles.

In one embodiment, systems used for sales, purchasing of raw materials, manufacturing of the product, and shipping of a product are tied together to allow for the management and control of cost and quality of the product. Systems and methods described herein allow for different ownership of different data while allowing others to use the data so as to perform their function. Thus, a user may own the mixture data but allow the manufacturer to use the mixture data in order to make the product. Such ownership is accomplished by having a single gateway to add data to the system and by using a single master database.

By using a single master database which stores all of the data relating to the mixture, the components to make the mixture, the method to make the mixture, specifics about the products to include its costs, sales process and price agreements, methods of shipment as well as costs associated with each one of these items, quality and costs are managed during production.

Furthermore, changes made at any point during the manufacturing process are transmitted to the master database so that a record is maintained on the product. This allows real time costs and real time quality control of the product. Thus, variations are minimized between budget goals and operations, both theoretically and actually.

In addition, alerts may be issued when the actual values vary from the theoretical values. Thus, if one component is replaced with an equivalent, the master database is notified and an alert may be generated if the replacement component is not within specified tolerances, or is not recognized by the master database. Alternatively, if one or more components are batched in the manufacturing process in amounts exceeding specified tolerances as compared to the target, theoretical amounts for each component, then an alert may be issued.

By tying together the systems used for sales, purchasing of components and raw materials, maintaining formulations of mixtures, production of the mixtures and products and the shipping of the products, through a master database, improved management of quality and costs may be achieved.

Actual and theoretical data may be captured and stored in the master database. For example, statistical data for each batch produced at a particular production facility may be generated and stored. Comparisons between theoretical formulation and actual physical values are made and alerts are generated when the actual falls outside the tolerances set with respect to the theoretical values. Such alerts are done in real time because each of the separate units used for purchasing, manufacturing and transport provide feedback to the master database.

In another embodiment, comparative statistical information may also be generated for a plurality of production facilities, and benchmarks may be established in order to provide information that may be used by a producer to improve the efficiency of one or more production facilities.

In accordance with an embodiment, a method of managing a production system is provided. For each of a plurality of production facilities, a series of operations is performed. For each of a plurality of batches of a concrete mixture produced at the respective production facility based on a formulation, a first difference between a measured quantity of cementitious and a first quantity specified in the formulation is determined. A first standard deviation is determined based on the first differences. For each of the plurality of batches, a second difference between a measured quantity of water and a second quantity specified in the formulation is determined. A second standard deviation is determined based on the second differences. The first and second differences may be expressed as a percentage or as a real number, for example. A first benchmark is selected from among the first standard deviations, and a second benchmark is selected from among the second standard deviations. An amount by which costs may be reduced by improving production at the production facility to meet the first and second benchmarks is determined.

In another embodiment, the plurality of production facilities are managed by a producer. The producer is allowed to access, via a network, in real time, a page showing the first differences, the second differences, the first benchmark, the second benchmark, and the amount by which costs may be reduced.

In some embodiments, a user is allowed access to a graphical representation of statistical performance data for one or more production facilities. For example, in accordance with one embodiment, a method of managing a production management system is provided. A series of operations is performed for each of a plurality of batches of a product produced at a production facility. The batches are produced based on a formulation specifying a first quantity of a component. The operations include determining a second quantity of the component in the batch actually produced, determining a difference between the second quantity and the first quantity, and determining whether the difference is within a predetermined tolerance. The operations also include updating, in real time, a statistic representing a percentage of batches produced at the production facility for which the difference is within the tolerance, based on the difference, and providing to a user, in real time, access to the updated statistic.

In one embodiment, access to a web page displaying a graphical indicator of the statistic is provided to a user. The graphical indicator may comprise a graphical representation of a gauge comprising a range of percentage values and an indicator indicating the statistic. The web page may also display information identifying each of the plurality of batches and the respective difference associated with each respective batch. The web page may further display performance data for a plurality of second production facilities different from the production facility.

The product may be, for example, a chemical compound, a chemical-based product, a petroleum-based product, a food product, a pharmaceutical drug, a concrete mixture, a hydraulic fracturing (“FRACKING”) mixture, a paint mixture, a fertilizer mixture, a polymeric plastic formulation, etc.

In accordance with another embodiment, a production management system is provided. The system includes a memory storing performance data relating to batches of a product produced at a production facility, and a processor configured to perform a series of operations for each of a plurality of batches of the product produced at the production facility, the batches being produced based on a formulation, the formulation specifying a first quantity of a component. The operations include determining a second quantity of the component in the batch actually produced, determining a difference between the second quantity and the first quantity, and determining whether the difference is within a predetermined tolerance. The operations also include updating, in real time, a statistic representing a percentage of batches produced at the production facility for which the difference is within the tolerance, based on the difference, the statistic being stored in the memory, and provide to a user, in real time, access to the updated statistic.

In accordance with another embodiment, a method of managing data relating to a production management system is provided. First performance data relating to a first plurality of batches of a first product produced at a first production facility located at a first location are updated, in real time, based on first information relating to a first batch produced at the first production facility. Second performance data relating to a second plurality of batches of a second product produced at a second production facility located at a second location are updated, in real time, based on second information relating to a second batch produced at the second production facility. A first indicator associated with the first production facility and a second indicator associated with the second production facility are displayed on a web page. A first selection of the first indicator is received from a user device. The user device displays the first performance data in response to the first selection of the first indicator. A second selection of the second indicator is received from the user device. The user device displays the second performance data in response to the second selection of the second indicator.

In accordance with another embodiment, a method of providing information to a user is provided. An identifier of a first production facility is received. Information related a plurality of production facilities that includes the first production facility is retrieved from a memory. A device, which may be a mobile device such as a cell phone, for example, is caused to display a first indicator indicating a percentage of batches of concrete produced at the first production facility in which a first quantity of a selected component is within a specified tolerance. The first indicator may include a graphical component and a numerical component, for example. A selected color is caused to appear in at least a portion of the first indicator, the selected color being selected based on the percentage. The device is caused to display, proximate the first indicator, a second indicator identifying a second production facility having a highest percentage of batches produced in which a second quantity of the selected component is within the specified tolerance, among the plurality of production facilities.

In one embodiment, a user is prompted, via a page displayed on a device, to enter the identifier of the first production facility. The identifier of the first production facility is received from the device, via a network.

In another embodiment, the plurality of production facilities comprises a plurality of plants that produce concrete.

In another embodiment, the first indicator comprises a circular element and a numerical value overlaid on the circular element, the numerical value being equal to the percentage. In another embodiment, the device is caused to display a third indicator that displays the percentage in a graphical manner, the third indicator comprising a band overlaid around a periphery of the circular element.

In another embodiment, the device is caused to display a fourth indicator indicating a ranking of the first production facility among the plurality of production facilities, based on the percentage.

In another embodiment, the device is caused to display a fifth indicator indicating a percentage of batches of concrete produced at the first production facility, during a previous day, in which the first quantity of the selected component is within the specified tolerance.

In another embodiment, for each of a plurality of components, the following steps are performed: the device is caused to display a respective first indicator indicating a respective percentage of batches of concrete produced at the first production facility in which a respective first quantity of the respective component is within a respective tolerance, a respective selected color is caused to appear in at least a portion of the respective first indicator, the respective selected color being selected based on the respective percentage, and the device is caused to display, proximate the respective first indicator, a respective second indicator identifying a respective second production facility having a respective highest percentage of batches produced in which a respective second quantity of the respective selected component is within the respective tolerance, among the plurality of production facilities.

In another embodiment, the selected component is one of cement, water, cementitious, course aggregate, and fine aggregate.

In another embodiment, a first color is associated with a first range of percentages, and a second color is associated with a second range of percentages.

In accordance with another embodiment, a system for providing information to a user is provided. The system includes a memory and a processor. The memory is adapted to store information related to a plurality of production facilities including a first production facility. The processor is adapted to receive an identifier of a first production facility, retrieve from the memory information related to the plurality of production facilities, and cause a user device to display a first indicator indicating a percentage of batches of concrete produced at the first production facility in which a first quantity of a selected component is within a specified tolerance. The processor is further adapted to cause a selected color to appear in at least a portion of the first indicator, the selected color being selected based on the percentage, and cause the user device to display, proximate the first indicator, a second indicator identifying a second production facility having a highest percentage of batches produced in which a second quantity of the selected component is within the specified tolerance, among the plurality of production facilities.

In accordance with another embodiment, a method is provided. An identifier of a production facility is received from a device. Information related to a plurality of batches of a concrete mixture produced at the production facility based on a formula during a selected period of time is retrieved. The device is caused to display information indicating, for each of the plurality of batches, a difference between a first amount of a selected component in the respective batch actually produced and an amount specified in the formula.

These and other advantages of the present disclosure will be apparent to those of ordinary skill in the art by reference to the following Detailed Description and the accompanying drawings.

### BRIEF DESCRIPTION OF THE DRAWINGS

FIG. 1A illustrates a product management system in accordance with an embodiment;

FIG. 1B shows an exemplary menu that may be presented to a customer in accordance with an embodiment;

FIG. 1C is a flowchart of a method of managing a production system in accordance with an embodiment;

FIG. 2 is a flowchart of a method of producing a mixture in accordance with an embodiment;

FIG. 3 is a flowchart of a method of handling an order received from a production facility in accordance with an embodiment;

FIG. 4 illustrates a method of responding to an alert when a production facility replaces an ingredient with a known equivalent, in accordance with an embodiment;

FIG. 5 is a flowchart of a method of responding to an alert indicating a difference between a batched quantity and a specified quantity in accordance with an embodiment;

FIG. 6 is a flowchart of a method of managing transport-related data in accordance with an embodiment;

FIG. 7A shows a production management system in accordance with another embodiment;

FIG. 7B shows a production management system in accordance with another embodiment;

FIG. 7C shows a production management system in accordance with another embodiment;

FIG. 8 illustrates a system for the management of localized versions of a mixture formulation in accordance with an embodiment;

FIG. 9 is a flowchart of a method of generating localized versions of a mixture formulation in accordance with an embodiment;

FIG. 10 shows a mixture formulation and several localized versions of the mixture formulation in accordance with an embodiment;

FIGS. 11A-11B illustrate a system for synchronizing versions of a mixture formulation in accordance with an embodiment;

FIG. 12 is a flowchart of a method of synchronizing a localized version of a mixture formulation with a master version of the mixture formulation in accordance with an embodiment;

FIGS. 13A-13B comprise a flowchart of a method of managing a closed-loop production system in accordance with an embodiment;

FIG. 14 shows an exemplary web page that displays information relating to purchase, production and delivery of a mixture in accordance with an embodiment;

FIG. 15 shows a production management system in accordance with another embodiment;

FIGS. 16A-16B comprise a flowchart of a method of producing and analyzing a mixture in accordance with an embodiment;

FIG. 17 is a flowchart of a method of producing a formulation-based mixture in accordance with an embodiment;

FIG. 18 is a flowchart of a method of determining a measure of concrete strength performance quality for concrete produced at a production facility in accordance with an embodiment;

FIGS. 19A-19B comprise a flowchart of a method of providing comparative statistical information relating to a plurality of production facilities in accordance with an embodiment;

FIG. 20 shows a web page containing statistical information for a plurality of production facilities in accordance with an embodiment;

FIG. 21 shows a tolerances table in accordance with an embodiment;

FIG. 22 is a flowchart of a method of providing statistical performance data in accordance with an embodiment;

FIG. 23 is a flowchart of a method of maintaining statistical performance data for a concrete mixture production facility in accordance with an embodiment;

FIG. 24 shows an exemplary batch table in accordance with an embodiment;

FIG. 25 shows a performance data table that may be maintained for a particular production facility in accordance with an embodiment;

FIG. 26 shows a web page displaying a gauge that shows performance data generated for batches produced at a production facility;

FIG. 27 shows a performance data table that may be used to store performance data for a plurality of production facilities in accordance with an embodiment;

FIG. 28A is a flowchart of a method of managing performance data for a plurality of production facilities in accordance with an embodiment;

FIG. 28B shows a web page displaying performance data for a plurality of production facilities in accordance with an embodiment;

FIG. 28C shows a web page displaying performance data for a plurality of production facilities in accordance with an embodiment;

FIG. 29 shows a web page that may be provided in accordance with another embodiment;

FIG. 30 is a flowchart of a method of generating performance data in accordance with fuzzy logic principles, in accordance with an embodiment;

FIG. 31 shows a gauge that may be displayed on a web page in accordance with an embodiment;

FIG. 32 shows a user device and a menu of options displayed on the user device in accordance with an embodiment;

FIG. 33 is a flowchart of a method of providing comparative statistical performance data in accordance with an embodiment;

FIG. 34A shows a table containing comparative statistical performance data displayed on a user device in accordance with an embodiment;

FIG. 34B shows a table containing comparative statistical performance data displayed on a user device in accordance with another embodiment;

FIG. 35 is a flowchart of a method of providing comparative statistical performance data in accordance with an embodiment;

FIG. 36 shows several fields for specifying a request for information, displayed on a user device in accordance with an embodiment;

FIG. 37 shows an example of an indicator representing statistical performance data in a graphical manner in accordance with an embodiment;

FIG. 38A shows a plurality of indicators displayed on a user device in accordance with an embodiment;

FIG. 38B shows a plurality of indicators displayed on a user device in accordance with another embodiment;

FIG. 39 is a high-level block diagram of an exemplary computer that may be used to implement certain embodiments;

FIG. 40 is a flowchart of a method of providing performance data for a production facility in accordance with an embodiment;

FIG. 41A shows a user device displaying a table that includes performance data for a production facility in accordance with an embodiment; and

FIG. 41B shows a user device displaying a graph that shows performance data for a production facility in accordance with an embodiment.

### DETAILED DESCRIPTION

In accordance with embodiments described herein, systems and methods of managing a closed-loop production management system used for production and delivery of a formulation-based product are provided. Systems, apparatus and methods described herein are applicable to a number of industries, including, without limitation, the food manufacturing industry, the paint industry, the fertilizer industry, the chemicals industry, the oil refining industry, the pharmaceuticals industry, agricultural chemical industry and the ready mix concrete industry.

In accordance with an embodiment, a method of managing a closed loop production system is provided. An order relating to a formulation-based product is received, wherein fulfilling the order requires production of the formulation-based product at a first location, transport of the formulation-based product in a vehicle to a second location different from the first location, and performance of an activity with respect to the formulation-based product at the second location. First information relating to a first change made to the formulation-based product at the first location is received, from the first location, prior to transport of the formulation-based product. Second information relating to a second change made to the formulation-based product during transport of the formulation-based product is received during transport of the formulation-based product. Third information relating to the activity performed with respect to the formulation-based product at the second location is received from the second location. The first, second, and third information are stored in a data structure, and may be displayed with an analysis of the impact of selected information on the cost of the product.

In one embodiment, the processor operates within a product management system comprising a plurality of modules operating at independent locations associated with various stages of the ordering, production, transport and delivery of the product.

In accordance with an embodiment, the product is a formulation-based product. In one embodiment, the product is a formulation-based concrete product. In other embodiments, the formulation-based product may be any type of product that is manufactured based on a formulation. For example, the formulation-based product may be a chemical compound or other type of chemical-based product, a petroleum-based product, a food product, a pharmaceutical drug, etc. Systems, apparatus and methods described herein may be used in the production of these and other formulation-based products.

In another embodiment, statistical information concerning a plurality of production facilities is generated and provided to a producer and/or a customer. For each of a plurality of production facilities, a series of actions is performed. For each of a plurality of batches of a concrete mixture produced at the respective production facility based on a formulation, a first difference between a measured quantity of cementitious and a first quantity specified in the formulation is determined. A first standard deviation is determined based on the first differences. For each of the plurality of batches, a second difference between a measured quantity of water and a second quantity specified in the formulation is determined. A second standard deviation is determined based on the second differences. A first benchmark is selected from among the first standard deviations, and a second benchmark is selected from among the second standard deviations. An amount by which costs may be reduced by improving production at the production facility to meet the first and second benchmarks is determined.

In accordance with another embodiment, a method of managing data relating to a production management system is provided. First performance data relating to a first plurality of batches of a first product produced at a first production facility located at a first location are updated, in real time, based on first information relating to a first batch produced at the first production facility. Second performance data relating to a second plurality of batches of a second product produced at a second production facility located at a second location are updated, in real time, based on second information relating to a second batch produced at the second production facility. A first indicator associated with the first production facility and a second indicator associated with the second production facility are displayed on a web page. A first selection of the first indicator is received from a user device. The user device displays the first performance data in response to the first selection of the first indicator. A second selection of the second indicator is received from the user device. The user device displays the second performance data in response to the second selection of the second indicator.

In accordance with another embodiment, a method of providing information to a user is provided. An identifier of a first production facility is received. Information related a plurality of production facilities that includes the first production facility is retrieved from a memory. A device, which may be a mobile device such as a cell phone, for example, is caused to display a first indicator indicating a percentage of batches of concrete produced at the first production facility in which a first quantity of a selected component is within a specified tolerance. The indicator may include a graphical component and a numerical component, for example. A selected color is caused to appear in at least a portion of the first indicator, the selected color being selected based on the percentage. The device is caused to display, proximate the first indicator, a second indicator identifying a second production facility having a highest percentage of batches produced in which a second quantity of the selected component is within the specified tolerance, among the plurality of production facilities.

The terms “formulation,” “recipe,” and “design specification” are used herein interchangeably. Similarly, the terms “components” and “ingredients” are used herein interchangeably.

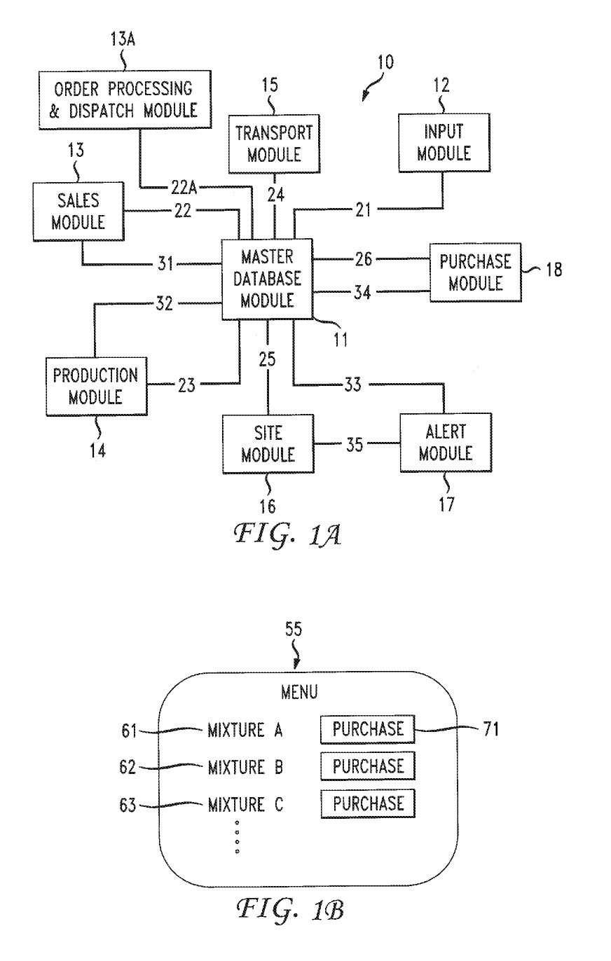

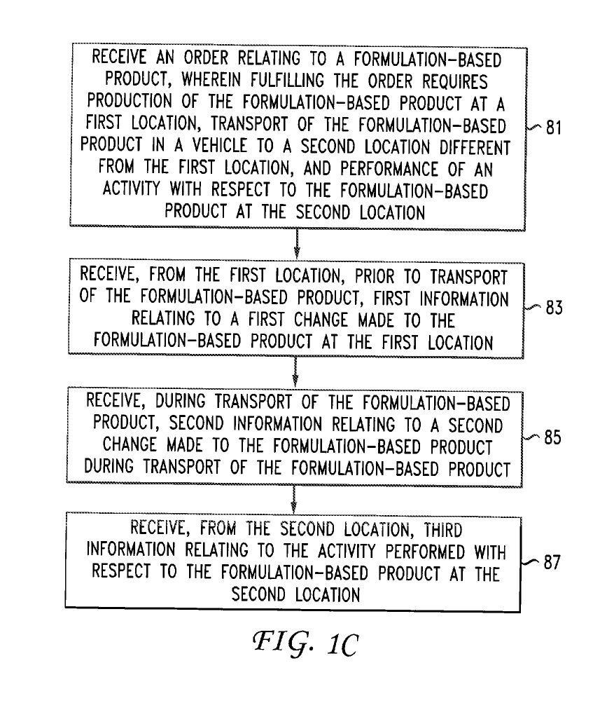

FIG. 1A illustrates a production management system in accordance with an embodiment. Product management system 10 includes a master database module 11, an input module 12, a sales module 13, an order processing & dispatch module 13A, a production module 14, a transport module 15, a site module 16, an alert module 17 and a purchasing module 18.

Master database module 11 may be implemented using a server computer equipped with a processor, a memory and/or storage, a screen and a keyboard, for example. Modules 12-18 may be implemented by suitable computers or other processing devices with screens for displaying and keep displaying data and keyboards for inputting data to the module.

Master database module 11 maintains one or more product formulations associated with respective products. In the illustrative embodiment, formulations are stored in a database; however, in other embodiments, formulations may be stored in another type of data structure. Master database module 11 also stores other data related to various aspects of production management system 10. For example, master database module may store information concerning acceptable tolerances for various components, mixtures, production processes, etc., that may be used in system 10 to produce various products. Stored tolerance information may include tolerances regarding technical/physical aspects of components and processes, and may also include tolerances related to costs. Master database module 11 may also store cost data for various components and processes that may be used in system 10.

Each module 12-16 and 18 transmits data to master database module 11 by communication lines 21-26, respectively. Master database module 11 transmits data to modules 13, 14, 17 and 18 by communication lines 31-34, respectively. Order processing & dispatch module is linked to master database module via communication line 22A. Each communication line 21-26 (including line 22A) and 31-34 may comprise a direct communication link such as a telephone line, or may be a communication link established via a network such as the Internet, or another type of network such as a wireless network, a wide area network, a local area network, an Ethernet network, etc.

Alert module 17 transmits alerts to the producer and/or customers by communication line 35 to site module 16.

Master database module 11 stores data inputted from modules 12-16 and 18. Master database module 11 stores data in a memory or storage using a suitable data structure such as a database. In other embodiments, other data structures may be used. In some embodiments, master database module 11 may store data remotely, for example, in a cloud-based storage network.

Input module 12 transmits to master database module 11 by communication line 21 data for storage in the form of mixture formulations associated with respective mixtures, procedures for making the mixtures, individual ingredients or components used to make the mixture, specifics about the components, the theoretical costs for each component, the costs associated with mixing the components so as to make the product or mixture, the theoretical characteristics of the product, acceptable tolerances for variations in the components used to make the product, the time for making and delivering the product to the site and costs associated shipping the product.

The terms “product” and “mixture” are used interchangeably herein.

Data transmitted by input module 12 to master database module 11 and stored in master database module 11 may be historical in nature. Such historical data may be used by the sales personnel through sales module 13 to make sales of the product.

In one embodiment, sales module 13 receives product data by communication line 31 from master database module 11 relating to various products or mixtures that are managed by system 10, the components that make up those products/mixtures, the theoretical costs associates with the components, making the mixture and delivery of the mixture, times for delivery of the mixture and theoretical characteristics and performance specifications of the product. Order processing & dispatch module 13A processes orders and handles certain dispatching activities.

Sales module 13 may present all or a portion of the product data to a producer and/or customer in the form of a menu of options. FIG. 1B shows an exemplary menu 55 that may be presented to a producer and/or customer in accordance with an embodiment. Menu 55 comprises a list of mixtures available for purchase, including Mixture A (61), Mixture B (62), Mixture C (63), etc. Each mixture shown in FIG. 1B represents a product offered for sale. For example, each mixture may be a respective concrete mixture that may be purchased by a customer. Menu 55 is illustrative only; in other embodiments, a menu may display other information not shown in FIG. 1B. For example, a menu may display the components used in each respective mixture, the price of each mixture, etc.

From the menu, the producer and/or customer may choose one or more products to purchase. For example, a producer and/or customer may purchase Mixture A (61) by selecting a Purchase button (71). When the producer and/or customer selects a mixture (by pressing Purchase button (71), for example), sales module 13 generates an order for the selected mixture and transmits the order by communication line 22 to master database module 11. The order may specify the mixture selected by the producer and/or customer, the components to be used to make the selected mixture, a specified quantity to be produced, the delivery site, the delivery date for the product, etc. An order may include other types of information.

In accordance with an embodiment, the producer and/or customer may input a specialty product into system 10. Such input may be accomplished through input module 12.

Producer and/or customer orders are transmitted to master database module 11. Master database module 11 uses an integrated database system to manage information relating to the orders, as well as the production, transport, and delivery of the ordered products. FIG. 1C is a flowchart of a method of managing a production system in accordance with an embodiment. At step 81, an order relating to a formulation-based product is received, wherein fulfilling the order requires production of the formulation-based product at a first location, transport of the formulation-based product in a vehicle to a second location different from the first location, and performance of an activity with respect to the formulation-based product at the second location. As described above, the producer's and/or customer's order is transmitted to master database module 11. Master database module receives the order from sales module 13, and stores the order.

Based on the order inputted to master database module 11, master database module 11 places a production order for production of the product to production module 14 by communication line 32. Production module 14 is located at a production facility capable of manufacturing the purchased product in accordance with the order.

In the illustrative embodiment, the product is a formulation-based product. Thus, the product may be produced based on a formulation defining a plurality of components and respective quantities for each of the components. The formulation may also specify a method, or recipe, for manufacturing the product. The production order provided to the production module 14 may include the mixture or product to be made, the components to be used to make the mixture or product, the specifics about the individual components, the method to make the mixture and the delivery dates. The product is produced at the production facility and placed in a vehicle for transport to a delivery site specified in the order.

At step 83, first information relating to a first change made to the formulation-based product at the first location is received from the first location, prior to transport of the formulation-based product. If any changes are made to the product at the production facility, production module 14 transmits information relating to such changes to master database module 11. For example, a particular component specified in the formulation may be replaced by an equivalent component. In another example, a quantity of a selected component specified in the formulation may be altered. In another example, an additional component not specified in the formulation may be added. For example, components such as water, cementitious, particular chemicals, particular fibers, etc., may be replaced, added, or their specified quantities may be altered. Master database module 11 receives and stores such information.

At step 85, second information relating to a second change made to the formulation-based product during transport of the formulation-based product is received during transport of the formulation-based product. If any changes are made to the product during transport of the product, transport module 15 transmits information relating to such changes to master database module 11. Master database module 11 receives and stores such information.

Upon arrival at the specified delivery site, the product is delivered. At step 87, third information relating to the activity performed with respect to the formulation-based product at the second location is received from the second location. For example, site module 16 may transmit to master database module 11 information indicating the time of delivery, or information relating to the performance of the product after delivery.

In the illustrative embodiment, information transmitted among modules 11-19, and to a producer and/or customer, may be transmitted in the form of an alert. An alert may be any suitable form of communication. For example, an alert may be transmitted as an electronic communication, such as an email, a text message, etc. Alternatively, an alert may be transmitted as an automated voice message, or in another form.

In one embodiment, information is transmitted to master database module 11 in real time. For example, strict rules may be applied requiring that any information concerning changes to a product that is obtained by any module (including production module 14, purchase module 18, transport module 15, site module 16, etc.) be transmitted to master database module 11 within a predetermined number of milliseconds.

Various embodiments are discussed in further detail below.

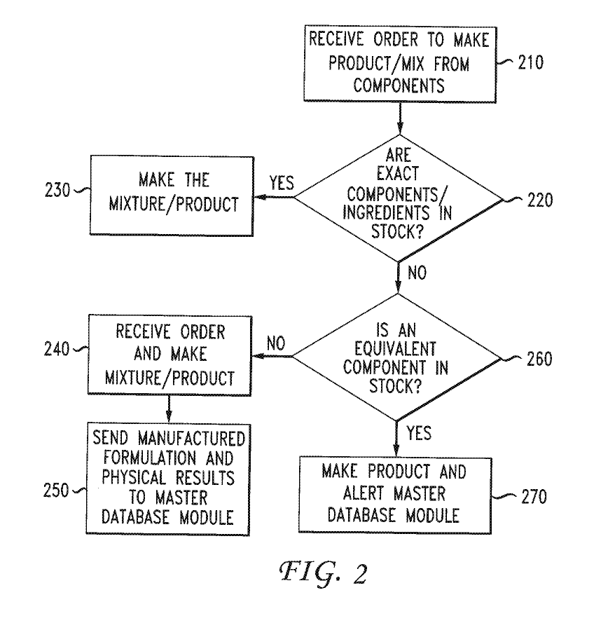

As described above, in some embodiments, the product is made at a production facility in accordance with a predetermined formulation. Production module 14 operates at the production facility and has stored data as to the specifics of the individual components or raw ingredients on hand at the facility. FIG. 2 is a flowchart of a method of producing a mixture in accordance with an embodiment. At step 210, an order to make a product/mixture from specified components is received. Referring to block 220, if the exact components or ingredients are in stock, the production facility proceeds to make the mixture/product (step 230). If the production facility does not have on hand the exact components needed to make the mixture/product, then the method proceeds to step 260 and determines whether an equivalent component is in stock. If an equivalent component is in stock, the method proceeds to step 270. At step 270, production module 14 makes the product using the equivalent component and alerts master database module 11 of the change. Such a replacement may change the cost of the raw materials and/or the characteristics of the mixture/product which is finally made.

Returning to block 260, if there is no equivalent component in stock, the production module 14 may send an order by communication line 32 to master database module 11 for the specified component (or for the equivalent component). When the order is received, production module 14 makes the product (step 240). The manufactured formulation and physical results are sent to master database module 11 (step 250).

In another embodiment, production module 14 alerts master database module 11 if the method of manufacture specified in a mixture formulation is modified. For example, a step of the method may be changed or eliminated, or a new step may be added. Master database module stores information related to the change. Master database module 11 may also determine if the change is within acceptable tolerances and alert the producer and/or customer if it is not within acceptable tolerances. For example, master database module 11 may compare the modified method to stored tolerance information to determine if the modified method is acceptable.

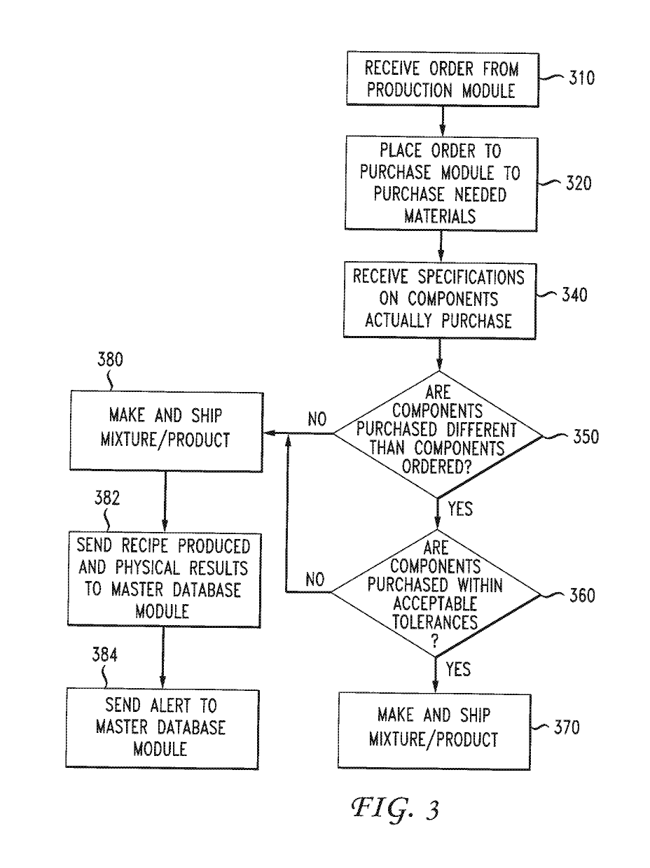

FIG. 3 is a flowchart of a method of handling an order received from a production facility in accordance with an embodiment. At step 310, an order is received from production module 14, by master database module 11. At step 320, master database module 11 places an order by communication line 34 to purchase module 18 to purchase the needed components or raw materials. Purchase module 18 transmits by communication line 26 the specifics of the components that it has purchased and the estimated delivery date to the production facility as well as the costs associated with the component. Purchase module 18 is associated with a raw material/component supply facility. At step 340, master database module 11 receives the specifics on the components actually purchased by purchase module 18.

Referring to block 350, if the components purchased (by purchase module 18) are the same as the order placed, the method proceeds to step 380, and the product is made and shipped to the production facility. At step 382, the recipe produced and the physical results are sent to master database module 11. At step 384, an alert is sent to master database module 11.

Returning to block 350, if the components purchased (by purchase module 18) differ from those specified in the order, the method proceeds to block 360. Master database module 11 compares the components purchased, either those replaced by the production facility or those purchased by the purchase module 18, to stored tolerance information (which may include tolerances regarding physical/technical aspects of a component and/or cost tolerances). Referring to block 360, if the replacement components fall within acceptable tolerances both for performance characteristics and cost, then at step 370, the mixture/product is made is shipped. If the cost or characteristics of the raw ingredients fall outside acceptable tolerances, then the method proceeds to step 380 (described above).

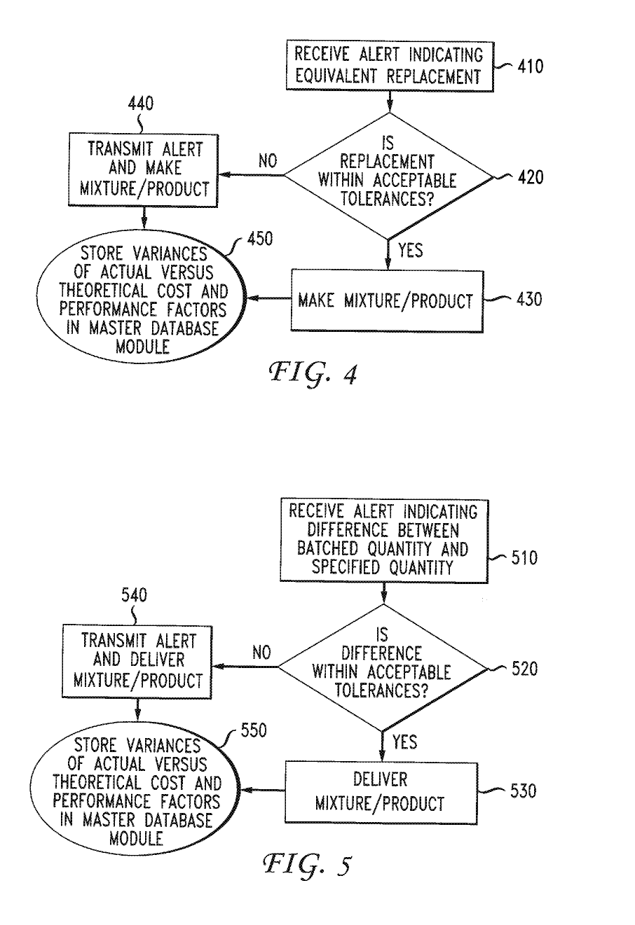

FIG. 4 is a flowchart of a method of responding to an alert in accordance with an embodiment. Specifically, FIG. 4 illustrates a method of responding to an alert when a production facility replaces an exact ingredient with a known equivalent, in accordance with an embodiment. At step 410, an alert indicating an equivalent replacement is received by master database module 11 from production module 14. Referring to block 420, a determination is made by master database module 11 whether the equivalent component is within acceptable tolerances. If the equivalent component is within acceptable tolerances, the method proceeds to step 430 and the product is made. Master database module 11 instructs production module 14 to proceed with manufacturing the mixture. If the equivalent component is not within acceptable tolerances, the method proceeds to step 440. At step 440, and an alert is transmitted and the product is made. For example, an alert may be transmitted by master database module 11 or by alert module 17 to the producer and/or customer.

At step 450, the variances of actual versus theoretical cost and performance factors are stored at master database module 11.

As described above, production module 14 receives instructions from master database module 11, prior to production of a mixture, specifying the recipe and components required for producing the mixture. However, from time to time the batched amounts of each component (i.e., the amount of each component in the batch actually produced) differs from the amounts specified in the recipe received from master database module 11 due to statistical or control factors.

When quantity variances are outside the specified tolerances, alerts are transmitted and the actual amounts produced, and cost variances from target costs, are provided to master database module 11. FIG. 5 is a flowchart of a method of responding to an alert indicating a difference between a batched quantity and a specified recipe quantity in accordance with an embodiment. At step 510, an alert is received indicating a difference between a batched quantity and a specified recipe quantity. The alert typically indicates variances of actual versus theoretical cost and performance factors. Referring to block 520, if the differences are within acceptable tolerances, the method proceeds to step 530 and the product is delivered. If the differences are not within acceptable tolerances, the method proceeds to step 540. At step 540, an alert is transmitted and the product is delivered. An alert may be transmitted to the producer and/or customer, for example. At step 550, the variances of actual versus theoretical cost and performance factors are stored at master database module 11. In other embodiments, variances are not stored.

After production of the mixture, the production facility uses one or more transport vehicles to transport the product/mixture from the production facility to the producer's and/or the customer's site. Such transport vehicles may include trucks, automobiles, trains, airplanes, ships, etc. Each transport vehicle is equipped with a transport module such as transport module 15. Transport module 15 transmits by communication line 24 to master database 11 information concerning the transport of the product/mixture. The information concerning the transport can include changes which are made to the mixture during transport (e.g., addition of water or other chemicals), the length of travel, temperatures during transport, or other events that occur during transport. For example, in the ready mix concrete industry it is common for a truck transporting the mixture from the production facility to a delivery site to add water and/or chemicals during the transport process. Information indicating such addition of chemicals or water is transmitted to master database module 11 by communication line 24. Furthermore, in the ready mix concrete industry, measuring and recording the temperature of the concrete during transport is advantageous for several reasons: (a) such data can be used to determine a maturity value per ASTM c1074; (b) such data, in combination with reference heat of hydration data may be used to determine degree of hydration attained during transport; (c) the data, in combination with reference strength and heat of hydration data may be used to determine pre-placement strength loss due to pre-hydration prior to discharge of the concrete at project site.

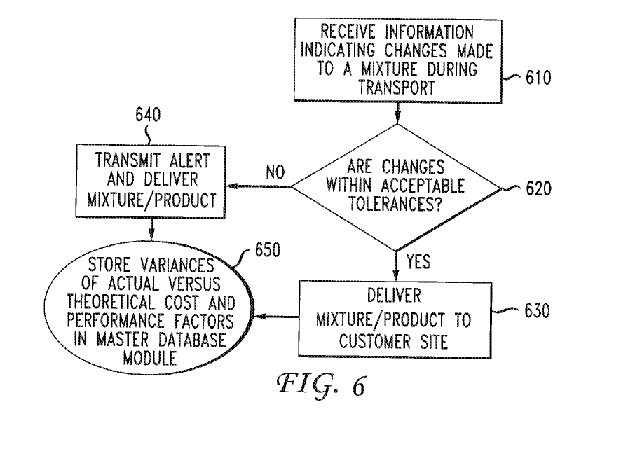

The transport-related information is transmitted by transport module 15 to master database module 11. For example, such information may be transmitted in the form of an alert. The information is analyzed by master database module 11 to determine whether the changes that are made are within acceptable tolerances. FIG. 6 is a flowchart of a method of managing transport-related data in accordance with an embodiment.

At step 610, information indicating changes to a mixture during transport is received from a transport module. For example, master database module 11 may receive an alert from transport module 15 indicating that changes occurred to a mixture during transport of the mixture. Referring to block 620, a determination is made whether the changes are within acceptable tolerances. If the changes are within acceptable tolerances, the method proceeds to step 630. At step 630, the product/mixture is delivered to the producer's and/or customer's site. If the changes are not within acceptable tolerances, the method proceeds to step 640. At step 640, an alert is transmitted to the producer and/or customer and the product/mixture is delivered. Alerts to the producer and/or customer may be issued by alert module 17, or by master database module 11. At step 650, the variances of actual versus theoretical recipe cost and performance factors is stored at master database module 11. In other embodiments, the information concerning changes is not stored.

In the illustrative embodiment, the producer's and/or the customer's site or location is equipped with site module 16, which transmits to master database module 11, by communication line 25, information about the mixture of product that is delivered to the site. Such information may include, for example, information indicating the actual performance of the product/mixture as delivered. Master database module 11 stores the actual performance data. Master database module 11 may provide to the producer and/or customer a report concerning various aspects of the actual product delivered.

Site module 16 may also receive alerts from alert module 17 by communication line 35. In the illustrative embodiment, alert module 17 is a module separate from master database module 11. However, in other embodiments, the functions of alert module 17 may be performed by master database module 11.

Alert module 17 may also transmit final reports concerning the products to site module 16, thereby enabling the seller and the producer and/or customer a way of managing the product. Feedback provided throughout the production process, as illustrated above, advantageously allows the producer and/or customer and the manufacturer to manage costs and quality of the products.

The alert functions described above facilitate the process of managing production and costs. In response to any alert, the producer and/or customer or the manufacturer has the ability to make a decision not to continue the production or delivery of the product because the product has fallen outside of acceptable tolerances.

While the illustrative embodiment of FIG. 1A includes only one production module, one transport module, one site module, one alert module, one purchase module, one input module, and one sales module, in other embodiments, a system may include a plurality of production modules, a plurality of transport modules, a plurality of site modules, a plurality of alert modules, a plurality of purchase modules, a plurality of input modules, and/or a plurality of sales modules. For example, in an illustrative embodiment, suppose that a system used by a company in the ready mix concrete industry includes a master database module 11 residing and operating on a server computer located in Pittsburgh, Pa. The company's sales force may be located in Los Angeles, Calif., where the sales module 13 resides and operates (on a computer). Suppose that a sale is made in Los Angeles, and the purchase order specifies a site in San Francisco, Calif. Thus, master database module 11 may output an order to a production module 14 which is located at a ready mix production facility in the vicinity of San Francisco, Calif. Suppose further that a single production facility in the vicinity of San Francisco cannot handle the volume of the concrete that is needed for the job site in San Francisco. In such a case, master database module 11 may output to a plurality of production facilities, each having a production module 14, the necessary orders for fulfillment. Thus, the system includes a plurality of production modules, one in each of the various production facilities. The production facilities produce the specified mixture and transport the ready mix concrete in a plurality of trucks to the producer site and/or customer site in San Francisco. Each truck has a transport module associated therewith. Suppose that one or more of the production modules does not have the specific components that were specified in the purchase order for the concrete. Thus, adjustments may be made at the production facility to the concrete mixes, and information concerning such adjustments are transmitted back to the master data base module 11. Such adjustment information may be processed in accordance with the steps illustrated in FIGS. 3 and/or 4.

During the transport of the ready mix concrete from the various production facilities, the transport modules 15 in each of the trucks transmit to the master database module 11 any changes made to the mixture. The master database module 11 may then perform the method described FIG. 6. In a similar manner, master database module 11 is informed of any changes occurring during production and, as a result, master database module 11 may perform the method described in FIG. 5.

Finally, the concrete is delivered to the producer and/or customer site in San Francisco and information concerning the delivered concrete may be transmitted to the master database module 11. The site module 16 may also be used to provide the master database module 11 with information relating to one or more of the following: measurements of the actual heat of hydration taken from the fresh state through the hardening process, strength characteristics of the concrete after it is hardened, etc. Advantageously, the feedback provided in this manner to master database module 11 from the various modules enables the producer and/or customer of the concrete in Los Angeles to monitor, on a real time basis, the concrete poured at the producer's and/or customer's construction site in San Francisco, without having to physically be in San Francisco.

Furthermore, the producer and/or customer in Los Angeles may monitor, on a real time basis, costs associated with the concrete which is delivered to the site in San Francisco.

Furthermore, the ready mix concrete producer may associate, in real time, variances in one or more parameters relating to the concrete's performance from specified expectations, and correlate such variances to actual batched versus the expected specified recipe. These capabilities advantageously allow the maintenance of consistent, low standard deviation production batching from a mixture recipe baseline, and production of concrete that has a consistent strength performance with a low standard deviation.

Changes in materials may impact a producer's cost of materials (COM). An increase in COM can in turn impact the producer's profitability. In many instances, any increase (in percentage terms) in the COM results in a much greater impact on profitability (in percentage terms). For example, it has been observed that, using ACI 318 statistical quality criteria, it can be demonstrated that each 1% cement or water variance from the mix design theoretical recipe value can result in a cost impact of around $0.2 to $0.4 per cubic yard. Since such variances can typically range from 2% to 10%, the cost impact may range from $0.4 to $10 per cubic yard annually. This cost impact is a very large percentage of the average profit of a producer in the ready mix concrete industry, which is on the order of $1/cubic yard.

Advantageously, the integrated production management system and method described herein enables a producer to manage the overall production system for ready mix concrete, and allows greater control over changes that may impact the producer's costs (and profits). The integrated production management system and method described herein also provides a producer and/or customer increased control over the producer's and/or customer's construction site. For convenience, several examples relating to the ready mix concrete industry are described below.

### Concrete Construction & Manufacturing/Production Examples

Examples are provided for three different market segments:

A. Ready Mix Concrete

B. Contractors

C. State Authorities

### Closed Loop Solutions (CLS) Overview

Set forth below is a discussion of a closed loop solution (CLS) in accordance with an embodiment. Each operation has a set of theoretical goals and obtained physical or actual results.
Practically all operational IT architectures include a collection of disparate information systems that need to work together.
CLS is an information technology solution that enforces:
Data Integrity across linked or associated disparate information systems (Ready Mix Example:
Mix costs & formulae to have data integrity or be the same across mix management, sales, dispatch, batch panels, and business systems)
Closed Loop Data Integrity, meaning that the operations' goals and its actual physical results match within tolerances (concrete batch & mix BOMs (Bill of Materials) closely match)

### Four Types of CLS for Different Market Segments

I. Ready Mix Producers: Closed Loop Integration (CLI):
1) CLI has been implemented as a CLS application for many Ready Mix Producers in the US and Canada.
2) CLI applications are real-time, two-way interfaces with production systems
3) One of the main purposes of CLI is to enforce data integrity between batches in trucks and parent mix designs; CLI closes the loop between the mix management and production cycles.

II. Ready Mix Producers: Closed Loop Sales Management (CLSM):
1) CLSM is a CLS application for Ready Mix Producers in the US and Internationally.
2) One of the main purposes of Closed Loop Sales Management is a project-based workflow for the industry sales process, tracking actual versus target profitability, This application closes the loop between actual and target profitability factors. One benefit is maximization of profitability.

III. Contractors: Closed Loop Quality & Cost:
1) The solution for the Contractor market segment is similar to the Closed Loop Quality application, except that it also includes concrete delivered cost management
2) One of the main purposes of Closed Loop Quality & Cost is a real time enforcement of placed concrete obtained specs and performance to the applicable project specs, plus monitoring placed versus as-purchased cost—This application closes the loop between both the delivered versus specified project concrete performance and cost.

IV. State Authorities: Closed Loop Quality:
1) This solution is intended for the Authorities market segment as a modification of the CLI production driven Ready Mix application
2) One of the main purposes of Closed Loop Quality is a real time enforcement of placed concrete obtained specs and performance to the applicable project specs. This application closes the loop between the delivered versus specified project concrete performance.
   Set forth below are several application examples.

### [A] Ready Mix Concrete Producers—CLS Type: Closed Loop Integration

for real time, production level, consolidated mix management

I. Ready Mix Needs Include:
1) Consolidate critical mix, cost, and quality data in a single database
2) Minimize quality issues
3) Utilize materials efficiently
4) Real time information visibility—customized by user profile

II. Ready Mix Economics & its Management:
1) 50% to 70% of cost of business (COB) is cost of materials (COM)
2) A 1% increase in COM can translate to more than a 10% profitability drop
3) Thus, production level materials management is important to profitability.
   Table 1 shows the relationship between COM and profitability.

TABLE 1

| Item | per Cyd |
|---|---|
| Net Profit % | 5.0% |
| Price | $85.00 |
| Cost of Business (COB) | $80.75 |
| Net Profit | $4.25 |
| Cost of materials (COM) as % of | |
| COB | 55.0% |
| COM | $44.41 |
| 1% increase in COM | $0.44 |
| Change in COB | $0.44 |
| Change in Net profit | ($0.44) |
| % change in net profits per % COM | −10.5% |

III. To meet quality, materials utilization, and information visibility needs:
1) Optimize mixes to performance and cost goals in a consolidated database using mix optimization tools.
2) Implement closed loop integration (CLI) for the production level management of optimized mixes; may use alerts application for alert notification of out-of-tolerance batches.
3) Use CLI to ship concrete to mix baselines for implementing production level, real time cost and quality management. The CLI system in effect uses mixes as a budgetary tool for both quality and cost control.

### [B] Contractors—CLS Type: Closed Loop Cost & Quality

Table 2 Illustrates Advantages of Real Time, Consolidated Costs and Quality Management.

I. Contractor Concrete Related Needs:
1) Consolidate aspects of concrete related data across all projects in a single database.
2) Ensure obtained quality meets specifications in order to minimize quality issues and avoid project delays
3) Track & match up contracted volume & cost versus actual delivered volumes & costs
4) Real time information visibility—customized by user profile

II. Basic Contractor Economics:
1) Concrete cost and quality related schedule delay can amount to around 16% in profit loss.
2) Thus, production level concrete quality and cost management are important to contractor profitability

III. Closed Loop Solution to meet quality, cost management, and information visibility needs:
1) Implement Closed Loop Cost & Quality (CLCQ) for the real time management of obtained versus a) specified performance and recipe factors, b) Actual versus budgeted cost and volume factors; use an alert system for alert reporting & notification of out-of-tolerance monitored variables.
2) For each project, consolidate quality & engineering team, tests, concrete deliveries & poured volumes, cost, project mix designs and specs, project documents, in a single unified database; do this across all of the contractor's projects in one or more countries—makes possible sharing and learning cross project experience
3) Use CLCQ to maintain quality, enforce meeting specs in real time, enforce budgetary cost & volume goals, and create real time, production level visibility including alerting reports.

### Contractor Concrete Economics

1. 10% to 20% of a project cost is concrete cost; in some regions/countries this number may be close to 20%
2. Since contractor margin is on the order of 1% to 5%, a 1% change in concrete cost may result on average in about a 8% profitability drop
3. Additionally, it is import to avoid schedule slippage due to quality issues:
   1. Each delay day may represent roughly 0.2% to 1% of total project cost—assume 0.2%
   2. Each delay day due to concrete quality for a $100 mil project may cost $200,000, or roughly an 8% drop in profitability
4. Concrete cost and quality schedule delay may total to around 16% in profit loss.
5. Thus, production level quality and cost management are important to contractor profitability, and the related cost factors can be managed by a closed loop production system
   [C] State authorities—CLS TYPE: Closed Loop Quality
   For real time, consolidated concrete quality management

I. State Authority Key Concrete Related Needs:
1) Consolidate all aspects of concrete related data across all projects in a single database including mix specifications and designs, batch data, and test data, as well as the required QC/QA plan
2) Make possible data access, input, and sharing cross projects, and by project-based entities
3) Ensure obtained quality and performance meet specifications in order to minimize quality issues and avoid project delays
4) Track & match up contracted costs & volumes versus actual values
5) Real time information visibility—customized by project & user profile

II. State Authority Economics—Costs of poor quality and reduced longevity:
1) Assume: $100 mil structure; 30,000 m3 concrete @ $100/m3 delivered
2) Concrete quality related schedule delay costs may amount to $70,000/delay day
3) Poor quality future repair costs may amount to $120,000 per 1% increase in strength CV
4) If the building service life is reduced by one year due to poor quality, then a revenue loss of around $1.25 mil. may result
5) Thus, production level, real time quality and cost management is important to the owner economics
6) These significant cost factors may be managed by the closed loop system

III. To Meet Quality, Cost Management, and Information Visibility Needs:
1) For each project, consolidate concrete production volumes, project mix designs and specifications, and tests in a single database. Also, include the QA/QC plan
2) Make possible data access, input, and sharing across projects. Restrict access by project and user profile. Include: State officials, Engineers/Architects, Contractors, Test Labs, and Ready Mix Producers
3) Implement Closed Loop Quality (CLQ) for the real time management of obtained versus specified performance and recipe factors; use an alert system for alert notification of out-of-tolerance batches. Reconcile tests against QC/QA plan.
4) Create real time, production level visibility including alerting reports.

### State Authority Concrete Economics

### Assume a $100 Mil Structure Requiring 30,000 m3 Concrete @ an Average of $100/m3 Delivered.

1. Suppose that:
   1) The owner wishes to amortize the $100 mil cost during a 10-year period, which amounts to a monthly rate of $833,333, and wishes to lease the building for the same amount
   2) The owner takes a 30 year mortgage @ 5% interest amounting to a monthly payment of $535 k.
   3) This leaves a monthly cash flow of around $300 k, or $3.6 mil/yr
2. Poor Quality Cost Factors include:
   1) Each delay day may result in an opportunity cost of roughly $70,000, or around 2% of annual cash flow
   2) If poor quality goes unnoticed, and is repaired at a later date, each 1% increase in the 28-day strength coefficient of variation from its ACI 318 design base may result in future repair costs of $120 k, or around 7% of the annual cash flow
   3) If poor quality goes unnoticed, and is not treated, each one year reduction in the service life may amount to $3.6 in lost revenues. Annualized over the first 10 years, this changes the monthly cash flow to around a loss of ($60,000)
3. Concrete poor quality costs without a reduction in the service life can amount to around 9% of cash flow; with service life reduction, the cash flow can turn negative.
4. Thus, production level quality management is important to the owner economics, and the related cost factors can be managed by the closed loop system

In accordance with another embodiment, a mixture formulation is maintained by master database module 11. Localized versions of the mixture formulation intended for use at respective production facilities are generated, stored, and provided to the respective production facilities, as necessary. At a respective production facility, the mixture is produced based on the localized version of the mixture formulation.

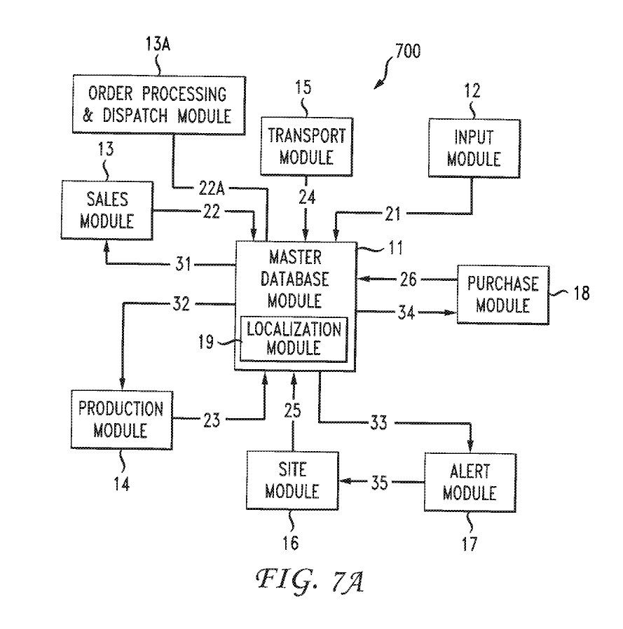

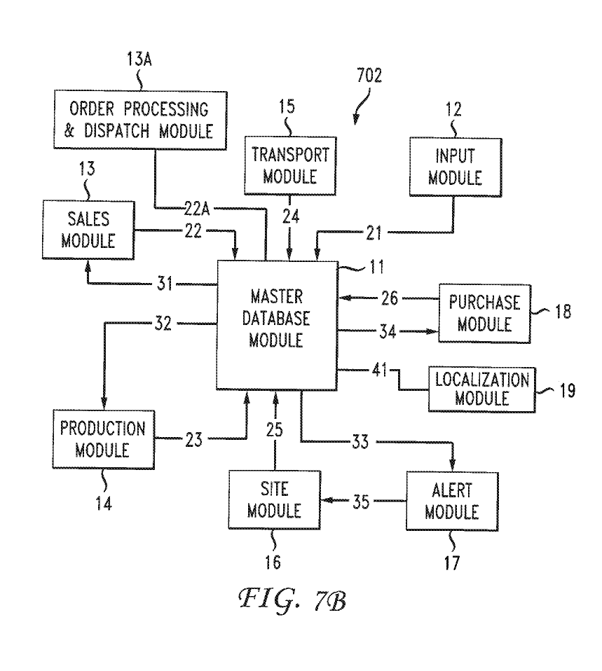

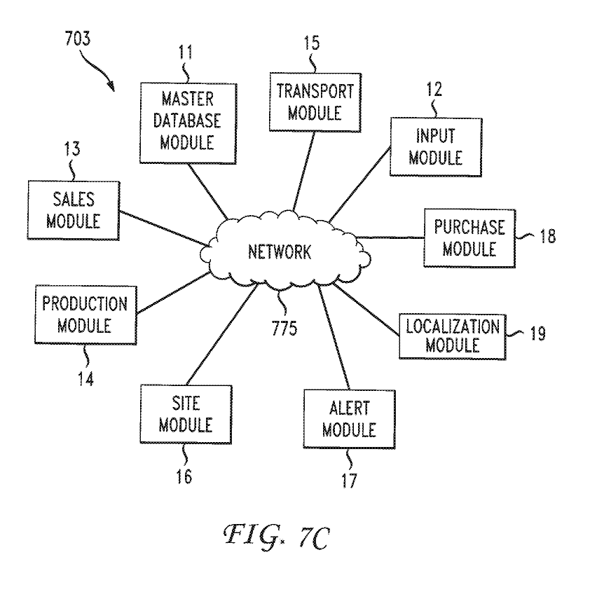

FIG. 7A shows a production management system 700 in accordance with another embodiment. Similar to product management system 10 of FIG. 1A, product management system 700 includes a master database module 11, an input module 12, a sales module 13, an order processing & dispatch module 13A, a production module 14, a transport module 15, a site module 16, an alert module 17, and a purchase module 18.

A localization module 19 resides and operates in master database module 11. For example, master database module 11 and localization module 19 may comprise software that resides and operates on a computer.

Localization module 19 generates one or more localized versions of a mixture formulation for use at respective production facilities where a mixture may be produced. Localization module 19 may, for example, access a mixture formulation maintained at master database module 11, analyze one or more local parameters pertaining to a selected production facility, and generate a modified version of the mixture formulation for use at the selected production facility. Localization module 19 may generate localized versions of a particular mixture formulation for one production facility or for a plurality of production facilities. For example, master database module 11 may generate localized versions of a mixture formulation for every production facility owned or managed by a producer. Likewise, localization module 19 may generate localized versions of selected mixture formulations maintained by master database module 11, or may generate localized versions for all mixture formulations maintained by master database module 11.

FIG. 7B shows a production management system 702 in accordance with another embodiment. Similar to product management system 10 of FIG. 1A, product management system 702 includes a master database module 11, an input module 12, a sales module 13, an order processing & dispatch module 13A, a production module 14, a transport module 15, a site module 16, an alert module 17, and a purchase module 18. In the embodiment of FIG. 7B, localization module 19 is separate from master database module 11 and is connected to master database module 11 by a link 41. For example, master database module 11 may reside and operate on a first computer and localization module 19 may reside and operate on a second computer remote from master database module 11. For example, localization module 19 may reside and operate on a second computer located at a production facility. Localization module 19 may communicate with master database module 11 via a network such as the Internet, or via another type of network, or may communicate via a direct communication link.

FIG. 7C shows a production management system 703 in accordance with another embodiment. Product management system 703 includes a master database module 11, an input module 12, a sales module 13, a production module 14, a transport module 15, a site module 16, an alert module 17, a purchase module 18, and a localization module 19. Modules 11-19 are connected to a network 775. Modules 11-19 communicate with each other via network 775. For example, various modules may transmit information to master database 11 via network 775.

Network 775 may comprise the Internet, for example. In other embodiments, network 775 may comprise one or more of a number of different types of networks, such as, for example, an intranet, a local area network (LAN), a wide area network (WAN), a wireless network, a Fibre Channel-based storage area network (SAN), or Ethernet. Other networks may be used. Alternatively, network 775 may comprise a combination of different types of networks.

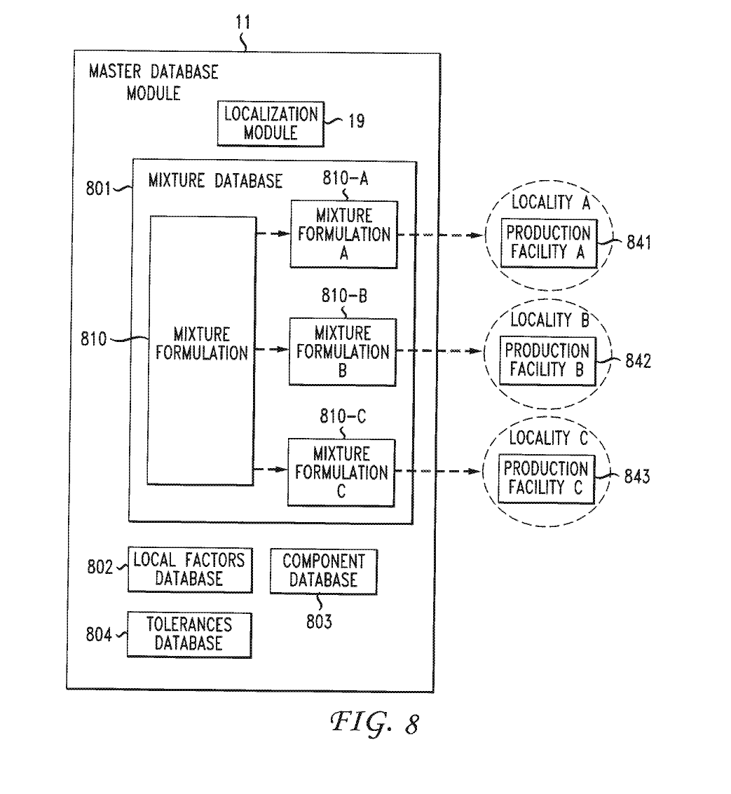

FIG. 8 illustrates a system for the management of localized versions of a mixture formulation in accordance with an embodiment. In the illustrative embodiment of FIG. 8, master database module 11 comprises localization module 19, a mixture database 801, a local factors database 802, a components database 803, and a tolerances database 804. A mixture formulation 810 associated with a particular mixture is maintained in mixture database 801. While only one mixture formulation is shown in FIG. 8, it is to be understood that more than one mixture formulation (each associated with a respective mixture) may be stored by master database module 11.

Master database module 11 is linked to several production facilities, as shown in FIG. 8. In the illustrative embodiment, master database module 11 is in communication with Production Facility A (841), located in Locality A, Production Facility B (842) located in Locality B, and Production Facility C (843), located in Locality C. While three production facilities (and three localities) are shown in FIG. 8, in other embodiments more or fewer than three production facilities (and more or fewer than three localities) may be used.

In the embodiment of FIG. 8, local factors database 802 stores local factor data relating to various production facilities, including, for example, local availability information, local cost information, local market condition information, etc. Localization module 19 may obtain local factor data based on the information in local factors database 802. Components database stores information pertaining to various components of product mixtures, such as, for example, technical information concerning various components, costs of various components, etc. Tolerances database 804 stores information defining tolerances related to various components and mixtures.

In the illustrative embodiment, localization module 19 accesses mixture formulation 810 and generates a localized version for Production Facility A (841), shown in FIG. 8 as Mixture Formulation A (810-A). Localization module 19 generates a localized version for Production Facility B (842), shown in FIG. 8 as Mixture Formulation B (810-B). Localization module 19 also generates a localized version for Production Facility C (843), shown in FIG. 8 as Mixture Formulation C (810-C). Mixture Formulation A (810-A), Mixture Formulation B (810-B), and Mixture Formulation C (810-C) are stored at master database module 11.

In order to generate a localized version of a mixture formulation for a particular production facility, localization module 19 accesses local factors database 802 and analyzes one or more local factors pertaining to the particular production facility. For example, localization module 19 may analyze one or more local availability factors representing local availability of components in the mixture formulation, one or more local market condition factors representing characteristics of the local market, one or more local cost factors representing the cost of obtaining various components in the local market, etc.

Localization module 19 may modify a mixture formulation based on a local factor. For example, if a local market factor indicates a strong preference for a product having a particular feature (or a strong bias against a certain feature), localization module 19 may alter the mixture formulation based on such local market conditions. If a particular component is not available in a local market, localization module 19 may alter the mixture formulation by substituting an equivalent component that is locally available. Similarly, if a particular component is prohibitively expensive in a particular locality, localization module 19 may reduce the amount of such component in the mixture formulation and/or replace the component with a substitute, equivalent component.

It is to be understood that FIG. 8 is illustrative. In other embodiments, master database module 11 may include components different from those shown in FIG. 8. Mixtures and local factors may be stored in a different manner than that shown in FIG. 8.

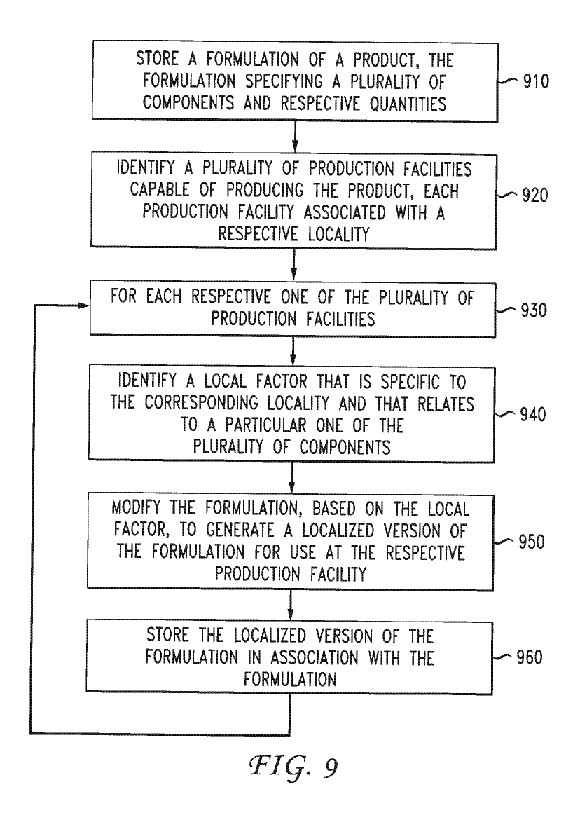

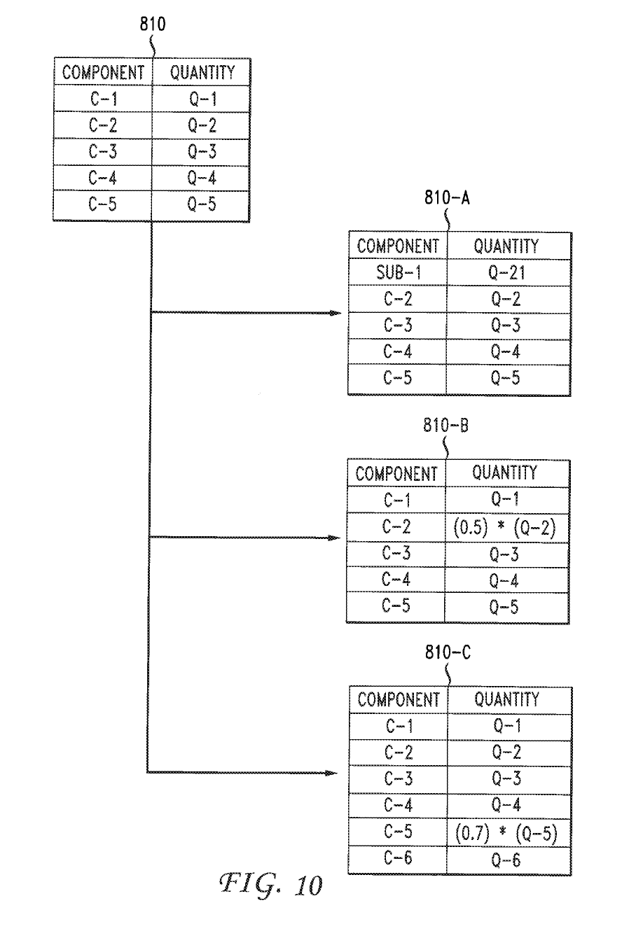

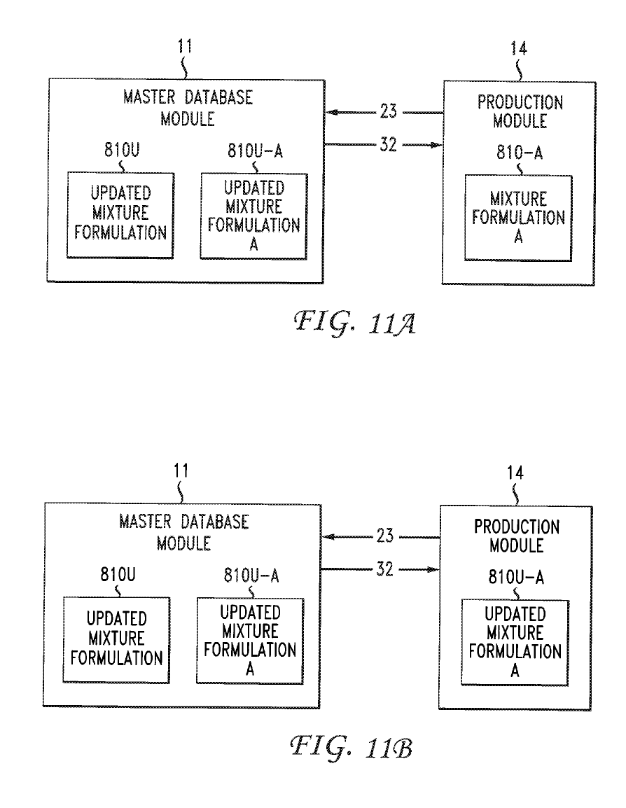

FIG. 9 is a flowchart of a method of generating localized versions of a mixture formulation in accordance with an embodiment. The method presented in FIG. 9 is discussed with reference to FIG. 10. FIG. 10 shows mixture formulation 810 and several corresponding localized versions of the mixture formulation in accordance with an embodiment.

At step 910, a formulation of a product is stored, the formulation specifying a plurality of components and respective quantities. As discussed above, mixture formulation 810 is stored at master database module 11. Referring to FIG. 10, mixture formulation 810 specifies the following components and quantities: C-1, Q-1; C-2, Q-2; C-3, Q-3; C-4, Q-4; and C-5, Q-5. Thus, for example, mixture formulation 810 requires quantity Q-1 of component C-1, quantity Q-2 of component C-2, etc. Mixture formulation 810 may also specify other information, including a method to be used to manufacture the mixture.

At step 920, a plurality of production facilities capable of producing the product are identified, each production facility being associated with a respective locality. In the illustrative embodiment, localization module 19 identifies Production Facility A (841) in Locality A, Production Facility B (842) in Locality B, and Production Facility C (843) in Locality C.

Referring to block 930, for each respective one of the identified production facilities, a series of steps is performed. At step 940, a local factor that is specific to the corresponding locality and that relates to a particular one of the plurality of components is identified. Localization module 19 first accesses local factors database 802 and examines local factors relating to Locality A and Production Facility A (841). Suppose, for example, that localization module 19 determines that in Locality A, component C-1 is not readily available.

At step 950, the formulation is modified, based on the local factor, to generate a localized version of the formulation for use at the respective production facility. In the illustrative embodiment of FIG. 10, localization module 19 substitutes an equivalent component SUB-1 for component C-1 to generate a localized version 810-A of mixture 810. Localized version 810-A is intended for use at Production Facility A (841).

At step 960, the localized version of the formulation is stored in association with the formulation. In the illustrative embodiment, localized version 810-A is stored at master database module 11 in association with mixture formulation 810.

Referring to FIG. 9, the routine may return to step 930 and repeat steps 930, 940, 950, and 960 for another production facility, as necessary. Suppose, for example that localization module 19 determines that in Locality B (associated with Production Facility B (842)), local purchasers prefer a product with less of component C-2. Localization module 19 thus reduces the quantity of component C-2 in the respective localized version 810-B of mixture 810, as shown in FIG. 10. In particular, the amount of component C-2 in localized version 810-B is (0.5)*(Q-2). Localized version 810-B is intended for use at Production Facility B (842). Localized version 810-B is stored at master database module 11 in association with mixture formulation 810, as shown in FIG. 8.

Suppose that localization module 19 also determines that in Locality C (associated with Production Facility C (843)), local purchasers prefer a product with an additional component C-6. Localization module 19 further determines that component C-6 is an equivalent of component C-5, but is of lower quality. To accommodate local market conditions, localization module 19 reduces the quantity of component C-5 to (0.7)*(C-5) and also adds a quantity Q-6 of component C-6 to generate a localized version 810-C of mixture 810, as shown in FIG. 10. Localized version 810-C is intended for use at Production Facility C (843). Localized version 810-C is stored at master database module 11 in association with mixture formulation 810, as shown in FIG. 8.

Master database module 11 may subsequently transmit one or more of the localized versions 810-A, 810-B, 810-C to Production Facilities A, B, and/or C, as necessary. For example, suppose that an order is received for Mixture Formulation 810. Suppose further that Production Facility A and Production Facility B are selected to produce the mixture. Master database module 11 accordingly transmits the localized version Mixture Formulation A (810-A) to Production Facility A (841). Mixture Formulation A (810-A) is stored at Production Module 14. Master database module 11 also transmits the localized version Mixture Formulation B (810-B) to Production Facility B (842). Mixture Formulation B (810-B) is stored at a respective production module (not shown) operating at Production Facility B (842).

The mixture is then produced at each designated production facility based on the respective localized version of the mixture formulation. In the illustrative embodiment, the mixture is produced at Production Facility A (841) in accordance with the localized version Mixture Formulation A (810-A)). The mixture is produced at Production Facility B (842) in accordance with the localized version Mixture Formulation B (810-B).

In accordance with another embodiment, master database module 11 from time to time updates the master version of a mixture formulation (stored at master database module 11). Master database module 11 also monitors versions of the mixture formulation maintained at various production facilities. If it is determined that a version of the mixture formulation stored at a particular production facility is not the same as the master version of the mixture formulation, an alert is issued and the local version is synchronized with the master version. For purposes of the discussion set forth below, any version of a mixture formulation that is stored at master database module 11 may be considered a “master version” of the mixture formulation.

In an illustrative embodiment, suppose that master database module 11 updates Mixture Formulation 810. This may occur for any of a variety of reasons. For example, the cost of one of the components in Mixture Formulation 810 may increase substantially, and the particular component may be replaced by an equivalent component. Referring to FIG. 11A, the updated formulation is stored at master database module 11 as Updated Mixture Formulation 810U.

Master database module 11 also generates localized versions of the updated mixture formulation. Thus, for example, master database module 11 generates an updated localized version of Mixture Formulation 810U for Production Facility 841 (in Locality A). The updated localized version of is stored at master database module 11 as Updated Mixture Formulation A (810U-A), as shown in FIG. 11A.

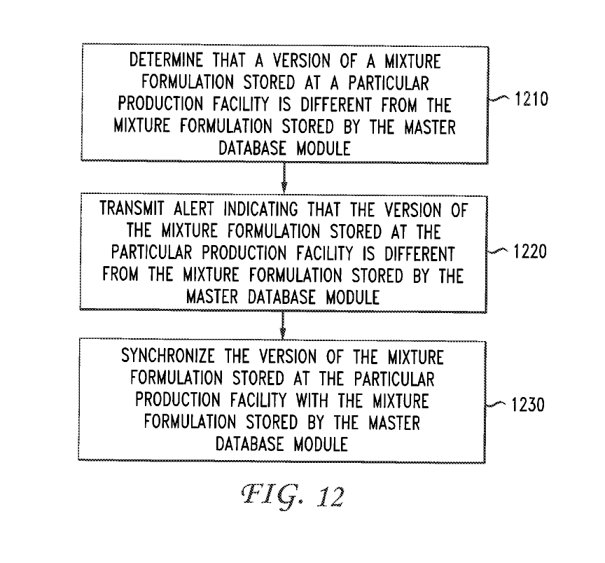

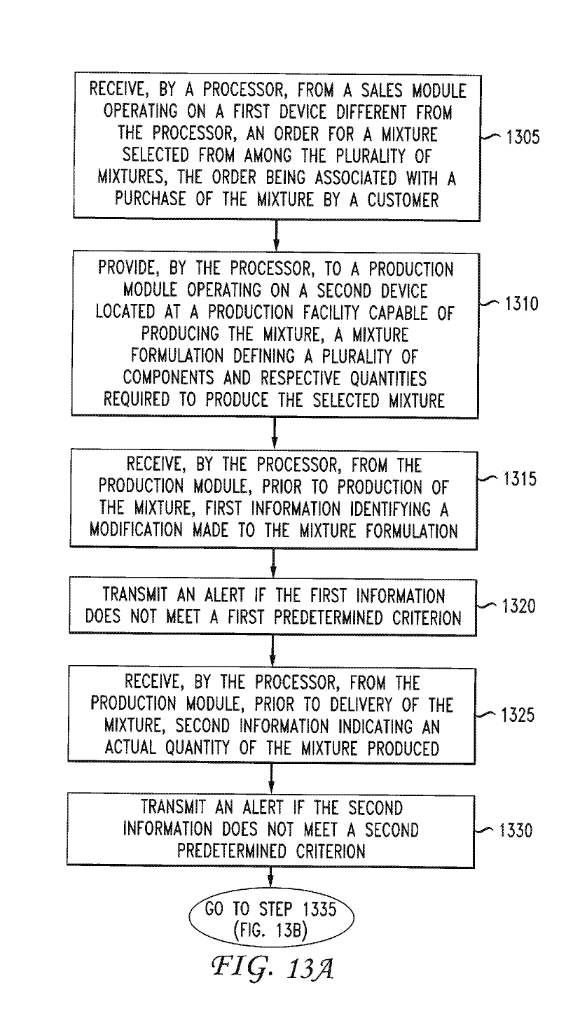

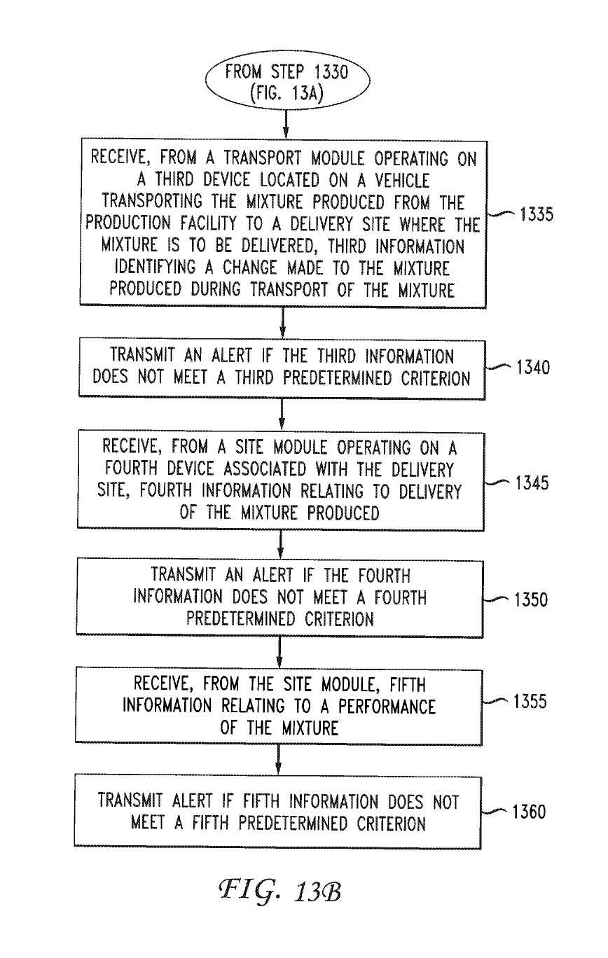

Master database module 11 identifies one or more production facilities that store a localized version of Mixture Formulation 810, and notifies each such production module that Mixture Formulation 810 has been updated. If a production module does not have the correct updated version of the mixture formulation, the localized version must be synchronized with the updated master version stored at master database module 11. FIG. 12 is a flowchart of a method of synchronizing a localized version of a mixture formulation with a master version of the mixture formulation in accordance with an embodiment.

In the illustrative embodiment, certain aspects of production at Production Facility A (841) are managed by production module 14. For example, production module 14 may operate on a computer or other processing device located on the premises of Production Facility A (841).

At step 1210, a determination is made that a mixture formulation stored at a particular production facility is different from the mixture formulation stored by the master database module. For example, master database module may communicate to production module 14 (operating at Production Facility A (841)) that Mixture Formulation A (810-A) has been updated. Production module 14 determines that its current localized version of the mixture formulation is not the same as Updated Mixture Formulation A (810U-A).

At step 1220, an alert is transmitted indicating that the version of the mixture formulation stored at the particular production facility is different from the mixture formulation stored by master database module 11. Accordingly, production module 14 transmits an alert to master database module 11 indicating that its local version of the mixture formulation is not the same as the updated version stored at master database module 11.

At step 1230, the version of the mixture formulation stored at the particular production facility is synchronized with the mixture formulation stored at the master database module 11. In response to the alert, master database module 11 provides production module 14 with a copy of Updated Mixture Formulation A (810U-A). Production module 14 stores Updated Mixture Formulation A (810U-A), as shown in FIG. 11B.

Various methods and system described above may be used in an integrated closed-loop production system to manage a production system. In accordance with an embodiment, a method of managing a closed-loop production system is provided. Master database module 11 provides to sales module 13 descriptions, prices, and other information relating to a plurality of available mixtures, enabling sales module 13 to offer several options to potential producers and/or customers. Specifically, master database module 11 provides information relating to a plurality of concrete mixtures. Sales module 13 may present the information to a producer and/or customer in the form of a menu, as discussed above with reference to FIG. 1B.

Suppose now that a producer and/or customer considers the available mixtures and selects one of the plurality of concrete mixtures. Suppose further that the producer and/or customer submits an order for the selected mixture, specifying parameters such as quantity, date and place of delivery, etc. For illustrative purposes, suppose that the producer and/or customer selects the mixture associated with mixture formulation 810 (shown in FIG. 8) and specifies a delivery site located in or near Locality A (also shown in FIG. 8). Master database module 11 utilizes a closed-loop production system such as that illustrated in FIG. 1A to manage the sale, production and delivery of the selected mixture to the producer and/or customer.

FIGS. 13A-13B comprise a flowchart of a method of managing a closed-loop production system in accordance with an embodiment. At step 1310, an order for a mixture selected from among the plurality of mixtures is received, by a processor, from a sales module operating on a first device different from the processor, the order being associated with a purchase of the mixture by a producer and/or customer. In the illustrative embodiment, sales module 13 transmits the order for the selected concrete mixture to master database module 11. The order specifies the selected mixture and other information including quantity, date and place of delivery, etc. Master database module 11 receives the order for the selected concrete mixture from sales module 13.

At step 1310, a mixture formulation defining a plurality of components and respective quantities required to produce the selected mixture is provided, by the processor, to a production module operating on a second device located at a production facility capable of producing the mixture. Accordingly, master database module 11 identifies one or more production facilities capable of producing the selected mixture. Production facilities may be selected based on a variety of factors. For example, master database module 11 may select one or more production facilities that are located near the delivery site specified in the order. In the illustrative embodiment, master database module 11 selects Production Facility A (841) due to the fact that the producer's and/or customer's delivery site is located in or near Locality A. It is to be understood that more than one production facility may be selected and used to produce a mixture to meet a particular order.

Master database module 11 transmits Mixture Formulation A (810-A) (or any updated version thereof) to Production Facility A (841). Production module 14 manages and monitors the production process. In the illustrative embodiment, production module 14 determines that a particular component of mixture formulation A (810-A) is currently unavailable and replaces the component with a known equivalent. Production module 14 accordingly transmits an alert to master database module 11 indicating that the component has been replaced. An alert may then be provided to the producer and/or customer, as well. Production of the selected mixture proceeds. In one embodiment, the alert may be transmitted in real time (e.g., within a specified time period after production module 14 receives the information).

At step 1315, first information identifying a modification made to the mixture formulation is received, by the processor, from the production module, prior to production of the mixture. Master database module 11 receives the alert from production module 14.

At step 1320, an alert is transmitted if the first information does not meet a first predetermined criterion. If the modification does not meet specified requirements, master database module 11 transmits an alert to the producer and/or customer. In one embodiment, the alert is transmitted in real time.

In the illustrative embodiment, a quantity of the mixture actually produced at Production Facility A (841) differs from the quantity specified in the order. Production module 14 transmits an alert to master database module 11 and to alert module 17 indicating that the quantity actually produced differs from the quantity ordered. The alert may be transmitted in real time. At step 1325, second information indicating an actual quantity of the mixture produced is received, from the production module, prior to delivery of the mixture. Master database module 11 receives the alert and stores the information specifying the actual quantity produced.

At step 1330, an alert is transmitted if the second information does not meet a second predetermined criterion. If the quantity of concrete mixture actually produced does not meet specified requirements, master database module 11 transmits an alert to the producer and/or customer. In one embodiment, the alert is transmitted in real time.

In another embodiment, production module 14 may inform master database module 11 if the method of manufacture specified in the mixture formulation is changed. For example, a step of the method may be modified or eliminated, or a new step may be added.

The method now proceeds to step 1335 of FIG. 13B.

The mixture is now placed on a transport vehicle, such as a truck, and transported to the delivery site specified in the order. The vehicle includes transport module 15, which may be a software application operating on a processing device, for example. The vehicle may have one or more sensors to obtain data such as temperature of the mixture, water content of the mixture, etc. During transport, transport module 15 monitors the condition of the mixture and detects changes made to the mixture.

At step 1335, third information identifying a change made to the mixture produced during transport of the mixture is received, from a transport module operating on a third device located on a vehicle transporting the mixture produced from the production facility to a delivery site. In the illustrative embodiment, the driver of the truck makes a change to the mixture during transport to the delivery site. For example, the driver may add additional water to the mixture while the mixture is in the truck. Transport module 15 transmits an alert to master database module 11 and to alert module 17 indicating the change that was made. In one embodiment, the alert is transmitted in real time.

At step 1340, an alert is transmitted if the third information does not meet a third predetermined criterion. If the third information is not within pre-established tolerances, an alert is issued to the producer and/or customer. In one embodiment, the alert is transmitted in real time.

In the illustrative embodiment, the mixture is delivered to the producer's and/or customer's construction site. At the producer's and/or customer's site, site module 16 monitors delivery of the mixture and performance of the mixture after delivery. At step 1345, fourth information relating to delivery of the mixture produced is received, from a site module operating on a fourth device associated with the delivery site. When the mixture is delivered to the specified delivery site, site module 16 transmits an alert to master database module indicating that the mixture has been delivered. In one embodiment, the alert is transmitted in real time.

At step 1350, an alert is transmitted if it is determined that the fourth information does not meet a fourth predetermined criterion. For example, if the delivery of the mixture occurs outside of a specified delivery time frame (e.g., if the delivery is late), master database module 11 (or alert module 17) may transmit an alert to the producer and/or customer. In one embodiment, the alert is transmitted in real time.

The site module 16 may also monitor certain performance parameters of the mixture after it is delivered and used. At step 1355, fifth information relating to a performance of the mixture is received, from the site module. After the mixture is used (e.g., when the concrete mixture is laid), site module 16 may transmit to master database module 11 information including performance data. In one embodiment, the information is transmitted in real time.

At step 1360, an alert is transmitted if it is determined that the fifth information does not meet a fifth predetermined criterion. Thus, if the performance data does not meet specified requirements, master database module 11 (or alert module 17) transmits an alert to the producer and/or customer. In one embodiment, the alert is transmitted in real time.

As described above, alerts are issued at various stages of the production process to inform master database module 11 of events and problems that occur during production, transport, and delivery of the mixture. Master database module 11 (or alert module 17) may then alert the producer and/or customer if a parameter does not meet specified requirements.

Master database module 11 may collect information from various modules involved in the production of a mixture, in real time, and provide the information to the producer and/or customer, in real time. For example, when master database module 11 receives from a respective module information pertaining to the production of a mixture, master database module 11 may transmit an alert to the producer and/or customer in the form of an email, or in another format.

In one embodiment, master database module 11 maintains a web page associated with a producer's and/or customer's order and allows the producer (and/or the customer) to access the web page. Information received from various modules involved in the production of the mixture may be presented on the web page. In addition, information relating to cost analysis may be presented on the web page. For example, an analysis of the impact of a modification to the mixture formulation, a change to the mixture during production or transport, a delay in delivery, or any other event, on the cost of materials (COM) and/or on the producer's profitability may be provided on the web page.

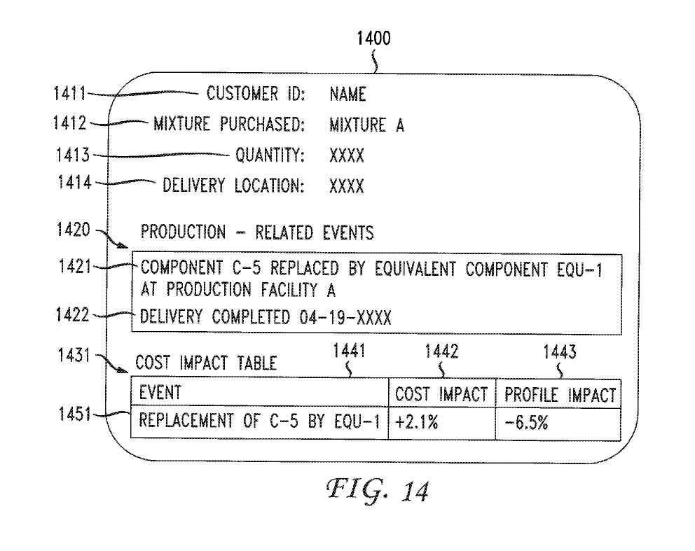

FIG. 14 shows an exemplary web page that may be maintained in accordance with an embodiment. For example, access to the web page may be provided to a producer to enable the producer to manage the production system and to control costs and profitability. Web page 1400 includes a customer ID field 1411 showing the producer's and/or customer's name or other identifier, a mixture purchased field 1412 showing the mixture that the producer and/or customer purchased, a quantity field 1413 showing the quantity of the mixture ordered, and a delivery location field 1414 showing the delivery location specified by the producer and/or customer.

Web page 1400 also includes a Production-Related Events field 1420 that lists events that occur during production of the mixture. Master database module 11 may display in field 1420 information received from various modules during production of the mixture, including information indicating modifications made to the mixture formulation prior to production, changes made to the mixture during transport of the mixture, information related to delivery, etc. In the illustrative embodiment of FIG. 14, field 1420 includes a first listing 1421 indicating that component C-5 of the mixture formulation was replaced by an equivalent component EQU-1 at Production Facility A (prior to production). Field 1420 also includes a second listing 1422 indicating that delivery of the mixture was completed on 04-19-XXXX.

Web page 1400 also includes a Cost Impact Table 1431 showing the expected impact of certain events on cost and profitability. Table 1431 includes an event column 1441, a cost impact column 1442, and a profitability impact column 1443. Master database module 11 accesses stored information concerning the costs of various components and calculates the expected impact of one or more selected events on the producer's costs. In the illustrative embodiment, row 1451 indicates that the replacement of C-5 by EQU-1 is expected to increase the cost of the mixture by +2.1%, and reduces the producer's profit by 6.5%.

In accordance with another embodiment, statistical measures of various aspects of the production process are generated for a plurality of production facilities and used to establish one or more benchmarks.

Concrete performance is generally specified and used on the basis of its 28 day compressive strength, or at times for pavement construction on the basis of its flexure strength at a specified age such as 7 or 28 days. The methods of measurement and reporting are generally specified by the American Society for Testing and Materials, or ASTM (such as ASTM C39 and C78) and the equivalent International standards such as applicable EN (European Norms). Additionally, concrete mix design and quality evaluation is guided by American Concrete Institute (ACI) 318 as a recommended procedure, which is almost always mandated by project specifications in the US, and also used in many countries worldwide. In ACI 318 a set of statistical criteria are established that relate concrete mix design strength, F′cr, to its structural grade strength, F′c, as used in the design process by the structural engineer. Thus the concrete producer designs his or her mixtures to meet certain F′cr values in order to meet certain desired F′c structural grades specified in the project specifications. A variable relating F′cr and F′c is the standard deviation of strength testing, SDT, as determined per prescribed ACI procedures. The ACI formulae include:

For F′c≦5,000 psi:

F′cr=F′c+1.34 SDT (ACI 1)

(1% probability that the run average of 3 consecutive tests are below F′c)

F′cr=F′c−500+2.33 SDT (ACI 2)

(1% probability that a single test is 500 psi or more below F′c)

For F′c>5,000 psi−[1] applies but [2] is replaced by [3] below:

F′cr=F′c−0.1F′c+2.33 SDT (ACI 3)

(1% probability that a single test is 10% of F′c or more below F′c)

In general the above equations can be expressed in the following form: Mix Design Strength (F′cr)=Structural Grade Strength (F′c)+ An overdesign factor proportional to the Standard Deviation of testing, SDT.

The factor SDT is a direct measure of concrete quality and reliability, and experience shows that it can range widely from an excellent level of on the order of 80 to 200 psi, to the very poor level of over 1,000 psi. Concrete mix design cost factor is directly proportional to SDT, which means that high quality concrete is also less expensive to produce since it would contain less cement (or cementitious materials, which include binders such as slag, fly ash, or silica fume in addition to cement).

Because of the above ACI approach now in practice for many decades, the industry (including ready mix producers, test labs, contractor, and specifying engineers) has paid significant attention to test results variability and the standard deviation of testing.

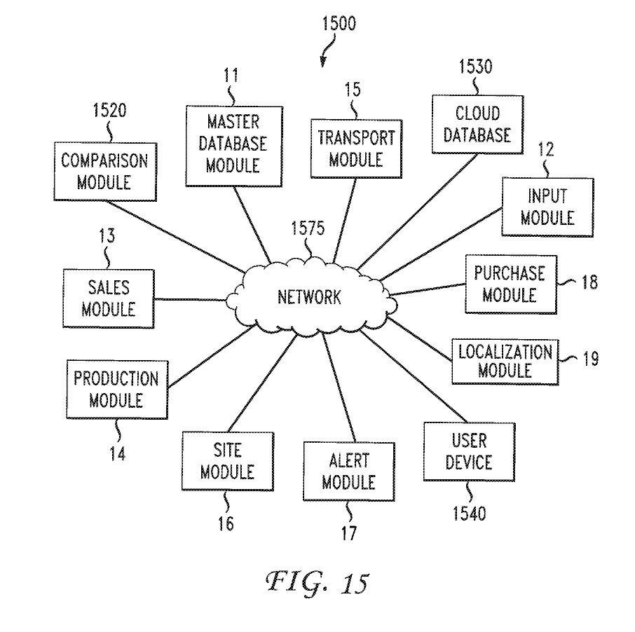

FIG. 15 shows a production management system 1500 in accordance with an embodiment. Product management system 1500 includes a master database module 11, input module 12, sales module 13, production module 14, transport module 15, site module 16, alert module 17, purchase module 18, and localization module 19. Production management system 1500 also includes a comparison module 1520, a network 1575 and a cloud database 1530. Various components, such as master database module 11, may from time to time store data in cloud database 1530. Production management system 1500 also comprises a user device 1540.

In another embodiment, the master database module 11, the comparison module 1520, and the alert module 17 are housed within a single module.

In one embodiment, a batch of a concrete mixture is produced at a production facility in accordance with a formulation. Certain aspects of the batch produced are measured and differences between the batch produced and the formulation requirements are identified. The differences are analyzed to determine if the differences fall within acceptable tolerances.

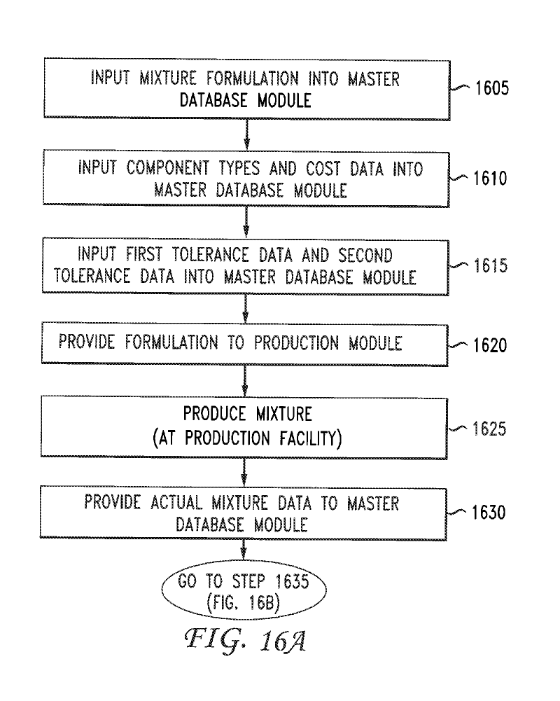

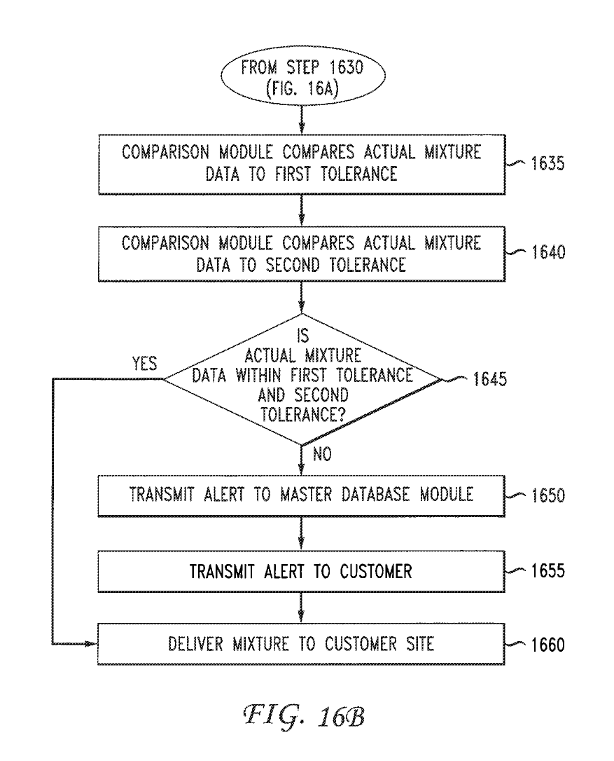

FIGS. 16A-16B comprise a flowchart of a method of producing and analyzing a mixture in accordance with an embodiment. At step 1605, a mixture formulation is input into a master database module. In the illustrative embodiment, input module 12 provides a formulation for a particular concrete mixture to master database module 11. Master database module 11 stores the formulation.

In one embodiment, a plurality of mixture formulations is provided by input module 12 to master database module 11. A master list of mixtures, comprising a plurality of mixture formulations, is maintained at master database module 11.

As described above, master database module 11 may generate localized versions of a mixture formulation. Referring again to FIG. 8, localization module 19 generates localized mixture formulations for Production Facility A, Production Facility B, etc.

At step 1610, data relating component types and costs are input into the master database module. Technical data for a variety of components used in the formulation (and in other formulations), as well as cost data for the components, is provided by input module 12 to master database module 11. Technical data and cost data for various components may be stored in a components database 803, shown in FIG. 8.

At step 1615, first tolerance data and second tolerance data are input into the master database module. Input module 12 transmits to master database module 11 information defining a first tolerance and information defining the second tolerance. For example, tolerances may indicate that an amount of water in a batch of a concrete mixture must fall within a specified range, or that an amount of cementitious in the concrete mixture must fall within a specified range. Tolerance information is stored in tolerances database 804.

At step 1620, a formulation is provided to the production module. Master database module 11 transmits the mixture formulation to a selected production facility. For example, master database module 11 may provide a respective localized mixture formulation to Production Facility A (841). A different localized mixture formulation may be provided to Production Facility B (842), for example.

At step 1625, the mixture is produced at the production facility. The production facility produces one or more batches of the mixture. For example, Production Facility A (841) may produce a batch of the mixture based on the mixture formulation.

At step 1630, actual mixture data is provided to master database module. After a batch is made, production module 14 provides batch data indicating the actual quantity of the mixture produced, the components used to make the batch, the quantity of each component, etc., to master database module 11. Production module 14 obtains batch data indicating the actual quantity of the mixture produced, which components were actually used, etc., and transmits the batch data to master database module 11. Master database module 11 may store the batch data. The method now proceeds to step 1635 of FIG. 16B.

At step 1635, the comparison module compares the actual mixture data to the first tolerance. Comparison module 1520 accesses the stored batch data, and accesses tolerance information in tolerances database 804 (shown in FIG. 8). Comparison module 1520 applies the first tolerance to the batch data to determine whether the batch data is acceptable.

At step 1640, the comparison module compares the actual mixture data to the second tolerance. Comparison module 1520 accesses the stored batch data and applies the second tolerance to the batch data to determine whether the batch data is acceptable.

Referring to block 1645, a determination is made whether the actual mixture data are within the first tolerance and the second tolerance. Comparison module 1520 determines whether the actual mixture data are within the specified tolerances. If the actual mixture data are within the first tolerance and the second tolerance, the method proceeds to step 1660. If the actual mixture data are not within the first tolerance and the second tolerance, the method proceeds to step 1650.

At step 1650, an alert is transmitted to the master database module. Comparison module 1520 transmits to master database module 11 an alert indicating that the batch data are not within acceptable tolerances.

At step 1655, an alert is transmitted to the producer and/or to the customer. Alert module 17 transmits to the producer and/or customer an alert indicating that the batch data are not within acceptable tolerances.

In another embodiment, a first alert is issued if the batch data is not within the first tolerance, and a second alert is issued if the batch data is not within the second tolerance.

At step 1660, the mixture is delivered to the producer and/or customer site. The mixture is placed on a transport vehicle and is delivered to the site specified by the producer and/or customer in the order.

In accordance with another embodiment, comparison module 1520 monitors the quantity of one or more components in each batch actually produced, and compares the amounts to the amounts of such components as specified in the formulation.

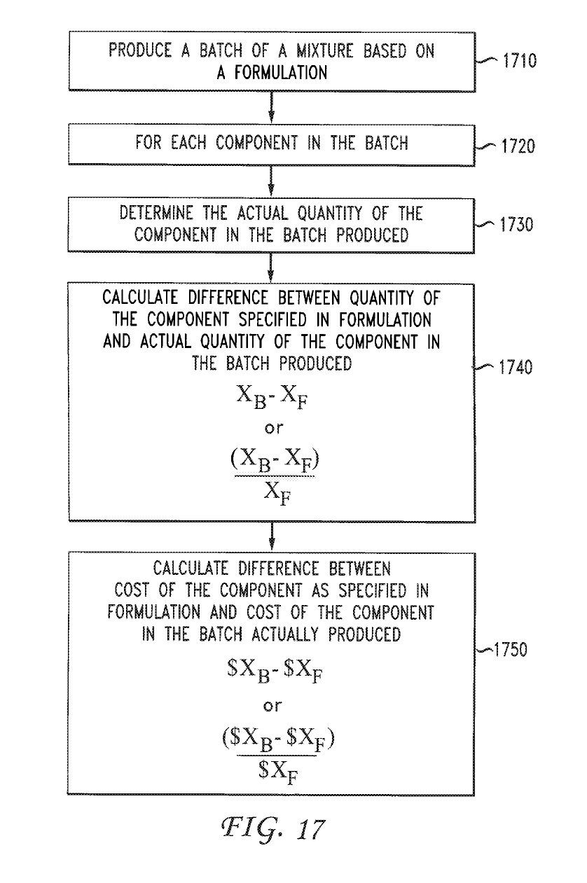

FIG. 17 is a flowchart of a method of producing a formulation-based mixture in accordance with an embodiment. In another illustrative embodiment, suppose that another producer and/or customer orders a desired quantity of the mixture defined by Mixture Formulation (810). Several production facilities may be selected to produce the mixture, including Production Facility C (841). Master database module 11 transmits localized Mixture Formulation C (810-C) to production facility C (843).

At step 1710, a batch of a mixture is produced based on a formulation. A batch of the mixture is produced at Production Facility C (843) based on localized Mixture Formulation A (810-C). Referring to FIG. 10, localized Mixture Formulation (810-C) specifies the following components and quantities: C-1, Q-1; C-2, Q-2; C-3, Q-3; C-4, Q-4; C-5, (0.7)*(Q-5); and C-6, Q-6.

Referring to block 1720, for each component X in the batch, a series of step is performed. Thus, the steps described below are performed with respect to each of the components C-1, C-2, C-3, C-4, C-5, and C-6. For convenience, the method steps are described with respect to component C-1; however, the steps are also performed for each of the other components.

At step 1730, the actual quantity of the component in the batched mixture, XB, is determined. Thus, the actual quantity of C-1 used in the batch produced at Production Facility C (843) is determined. Production module 14 obtains this information concerning the actual quantity of the component in the batched mixture, XB, and transmits the information to master database module 11.

Now a measure of a difference between the batch and the formulation is determined based on a relationship between the quantity of the component in the batched mixture, X_{B}, and the quantity of the component as specified by the formulation, X_{F}.

Specifically, at step 1740, a difference between the quantity of the component specified in the formulation and the actual quantity of the component in the batch produced is calculated. Specifically, the difference (X_{B}−X_{F}) is calculated, where X_{B} is the amount of the component actually used in the batch produced and XF is the amount of the component as specified in the formulation. In some embodiments, a percentage value representing the difference may also be computed using the following formula:

ΔX=(X_{B}−X_{F})/X_{F}.

In the illustrative embodiment, comparison module 1520 calculates the quantity ΔX, and provides the information to master database module 11. The quantity ΔX is stored at master database module 11.

At step 1750, a difference between the cost of the component as specified in the formulation and the cost of the component in the batch produced is calculated. Thus, the difference ($X_{B}−$X_{F}) is calculated, where $X_{B} is the cost of the component actually used in the batch produced and $XF is the cost of the component as specified in the formulation. In some embodiments, a percentage value representing the difference may also be calculated using the following formula:

Δ$X=($X_{B}−$X_{F})/$X_{F},

In the illustrative embodiment, comparison module 1520 calculates the quantity Δ$X and provides the information to master database module 11. The quantity Δ$X is stored at master database module 11.

In accordance with an embodiment, comparison module 1520 particularly monitors the quantity of cementitious and the quantity water in each batch. Systems and methods for monitoring and analyzing quantities of cementitious and water in batches produced are described below.

For convenience, the terms CM_{F}, CM_{B}, W_{F}, and W_{B} are defined as follows:

CM_{F}=the amount of cementitious specified in the formulation,

CM_{B}=the actual amount of cementitious in a batch produced,

W_{F}=the amount of water specified in the formulation,

W_{B}=the actual amount of water in a batch produced.

Then ΔCM and ΔW are defined as follows:

ΔCM=CM_{B}−CM_{F}

ΔW=W_{B}−W_{F}

Using the terms defined above, set forth below is a method of computing a standard deviation of ΔCM/CM_{F} (referred to as SDrCM) and a standard deviation of ΔW/W_{F} (referred to as SDrW, for each production facility, across all its production batches and mixes.

In accordance with well-known principles of concrete technology, and since strength is proportional to CM/W ratio, it can be shown that for any given mix, a variance of the strength S of a given batch of concrete has the following relationship to CM and W:

ΔS/S=(ΔCM/CM)−(ΔW/W)

Accordingly, relative strength increases as CM specified in the formulation increases. Likewise, relative strength increases as W specified in the formulation decreases.

In accordance with well-known statistical principles, the variance (VAR) of the strength measure can be expressed as follows:

$$\begin{matrix}VAR ( Δ S / S ) = VAR ( Δ CM / CM ) + VAR ( Δ W / W ) \\ = {( SDrCM )}^{2} + {( SDrW )}^{2}\end{matrix}$$

Now if SDrWCM is the standard deviation of the measured ratio W/CM in a batch actually produced relative to the value of W/CM specified in the formulation, the SDrWCM can be expressed as follows:

(SDrWCM)=[(SDrCM)²+(SDrW)2]^{1/2}

Hence:

SDrS=(SDrWCM),

where SDrS is the standard deviation of relative strength resulting from the variability of the batching process. The term “relative strength” as used herein means the difference in strength in all batches actually produced at a given production facility relative to the strength baseline specified in the formulation, due to the batching variabilities of CM and W, expressed as a ratio with respect to the strength baseline specified in the formulation.

It follows that:

SD(ΔS)=S×(SDrWCM)

In accordance with an embodiment, the closed loop production management system described herein provides, in real time, to a producer and/or a customer, the statistical values SDrCM and SDrW, and SD(ΔS). SD(ΔS) is a direct measure of concrete strength performance quality related to the quality of the production batching process, both of which are characterized by the applicable SD values. Low batching quality is reflected by a high SD value; high batching quality is reflected by a low SD. Thus as the batching quality deteriorates, the strength quality also decreases proportionally.

Accordingly, when the batching quality decreases, it may be necessary to adjust the applicable formulation by using an extra batching driven increment in the SDT standard deviation factor. This is done using the ACI 318 Eqs.[1]-[3] and the equation above in the following form:

ΔF′cr=1.34×S×(SDrWCM) [1a]

ΔF′cr=2.33×S×(SDrWCM) [2a]

ΔF′cr=2.33×S×(SDrWCM) [3a]

where ΔF′cr is an added mix design strength increment resulting from the batching variability SDrWCM, for each of the three ACI equations. Since Equations [2a] and [3a] are identical, the three ACI statistical criteria are in fact reduced to two for these batching increment cases.

Because F′cr is the theoretical strength associated with the specified formulation, an increase in F′cr is associated with an increase in the CM content at constant W, resulting in an increase in the cost of the CM cost in the mixture. The cost of CM in a mixture can be expressed as follows:

Φ=CM efficiency factor in PSI/(LB·CYD)

K=CM cost per LB

$CM=CM cost per cyd=(K/Φ)×F′cr

It follows from the equation above and Equations [1a-1b] that:

Δ$CMB=increase in CM cost due to batching SD

Δ$CMB=1.34×(K/Φ)×S×SDrWCM

ΔCSTB=2.33×(K/Φ)×S×SDrWCM

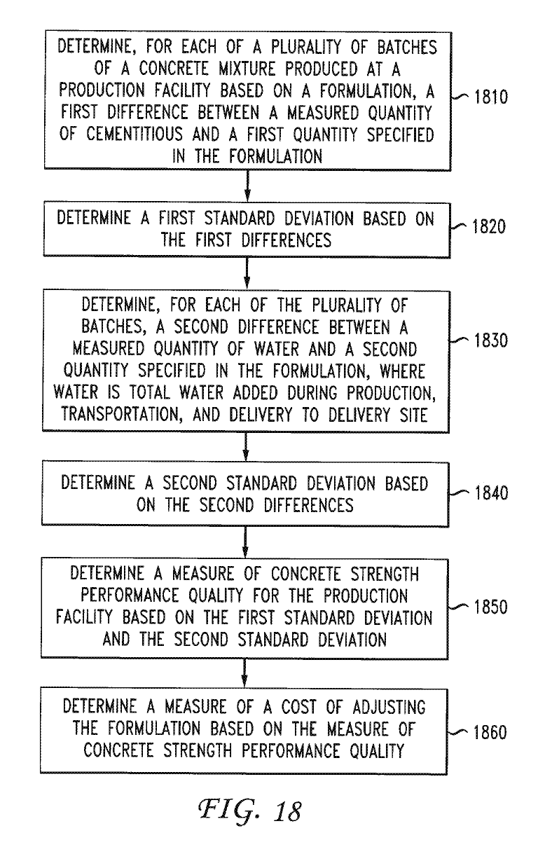

Accordingly, in accordance with an embodiment, standard deviations are determined in according with the principles described above, and are used to determine a measure of concrete strength performance quality for a plurality of batches produced at a production facility. FIG. 18 is a flowchart of a method of determining a measure of concrete strength performance quality for concrete produced at a production facility in accordance with an embodiment.

At step 1810, a first difference between a measured quantity of cementitious and a first quantity specified in a formulation is determined, for each of a plurality of batches of concrete produced at a production facility. As described above, for each batch, the batched CM is measured, and information indicating the batched CM is provided to master database module 11. Comparison module 1520 then determines the difference ACM between the batched CM and the CM amount specified in the formulation.

At step 1820, a first standard deviation is determined based on the first differences. In the illustrative embodiment, comparison module 1520 calculates the Standard Deviation SDrCM of the difference of batched CM versus design specification (formulation) CM over all batches produced in the production facility.

At step 1830, a second difference between a measured quantity of water and a second quantity specified in the formulation is determined for each of the plurality of batches, where water is the total water added during production, transportation, and delivery to the delivery site. As described above, for each batch, the batched W is measured, and information indicating the batched W is provided to master database module 11. Comparison module 1520 determines the difference ΔW between the batched W and the W amount in the formulation.

At step 1840, a second standard deviation is determined based on the second differences. Comparison module 1520 calculates the Standard Deviation SDrW of the difference of batched W versus the design specification (formulation) W over all batches produced in the production facility.

At step 1850, a measure of concrete strength performance quality is determined for the production facility based on the first standard deviation and the second standard deviation. In the manner described above, comparison module 1520 determines SD(ΔS) based on SDrCM and SDrW.

At step 1860, a measure of a cost of adjusting the formulation is determined based on the measure of concrete strength performance quality. Comparison module 1520 calculates the potential impact on costs of adjusting the design specification (formulation). For example, as described above, increasing F′cr may result in an increase in costs due to an increase in the cost of CM in the mixture. The increase in CM cost Δ$CMB may be calculated using equations discussed above.

In accordance with another embodiment, statistical data is provided to a producer and/or a customer, for example, via a web page displayed on a user device. Suppose, for example, that a producer who owns and/or manages a plurality of production facilities wishes to compare the performance of the various production facilities. Statistical performance measures of the respective performance facilities are provided. For example, in the illustrative embodiment of FIG. 15, the producer may employ user device 1540 to access a web page and view the statistical data.

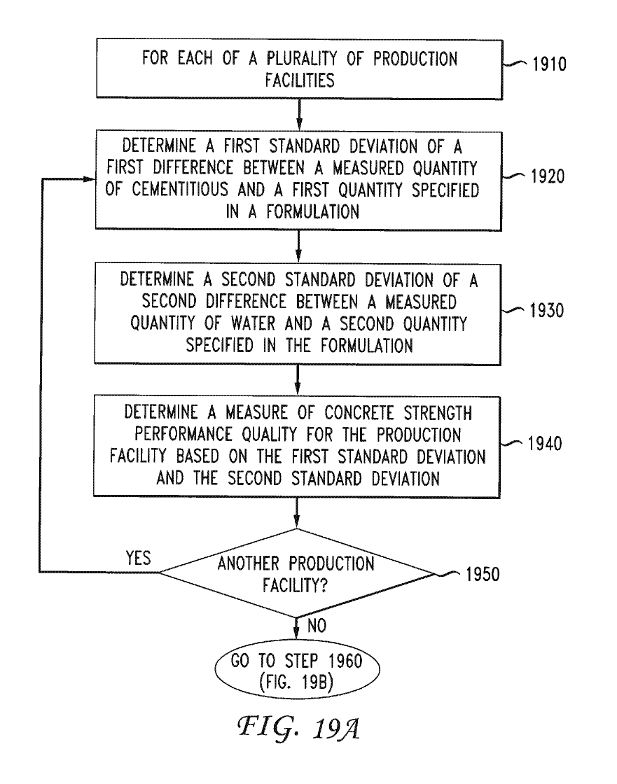

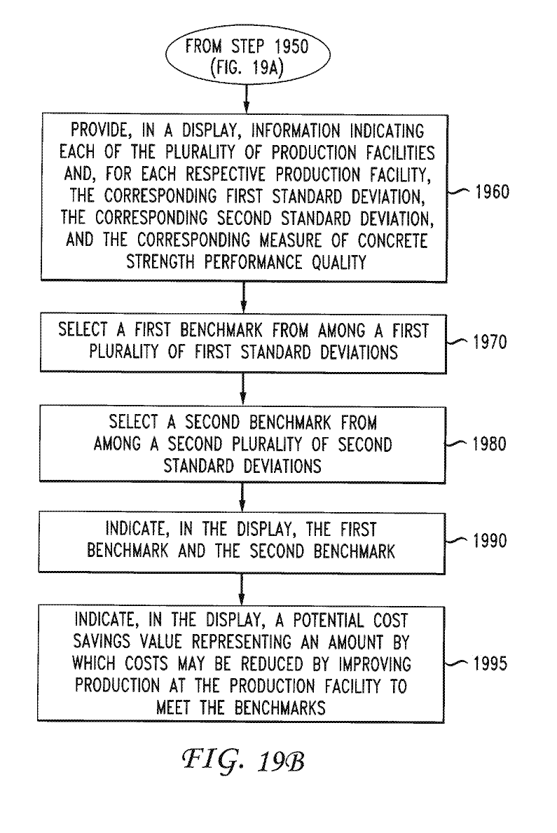

FIGS. 19A-19B comprise a flowchart of a method of providing comparative statistical information relating to a plurality of production facilities in accordance with an embodiment. Referring to block 1910, for each of a plurality of production facilities, a series of actions is performed as described below.

For a selected production facility (such as Production Facility A(841)), the following steps are performed. At step 1920, a first standard deviation of a first difference between a measured quantity of cementitious and a first quantity specified in a design specification is determined. Comparison module 1520 computes the first standard deviation SDrCM of the difference of batched CM versus design specification (formulation) CM over all batches produced in the production facility, as described above in steps 1810-1820.

At step 1930, a second standard deviation of a second difference between a measured quantity of water and a second quantity specified in the design specification is determined. Comparison module 1520 computes the second standard deviation SDrW of the difference of batched W versus the design specification (formulation) W over all batches produced in the production facility, as described above in steps 1830-1840.

At step 1940, a measure of concrete strength performance quality for the production facility is determined based on the first standard deviation and the second standard deviation. Comparison module 1520 computes SD(ΔS) based on SDrCM and SDrW, as described above in step 1850.

Referring to block 1950, the method may return to step 1920 and statistics for another production facility may be generated in a similar manner. Preferably, statistical information is generated for a plurality of production facilities. Otherwise, the method proceeds to step 1960 of FIG. 19B.

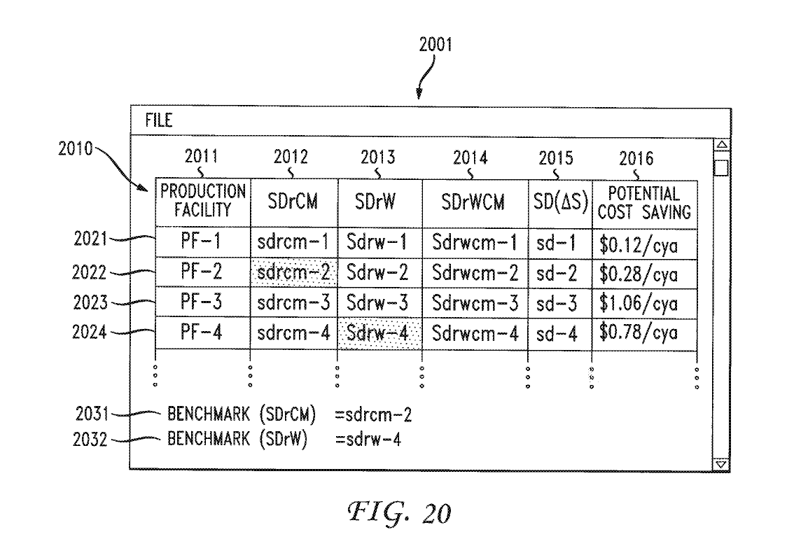

At step 1960, information indicating each of the plurality of production facilities and, for each respective production facility, the corresponding first standard deviation, the corresponding second standard deviation, and the corresponding measure of concrete strength performance quality, is provided in a display. In one embodiment, the statistical information computed by comparison module 1520 may be displayed on a web page such as that shown in FIG. 20. Web page 2001 includes a statistics table 2010 which includes six columns 2011, 2012, 2013, 2014, 2015, and 2016. Production facility identifier column 2011 includes identifiers for a plurality of production facilities. Columns 2012, 2013, 2014, and 2015 store values for SDrCM, SDrW, SDrWCM, and SD(ΔS), respectively, for each respective production facility listed. For example, referring to record 2021, the production facility identified as PF-1 has the following statistics: sdrcm-1; sdrw-1; sdrwcm-1; sd-1. Column 2016 displays a potential cost savings for each production facility listed.

At step 1970, a first benchmark is selected from among a first plurality of first standard deviations. For example, in the illustrative embodiment, comparison module 1520 may determine that the standard deviation associated with the best performance among those displayed in SDrCM column 2012 is sdrcm-2 (shown in record 2022).

At step 1980, a second benchmark is selected from among a second plurality of second standard deviations. For example, comparison module 1520 may determine that the standard deviation associated with the best performance among those displayed in SDrW column 2013 is sdrw-4 (shown in record 2024).

At step 1990, the first benchmark and the second benchmark are indicated in the display. In the illustrative embodiment, the benchmark standard deviations are displayed, respectively, in a Benchmark (SDrCM) field 2031 and a Benchmark (SDrW) field 2032. The two benchmark values are also highlighted in columns 2012, 2013. In other embodiments, the benchmark values may be indicated in a different manner. In another embodiment, a benchmark standard deviation of strength (PSI) is determined based on the benchmark values from fields 2031, 2032, and/or the values in column 2014. A benchmark consistency value may be determined as well. The benchmark standard deviation of strength value and benchmark consistency value may be displayed on web page 2001.

At step 1995, a potential cost savings value representing an amount that may be saved by improving production at the production facility to the benchmark is displayed in the display. For example, comparison module 1520 determines, for each production facility listed, how much savings may be achieved by improving the production process at the facility to meet the first and second benchmarks. In the illustrative embodiment of FIG. 20, the cost savings information is displayed in column 2016.

In another embodiment, a single generalized benchmark is determined based on the first benchmark and the second benchmark. A potential cost savings value is determined based on the generalized benchmark.

These and other aspects of the present Invention may be more fully understood by the following Examples.

### Example

### Illustration of the Impact of Concrete SD on its CM Cost

As shown in Table 1, concrete variability impacts its CM (cementitious cost) cost very significantly. The analysis is performed for a concrete of structural grade 4,000 psi, and using the referenced equations previously derived in this document. The example analysis assumes a CM efficiency factor, Φ=8 psi/(LB·cyd), and a CM cost, K=$0.045/Lb. Starting at a SD of 200 psi, the SD is increased in 100 psi increments in column 2, the mix design strength computed in columns 3 & 4 per two different ACI formulae, with the higher value always governing. The mix CM cost is computed in column 5. The cost of quality variability is well illustrated in columns 6 & 7; column 6 shows that per each 100 psi increase in standard deviation of strength, the CM cost will increase between $0.75 to $1.31 per cyd. Column 7 shows that the CM cost relative to very high quality concrete (represented by row 1) can increase dramatically by more than $8/cyd. Noting that the concrete industry on average generates a net profit of on the order of $0.5 to $2 per cyd, this example (using realistic numbers) illustrates the tremendous importance of maintaining low variability.

An important factor for maintaining low strength performance variability is the consistency of the batching process.

TABLE 1

| | Ref# | | | | | | |
|---|---|---|---|---|---|---|---|
| | 1 | | 3 | 4 | | | 7 |
| | Eng Design | 2 | Mix Design | | 5 | 6 | Relative cost |
| | Strength | SD, | Strength: F′cr, psi | | $CM/CYD | $CM per | of Variance |
| Ref# | F′c, psi | psi | Eq [1] | Eq [2] | Eq [9] | 100 psi SD | DEL_$CM/cyd |
| 1 | 4,000 | 200 | 4,268 | 3,966 | $24.01 | $0.00 | $0.00 |
| 2 | 4,000 | 300 | 4,402 | 4,199 | $24.76 | $0.75 | $0.75 |
| 3 | 4,000 | 400 | 4,536 | 4,432 | $25.52 | $0.75 | $1.51 |
| 4 | 4,000 | 500 | 4,670 | 4,665 | $26.27 | $0.75 | $2.26 |
| 5 | 4,000 | 600 | 4,804 | 4,898 | $27.55 | $1.28 | $3.54 |
| 6 | 4,000 | 700 | 4,938 | 5,131 | $28.86 | $1.31 | $4.85 |
| 7 | 4,000 | 800 | 5,072 | 5,364 | $30.17 | $1.31 | $6.17 |
| 8 | 4,000 | 900 | 5,206 | 5,597 | $31.48 | $1.31 | $7.48 |
| 9 | 4,000 | 1,000 | 5,340 | 5,830 | $32.79 | $1.31 | $8.79 |

Set forth below is a discussion of real-time batch data variability with respect to mixture design factors (as specified in a formulation, for example). Hypothetical data are used to illustrate a quantification of the cost of strength performance variably as driven by batching variability.

### Example

### Quantification of Batching Data Variability

Table 2 sets forth a set of real time data in columns 1-5. Column 6 shows the computed standard deviation W/CM using the raw data from columns 3 and 5.

In the example of Table 2, production facility (plant) #141, represented by row 9, is designated as the benchmark production facility (plant) because it shows the least variability.

TABLE 2
Example Quantification of Strength Standard Deviation
due to Batching Variability, and the Resulting Cost
Table 1

| | | Ref# | | | | | |
|---|---|---|---|---|---|---|---|
| | | 1 | 2 | 3 | 4 | 5 | 6 |
| | | Measured from CLI batch analysis | | | | | Eq [6] - data |
| | | | Del_CM % | | Del_WATER % | | [A] & [B] |
| | | Period | FROM MIX | | FROM MIX | | STDEV |
| Table [1] | | Volume, | AVG | [A] | AVG | [B] | W/CM [C] |
| Ref # | PLANT | cyds | DELTA | SDrCM | DELTA | SDrW | SDrWCM |
| 1 | 121 | 5,500 | 0.10% | 0.50% | −22.00% | 3.60% | 3.6% |
| 2 | 122 | 3,000 | 0.11% | 0.68% | −3.60% | 5.40% | 5.4% |
| 3 | 124 | 6,800 | −22.30% | 8.20% | −14.00% | 8.00% | 11.5% |
| 4 | 128 | 2,000 | 0.85% | 1.58% | −10.00% | 4.50% | 4.8% |
| 5 | 131 | 8,990 | −0.49% | 0.33% | −13.70% | 6.00% | 6.0% |
| 6 | 135 | 6,000 | −0.33% | 0.59% | −7.40% | 2.10% | 2.2% |
| 7 | 138 | 2,500 | −0.08% | 0.56% | −11.00% | 5.30% | 5.3% |
| 8 | 140 | 9,850 | −0.33% | 0.40% | −8.70% | 11.60% | 11.6% |
| 9 | 141 | 6,780 | −0.16% | 0.70% | −12.40% | 2.00% | 2.1% |
| 10 | 142 | 4,560 | −0.09% | 0.23% | −9.60% | 3.60% | 3.6% |
| 11 | 143 | 7,860 | 0.34% | 0.71% | −20.20% | 6.00% | 6.0% |
| 12 | 146 | 3,450 | 1.26% | 4.08% | −13.80% | 6.60% | 7.8% |
| 13 | 147 | 5,450 | 2.20% | 1.82% | −14.60% | 2.10% | 2.8% |
| 14 | 150 | 9,540 | 0.41% | 1.71% | −11.00% | 9.20% | 9.4% |

Assuming an average concrete mix design strength of 4,000 psi, Table 3 shows the strength SD (Column 3) computed from the SD of W/Cm; the strength SD varies by more than a factor of 5 from 85 psi for the benchmark plant to 458 psi in plant #124 (row 3). If this batching strength SD were reduced to the benchmark value, then significant CM costs would be saved as shown in column 4; this cost factor varies from $0.02 per cyd to $2.85 due to the varying batching qualities of the production facilities.

Supposing that the mix designs (formulations) developed for the benchmark plant (production facility) are used across all the production facilities, this could lead to a very costly situation, since probability analysis shows that for each 100 psi increase in strength SD from its assumed mix design value, the failure rate will increase by more than 4%, which translates to a potential remedial cost of around $2/cyd per 100 psi of SD increase.

TABLE 3
Closed Loop W/CM Ratio & Batching Strength
Standard Deviations From Real Time Data

| | | Ref# | | | |
|---|---|---|---|---|---|
| | | | | 3 | 4 |
| | | | | Computed from batch | |
| | | | 2 | data for avg strength | |
| | | | Computed per | of 4,000 psi | |
| | | 1 | Table [1] | Batching | |
| | | Period | STDEV W/CM | Strength SD | Bench Mark |
| Table [2] | | Volume, | [C] | [D] | Savings |
| Ref # | PLANT | cyds | SDrWCM | SD(Del_S) | [E] |
| 1 | 121 | 5,500 | 3.6% | 145 | $0.45 |
| 2 | 122 | 3,000 | 5.4% | 218 | $1.00 |
| 3 | 124 | 6,800 | 11.5% | 458 | $2.80 |
| 4 | 128 | 2,000 | 4.8% | 191 | $0.80 |
| 5 | 131 | 8,990 | 6.0% | 240 | $1.17 |
| 6 | 135 | 6,000 | 2.2% | 87 | $0.02 |
| 7 | 138 | 2,500 | 5.3% | 213 | $0.96 |
| 8 | 140 | 9,850 | 11.6% | 464 | $2.85 |
| 9 | 141 | 6,780 | 2.1% | 85 | $0.00 |
| 10 | 142 | 4,560 | 3.6% | 144 | $0.45 |
| 11 | 143 | 7,860 | 6.0% | 242 | $1.18 |
| 12 | 146 | 3,450 | 7.8% | 310 | $1.69 |
| 13 | 147 | 5,450 | 2.8% | 111 | $0.20 |
| 14 | 150 | 9,540 | 9.4% | 374 | $2.17 |
| | | | | AVG/YCD | $1.21 |

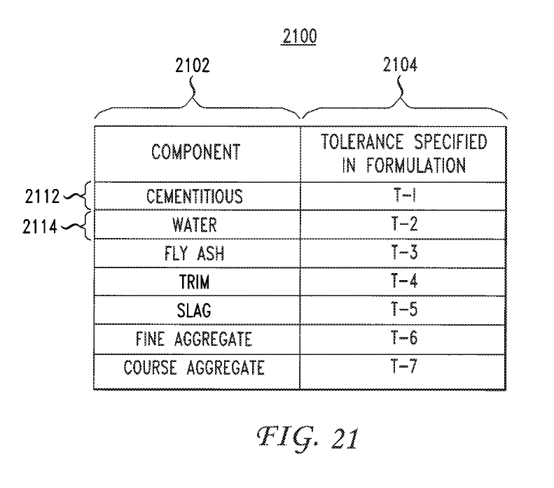

In accordance with another embodiment, statistical performance data is generated and maintained for one or more production facilities. As discussed above, tolerance information may be stored at master database module 11. For example, tolerance information for a particular component may indicate a tolerance limit to be used to determine acceptable variances relative to a quantity specified in the formulation. Any measured variance in the quantity of the component in a batch produced, relative to the specified quantity, that falls within the tolerance limit may be considered acceptable. Tolerance information for a particular mixture formulation may be maintained in a tolerance table or other data structure. For example, FIG. 21 shows a tolerances table 2101 that may be maintained, for example, for Mixture Formulation A (810). Tolerances table 2101 may be stored in tolerances database 804. Tolerances table 2101 includes a column 2102 that indicates respective components specified in the mixture formulation, and may specify other aspects of the formulation as well. In the illustrative embodiment, column 2102 specifies cementitious, water, fly ash, trim, slag, fine aggregate, course aggregate, etc. Column 2104 stores tolerance data for each respective component (or other aspect) specified in column 2102. Thus, referring to record 2112, the tolerance for cementitious in the particular mixture formulation is T-1. Likewise, referring to record 2114, the tolerance for water is T-2. Tolerances may be expressed as percentages, for example, or in another form.

In accordance with another embodiment, a dashboard function that displays real-time performance data to users is provided. The dashboard is enabled by the closed process of reconciling physical batch (formulation) results to target formulation values. Reconciliation means that for each and every physical batch, all component variances (deltas) are calculated with respect to their mix design values. The deltas are expressed either as units of measure (lb/cyd, kg/m3, etc.) or as a percentage relative to the mix design (formulation) target amount.

A set of cost deltas ($delta) can be computed analogously by considering $delta in $/cyd (or $/m3) as the cost variance of each component relative to its mix design target, or as a percentage. The total $-batch variance from the $-mix may also be determined and provided, also as $/cyd or as a percentage.

In one embodiment, real-time benchmarking is accomplished within a ready mix concrete operation comprising a number of concrete production facilities by benchmarking the most consistent production facilities as the best practice, and to leverage this to the standard practice.

In various embodiments, a number of different measures of benchmarking relating to the accuracy and consistency of the batching delta values may be used.

As used herein, degree of accuracy means the percentage of time that the delta factors are within user set tolerances. Thus, if delta-cement tolerance is set to a percentage, and the best production facility has a within tolerance score of 95%, then the benchmark for delta-cement accuracy is 95%. If the worst production facility has a score of 35%, then its benchmark accuracy score becomes 35/95=36.8%. An overall benchmark accuracy score may also be computed across multiple production facilities by volume average.

Two types of costs may be associated with the benchmark accuracy score: (1) cost of materials wastage; and (2) risk cost of under-performance (non-concrete, rejects, or damage due to non-performance).

Wastage can be computed by looking at amounts over-batched. It is known in the concrete industry that the cost of materials accounts for more than 50% of the cost of business, and that a 1% increase in the cost of materials due to wastage results in a decrease in profitability of 10%. Therefore, it is desirable to avoid materials wastage as compared to optimized mix design (formula) amounts. Wastage may be reduced, for example, by making visible in real-time, to operators and managers of production facilities the wastage amounts and costs. This may be done using batch-man gauges as described herein and as shown in the Drawings.

Risk costs are equal to cost of rejection, which in the concrete industry means either rejecting a truck load because it is deemed substandard or rejecting poured concrete and having to physically remove it and replace it. These costs can prove prohibitive and range from 1× to more than 5× the delivered concrete cost. Such risks can be quantified by systems and methods described herein through deployment of real-time performance gauges as described herein which monitor, for each production facility, the frequency of exceeding a set upper tolerance of batched amounts compared to the formulation amount.

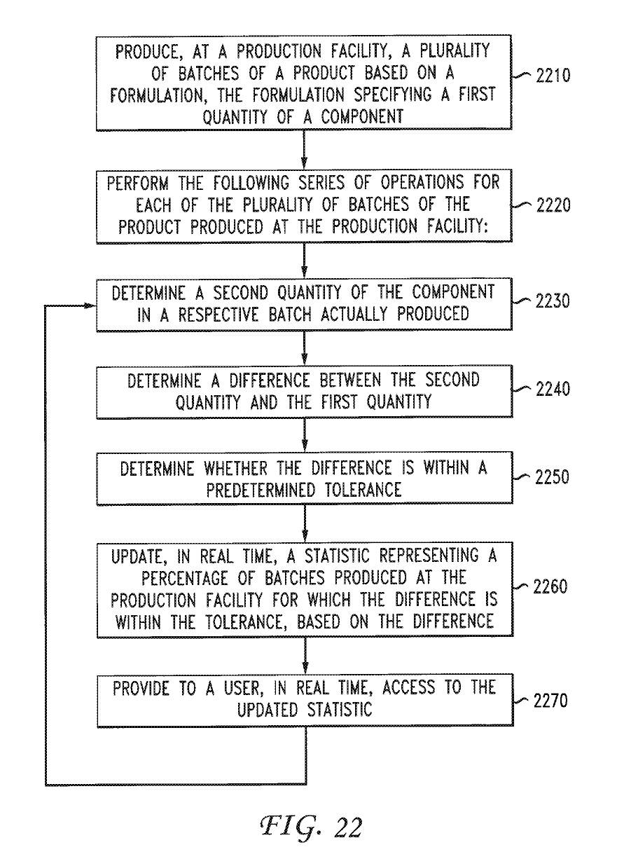

In accordance with one embodiment, statistical performance data for a production facility is generated and provided to a user, in real time. For example, various components and other aspects of a product may be measured for each batch produced at a particular production facility, and compared to the formulation to determine one or more measures of performance for the production facility. FIG. 22 is a flowchart of a method of providing statistical performance data in accordance with an embodiment. In the method described in FIG. 22, it is supposed that the formulation specifies a first quantity of a particular component.

At step 2210, a plurality of batches of a product are produced at a production facility, based on a formulation specifying a first quantity of a component. At step 2220, a series of operations is performed for each of a plurality of batches of a product produced at a production facility. Thus, for each batch of the product produced at the production facility, the operations set forth below are performed.

At step 2230, a second quantity of the component in the batch actually produced is determined. The actual quantity of the component in the batch is measured.

At step 2240, a difference between the second quantity and the first quantity is determined. Comparison module 1520 calculates the difference between the actual quantity and the quantity specified in the formulation. The difference may be expressed as a real number or as a percentage, for example.

At step 2250, a determination is made whether the difference is within a predetermined tolerance. The difference is compared to the appropriate tolerance stored in tolerances database 804, and a determination is made whether or not the difference is within the acceptable tolerance specified therein.

At step 2260, a statistic representing a percentage of batches produced at the production facility for which the difference is within the tolerance is updated, in real time, based on the difference. For example, a count of the number of batches which are within the specified tolerance may be maintained and updated after each batch is measured and analyzed. A percentage figure indicating a percentage of all batches which are within the specified tolerance may be generated, based on the updated count. The count and the statistic are maintained at master database module 11.

At step 2270, access to the updated statistic is provided to a user, in real time. For example, a producer and/or a customer may be allowed to access a web page showing the current percentage figure, as well as other statistical data relating to the particular production facility. The information displayed on the web page is updated in real time to enable the user to view the most current performance data.

When another batch is produced at the production facility, the routine returns to step 2230. A quantity of the component in the new batch is measured, and other steps of the routine are repeated.

The product may be any formulation-based product. In various embodiments, the product may comprise, for example, and without limitation, a chemical compound or other type of chemical-based product, a petroleum-based product, a food product, a pharmaceutical drug, a concrete mixture, etc.

Further embodiments are described in more detail below.

In one embodiment, statistical performance data are maintained for a concrete mixture production facility. For example, in an illustrative embodiment, a performance measure is generated and maintained for Production Facility A (841) to indicate how consistently the production facility includes the correct quantity of cementitious in batches of a concrete mixture. In particular, the statistic is maintained for batches of the concrete mixture defined by Mixture Formulation (810) that are produced at Production Facility A (841). Suppose further that Mixture Formulation (810) specifies a quantity of cementitious that should be included in each batch.

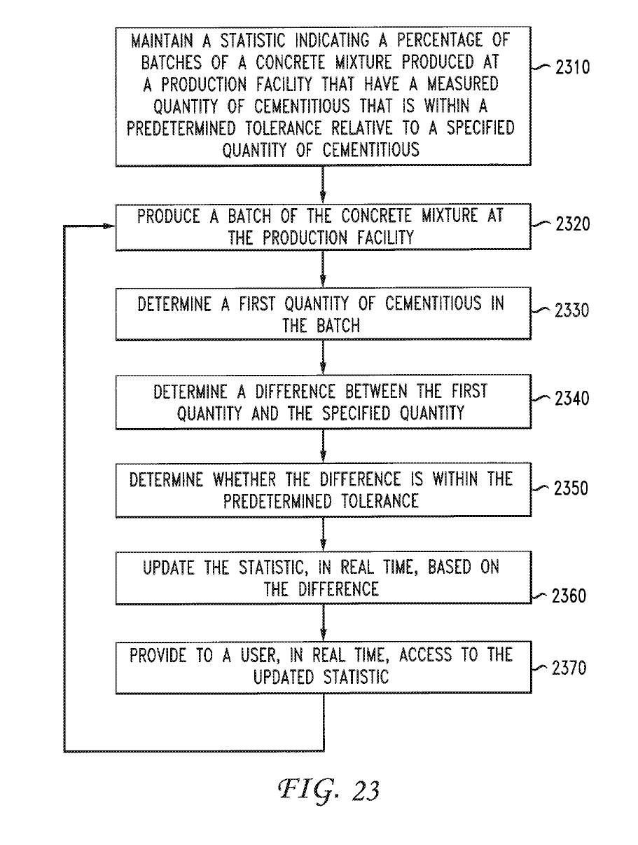

FIG. 23 is a flowchart of a method of maintaining statistical performance data for a concrete mixture production facility in accordance with an embodiment. At step 2310, a statistic indicating a percentage of batches of a concrete mixture produced at a production facility that have a measured quantity of cementitious that is within a predetermined tolerance relative to a specified quantity of cementitious is maintained. Thus, a statistic is established and maintained at master database module 11 to indicate the percentage of batches produced at Production Facility A (841) based on Mixture Formulation (810) that have a measured quantity of cementitious within a predetermined tolerance of the quantity specified in Mixture Formulation (810). The statistic may comprise a percentage value, for example.

As batches of the mixture are produced at Production Facility A (841), data is generated for each batch, and the statistic is continually updated. Thus, at step 2320, a batch of the concrete mixture is produced at the production facility. At step 2330, a first quantity of cementitious in the batch is determined. When a batch of concrete is produced at Production Facility A (841) based on Mixture Formulation (810), the actual quantity of cementitious in the batch is measured. The measured quantity is provided to master database module 11, where the data is stored.

At step 2340, a difference between the first quantity and the specified quantity is determined. Comparison module 1520 accesses the quantity data and calculates the difference between the measured quantity of cementitious and the quantity specified in Mixture Formulation (810).

At step 2350, a determination is made whether the difference is within the predetermined tolerance. Comparison module 1520 accesses tolerances table 2101 (shown in FIG. 21) and examines the tolerance associated with cementitious. A determination is made whether the difference calculated at step 2340 is within the tolerance specified in table 2101.

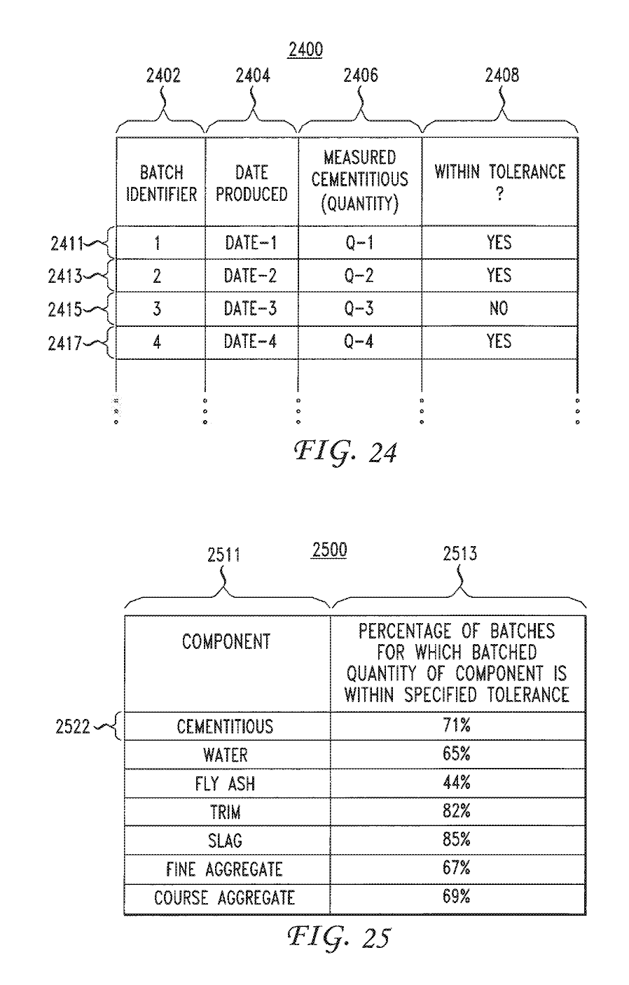

In the illustrative embodiment, statistical data relating to each respective batch is stored in a batch table. FIG. 24 shows an exemplary batch table 2400 in accordance with an embodiment. Batch table 2400 includes a column 2402 storing batch identifiers identifying respective batches of the concrete mixture (associated with Mixture Formulation (810)) that are produced at Production Facility A (841). Column 2404 stores data indicating the date when each respective batch is produced. Column 2406 stores information indicating the actual, measured quantity of cementitious in each respective batch. Column 2408 stores data indicating whether the actual measured quantity of cementitious is within the appropriate tolerance. Thus, for example, record 2411 indicates that a batch identified as batch number 1 was produced on DATE-1 and contained quantity Q-1 of cementitious. Column 2408 stores “YES” indicating that the quantity Q-1 is within the specified tolerance.

Records 2413, 2415, and 2417 hold similar information for three other batches produced at Production Facility A (841). Referring to column 2408, the quantity of cementitious in batches 2 and 4 were within the specified tolerance; however, record 2415 contains “NO” in column 2408 indicating that the quantity of cementitious in batch 3 was not within the specified tolerance.

In one embodiment, comparison module 1520 maintains batch table 2400. Thus, when comparison module 1520 receives data relating to a batch, comparison module 1520 stores some or all of the information in batch table 2400. In other embodiments, other types of information may be stored in batch table 2400.

At step 2360, the statistic is updated, in real time, based on the difference. After each batch is produced at Production Facility A (841), comparison module 1520 creates a new record in table 2400 for the new batch. The measured amount of cementitious in the batch is recorded, a determination is made whether the measured quantity falls within the specified tolerance, and the statistic (i.e., the percentage value) is updated based on the data for the new batch.

Batch table 2400 is maintained and updated in real time. Thus, when comparison module 1520 receives information relating to a quantity of a component in a particular batch, comparison module 1520 updates batch table 2400 in accordance with predetermined time limits and requirements.

In one embodiment, statistics and percentage values may be maintained for a variety of different components specified in a mixture formulation. FIG. 25 shows a performance data table 2500 that may be maintained for a particular production facility (such as Production Facility A (841) in accordance with an embodiment. Table 2500 includes a column 2511 specifying respective components associated with a particular mixture formulation. In the illustrative embodiment, column 2511 specifies cementitious, water, fly ash, trim, slag, fine aggregate, and coarse aggregate. Table 2500 also includes a column 2513, containing a percentage representing the percentage of batches produced at the production facility that contain a quantity of the specified component within the acceptable tolerance. For example, record 2522 indicates that 71% of batches produced at Production Facility A (841) based on Mixture Formulation (810) contain a quantity of cementitious within acceptable tolerances.

Returning to FIG. 23, at step 2370, access to the updated statistic is provided to a user, in real time. Performance data, including the percentage data stored in table 2500, may be provided to a user (such as a producer or customer) in any suitable manner. For example, table 2500 may be displayed on a web page available to a user.

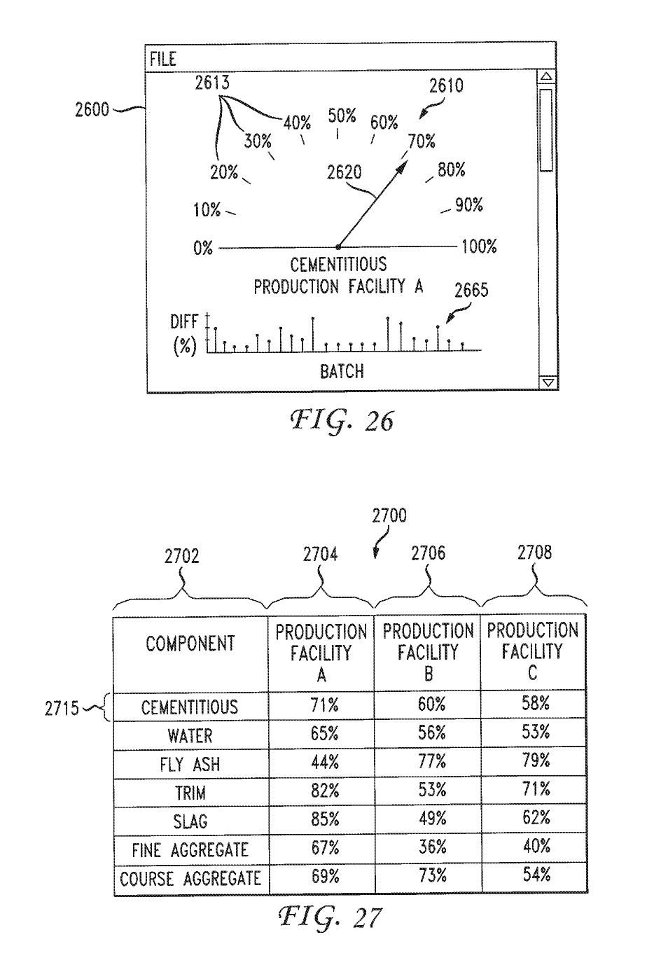

In another embodiment, performance data may be provided to a user in graphical form. For example, a user (such as a producer or customer) employing user device 1540 (shown in FIG. 15) may access a web page displaying performance data in one or more graphical formats. FIG. 26 shows a web page 2600 displaying a gauge 2610 showing performance data generated for batches produced at Production Facility A (841). Thus, gauge 2610 comprises a semi-circular scale having percentage values 2613 ranging from zero to one hundred percent, and an indicator 2620 indicating the percentage of batches produced at the production facility having a quantity of cementitious within the specified tolerance. Consistent with the information stored in record 2522 of table 2500 (shown in FIG. 25), indicator 2620 indicates the percentage value 71%. Gauges such as that shown in FIG. 26 may be displayed for other components specified in a mixture formulation.

Web page 2600 also displays a graph 2665 showing data for a plurality of batches produced at Production Facility A (841). Specifically, graph 2665 shows, for each of a plurality of batches, a percentage value representing a difference between a measured quantity of cementitious and the quantity of cementitious specified in the formulation.

In one embodiment, the color of a gauge such as that shown in FIG. 26 may be altered to provide information to a user. For example, colors may be used to indicate whether the “within acceptable tolerances rate” shown by the gauge is at a level considered to be high, or at a medium level, or at a low level. For example, gauge 2610 (or only a portion of the gauge such as indicator 2620) may turn GOLD if the within acceptable tolerance rate is high, SILVER if the rate is medium, or RED if the rate is low.

In another embodiment, performance data relating to various components in a mixture formulation may be generated and maintained for a plurality of production facilities. FIG. 27 shows a performance data table storing performance data for a plurality of production facilities in accordance with an embodiment. Performance data table 2700 includes a column 2702 specifying respective components associated with a particular mixture formulation. In the illustrative embodiment, column 2702 specifies cementitious, water, fly ash, trim, slag, fine aggregate, and coarse aggregate, in a manner similar to table 2500. Columns 2704, 2706, and 2708 hold performance data for respective production facilities. Thus, column 2704 holds performance data for Production Facility A (841), column 2706 holds performance data for Production Facility B (842), and column 2708 holds performance data for Production Facility C (843). Table 2700 facilities a comparison of performance data for several different production facilities. Row 2715, for example, shows that 71% of batches produced at Production Facility A have a quantity of cementitious within specified tolerances, 60% of batches produced at Production Facility B have a quantity of cementitious within specified tolerances, and 58% of batches produced at Production Facility C have a quantity of cementitious within specified tolerances.

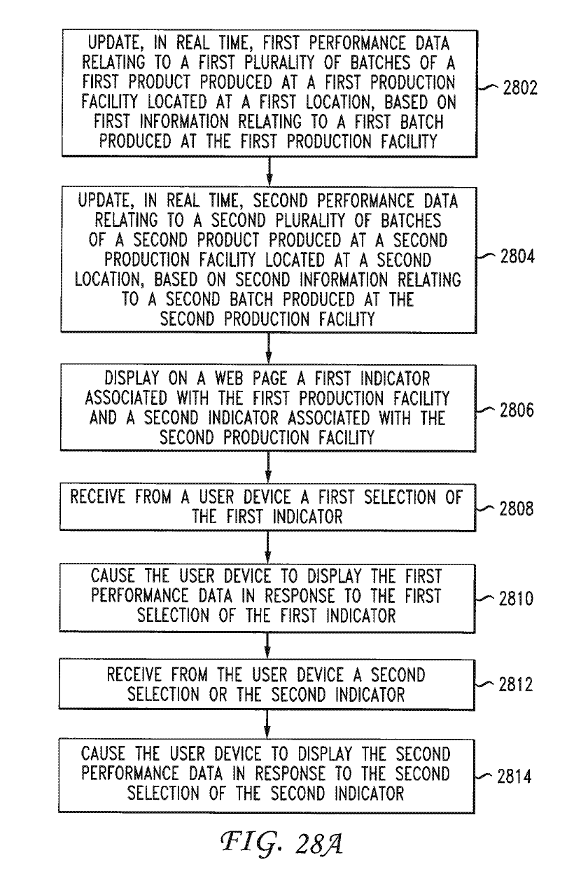

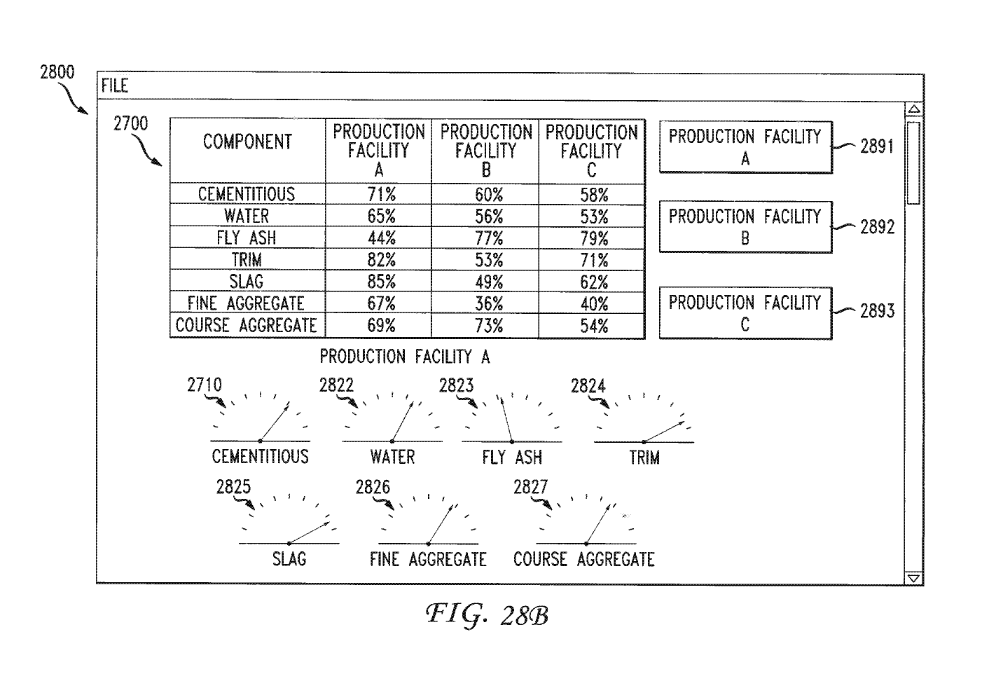

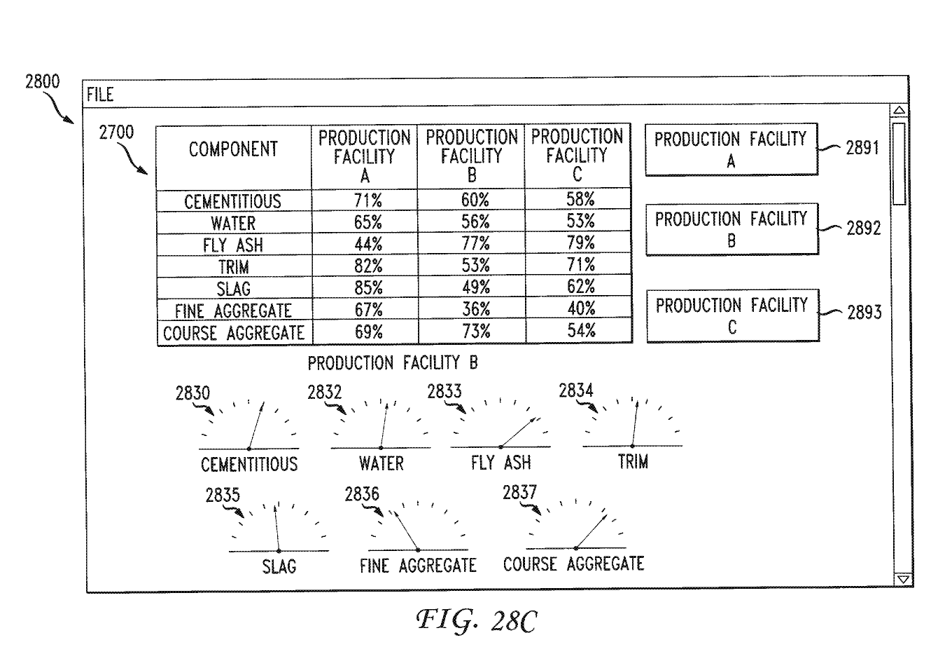

In another embodiment, access to performance data for a plurality of production facilities may be provided to a user. For example, suppose that a producer wishes to monitor, in real time, performance data for Production Facility A (841), Production Facility B (842), and Production Facility C (843). FIG. 28A is a flowchart of a method of managing performance data for a plurality of production facilities in accordance with an embodiment. At step 2802, first performance data relating to a first plurality of batches of a first product produced at a first production facility located at a first location are updated, in real time, based on first information relating to a first batch produced at the first production facility. As discussed above, performance data for Production Facility A (841) is maintained in a table such as table 2700 (shown in FIG. 27). Thus, data relating to various components (cementitious, water, fly ash, etc.) in batches produced at Production Facility A (841) may be maintained and continuously updated in table 2700. In particular, when master database module 11 receives data relating to a new batch produced at Production Facility A (841), table 2700 is updated in real time.

At step 2804, second performance data relating to a second plurality of batches of a second product produced at a second production facility located at a second location are updated, in real time, based on second information relating to a second batch produced at the second production facility. Performance data for Production Facility B (842) is also maintained in table 2700. When master database module 11 receives data relating to a new batch produced at Production Facility B (842), table 2700 is updated in real time.

At step 2806, a first indicator associated with the first production facility and a second indicator associated with the second production facility are displayed on a web page. FIG. 28B shows a web page 2800 displaying performance data for a plurality of production facilities in accordance with an embodiment. For example, the producer may employ user device 1540 (shown in FIG. 15), and access page 2800 via network 1575. In the illustrative embodiment, master database module 11 maintains web page 2800. Alternatively, web page 2800 may be maintained by a separate server.

Web page 2800 displays performance data table 2700 (of FIG. 27) in an upper portion of the page, allowing the user to view performance data for several different production facilities. Web page 2800 also includes button 2891 associated with Production Facility A (841), button 2892 associated with Production Facility B (842), and button 2893 associated with Production Facility C (843). The user may select one of buttons 2891, 2892, 2893 to view performance data related to a particular production facility. In the illustrative embodiment of FIG. 28, the user selects button 2891 associated with Production Facility A (841).

At step 2808, a first selection of the first indicator is received from a user device. The user's selection of button 2891 is received by master database module 11. At step 2810, the user device is caused to display the first performance data in response to the first selection of the first indicator. In response to the user's selection of button 2891, master database module 11 causes user device 1540 to display a plurality of gauges in the lower portion of page 2800 showing performance data for Production Facility A (841) in graphical form. In particular, gauge 2710 shows a percentage of batches produced at Production Facility A (841) that have a quantity of cementitious within acceptable tolerances; gauges 2822, 2823, 2824, 2825, 2826, and 2927 show similar information for water, fly ash, trim, slag, fine aggregate, and course aggregate, respectively.

At step 2812, a second selection of the second indicator is received from the user device. Supposing that the user now wishes to view performance data for Production Facility B (842), the user selects button 2892 associated with Production Facility B (842). At step 2814, the user device is caused to display the second performance data in response to the second selection of the second indicator. In response to the user's selection of button 2892, master database module 11 causes user device 1540 to display performance data for Production Facility B (842). FIG. 28C shows web page 2800 on which performance data for Production Facility B is displayed. Web page 2800 continues to display performance data table 2700 in the upper portion of the page. In the lower portion of the page, gauges 2830, 2832, 2833, 2834, 2835, 2835, 2836, and 2837 display data related to amounts of various components in batches produced at Production Facility B (842). In this manner, the producer may view and compare performance data for various production facilities.

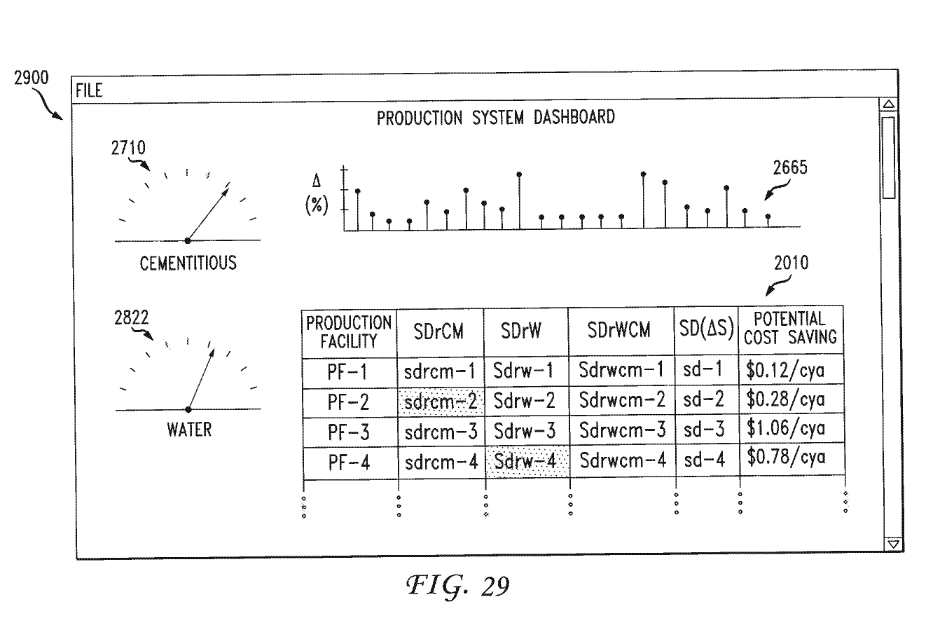

FIGS. 28B and 28C are not to be construed as limiting. In other embodiments, other types of performance data may be displayed on a web page. For example, FIG. 29 shows a web page displaying selected performance data for a plurality of production facilities in accordance with another embodiment. Web page 2900 displays gauges 2710 and 2822 (which are also displayed on page 2800 of FIG. 28B), graph 2665 (also displayed on page 2600 of FIG. 26) and standard deviation table 2010 (also displayed on page 2001 of FIG. 20). Other web pages showing other types of performance data may be provided.

In accordance with another embodiment, performance data related to a particular component (or other aspect of a mixture) is calculated for a particular production facility in accordance with principles of fuzzy logic. Fuzzy logic is known and used in fields including mathematics, logic, etc. Fuzzy logic is a form of many-valued logic, and deals with reasoning that is approximate rather than fixed and exact. Compared to binary sets, where variables take on true or false values, fuzzy logic variables may have a truth value that ranges in degree between zero and one.

Accordingly, in one embodiment, a quantity of a component is defined in a formulation by a variable; therefore, the quantity may vary within a range; the specified quantity of the component required for each particular mixture may depend on the value of one or more other parameters. Consequently, each particular mixture may require a different quantity of the component, and thus the tolerances used to analyze performance of the production facility also vary within a range. Performance data for a production facility may therefore be generated, and presented, as a range of percentage values rather than a single percentage value.

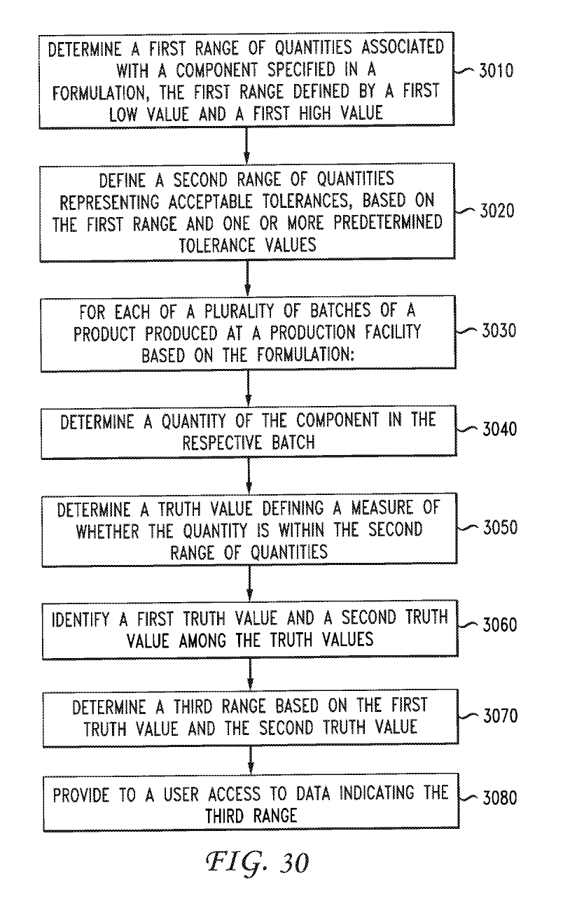

FIG. 30 is a flowchart of a method of generating performance data in accordance with fuzzy logic principles, in accordance with an embodiment. At step 3010, a first range of quantities associated with a component specified in a formulation is determined, wherein the first range is defined by a first low value and a first high value. For example, the formulation itself may specify that the quantity of a particular component may vary from a low quantity value QL to a high quantity value QH. The quantity required for any particular batch may be determined based on one or more parameters.

At step 3020, a second range of quantities representing acceptable tolerances is determined, based on the first range and one or more predetermined tolerance values. For example, supposing that a predetermined tolerance is used to determine acceptable tolerances for the mixture, the lower limit of acceptable tolerances may be QL minus the predetermined tolerance. The upper limit of acceptable tolerances may be QH plus the predetermined tolerance.

Now each batch of the mixture produced is analyzed based on the second range (representing acceptable tolerances). Specifically, referring to step 3030, a series of operations is performed for each of a plurality of batches of a product produced at a production facility based on the formulation. The series of operations is described below.

At step 3040, a quantity of the component in the respective batch is determined. Supposing that a respective batch is produced at the production facility, the quantity QB within the batch actually produced is determined.

At step 3050, a truth value defining a measure of whether the quantity is within a second range of quantities is determined. In accordance with fuzzy logic principles, a truth value representing a measure of whether QB is within the range of acceptable tolerances is determined.

At step 3060, a first truth value and a second truth value are identified among the truth values. Thus, the truth values associated with all the respective batches produced are examined, and the lowest and highest truth values are identified. At step 3070, a third range is determined based on the first truth value and the second truth value. A range of truth values is defined based on the lowest and highest truth values.

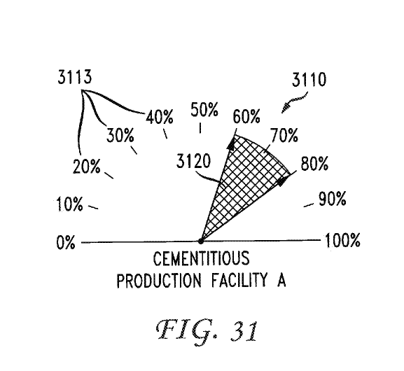

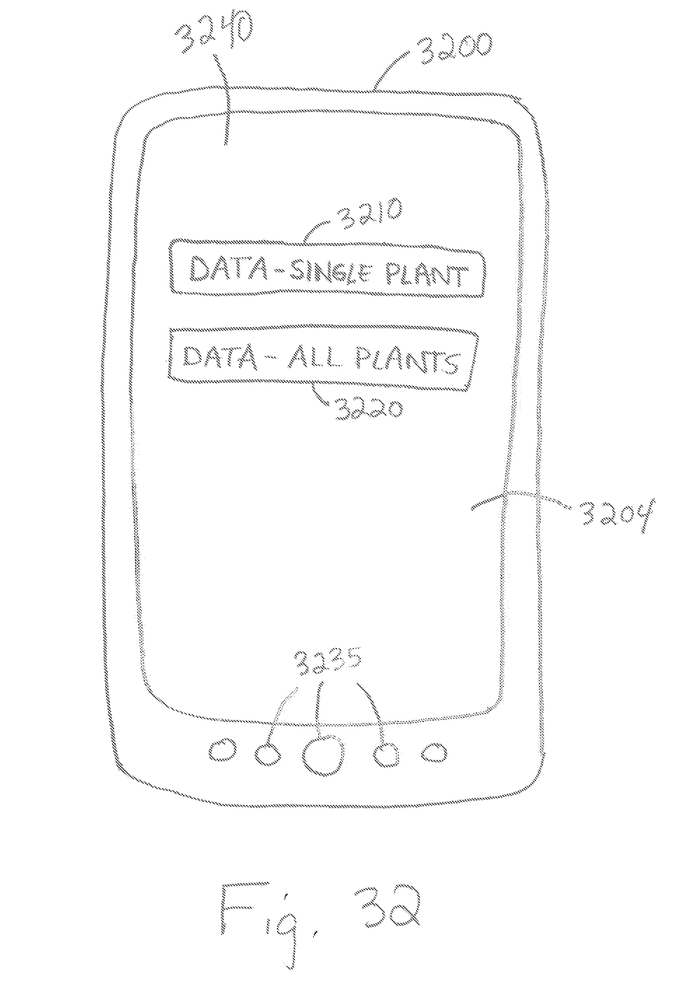

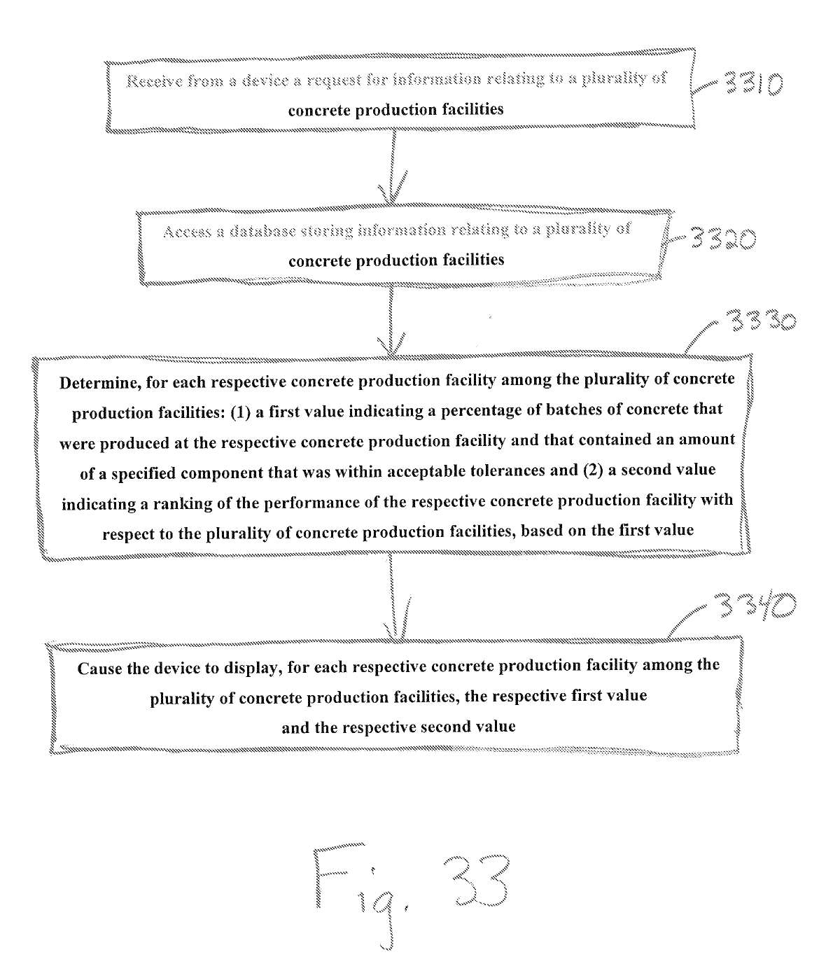

At step 3080, access to data indicating the third range is provided to a user. In one embodiment, the range of truth values may be presented to a user in graphical form. For example, the range of truth values may be displayed as a range of values on a gauge. FIG. 31 shows a gauge 3110 that may be displayed on a web page in accordance with an embodiment. Gauge 3110 shows percentage values 3113 from zero to one hundred percent. A range of values between approximately 60% and 80% is shown as a shaded region 3120, indicating a range of truth values associated with the quantity of cementitious in batches produced at Production Facility A (841). In other embodiments, fuzzy logic may be used to determine and display other types of performance data.

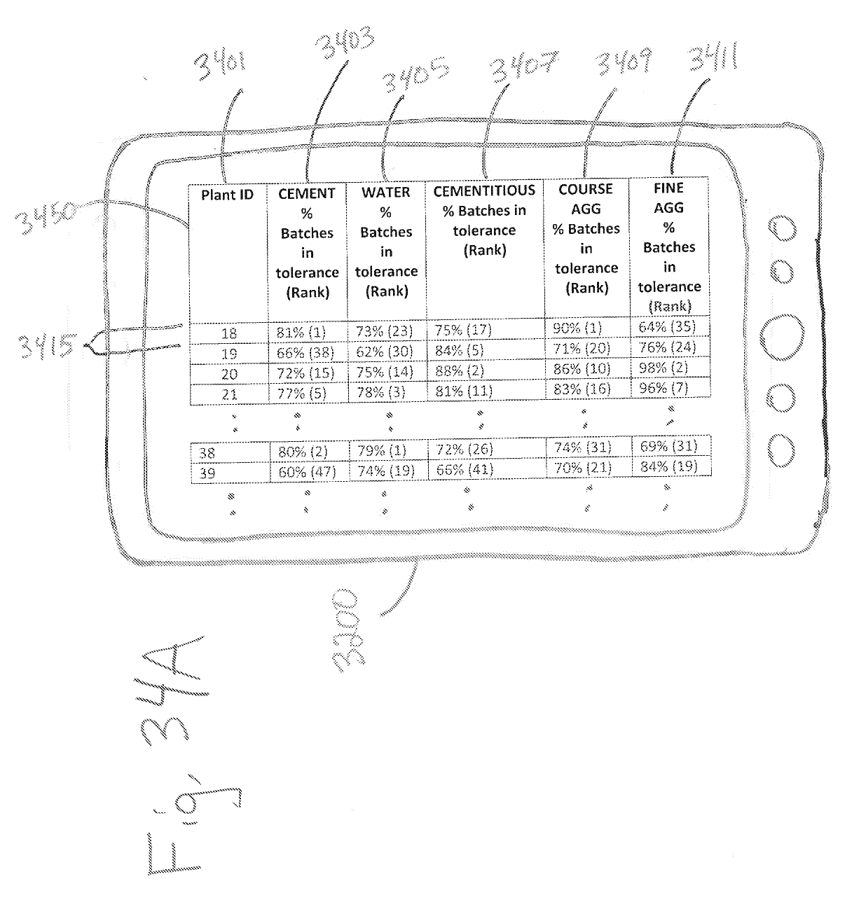

In accordance with another embodiment, one or more graphical indicators representing comparative performance data for a plurality of production facilities is displayed on a user device. In an illustrative embodiment, a user may employ a user device such as that shown in FIG. 32. User device 3200 includes a display screen 3204 and several control buttons 3235. User device 3200 may be a cell phone, a laptop device, or any other mobile processing device. Master database module 11 and device 3200 communicate using known methods and systems. For example, master database module 11 may use known communication methods and protocols to cause device 3200 to display information on screen 3204.

In other embodiments, other types of user devices may be used, such as a personal computer, a workstation, a mainframe computer, etc., or any other processing device.

If the user wishes to view statistical performance data relating to one or more production facilities, the user may employ user device 3200 to access a web page maintained by master database module 11 (or by another module), such as the page displayed on device 3200 in FIG. 32. Specifically, web page 3240 includes a first button 3210 labelled “DATA—SINGLE PLANT” and a second button 3220 labelled “DATA—ALL PLANTS.”

Supposing the user wishes to view statistical performance data for a plurality of production facilities, the user may select button 3220. User device 3200 transmits the user's selection of button 3220 to master database module 11 and, in response, master database module causes user device 3200 to display data for a plurality of production facilities.

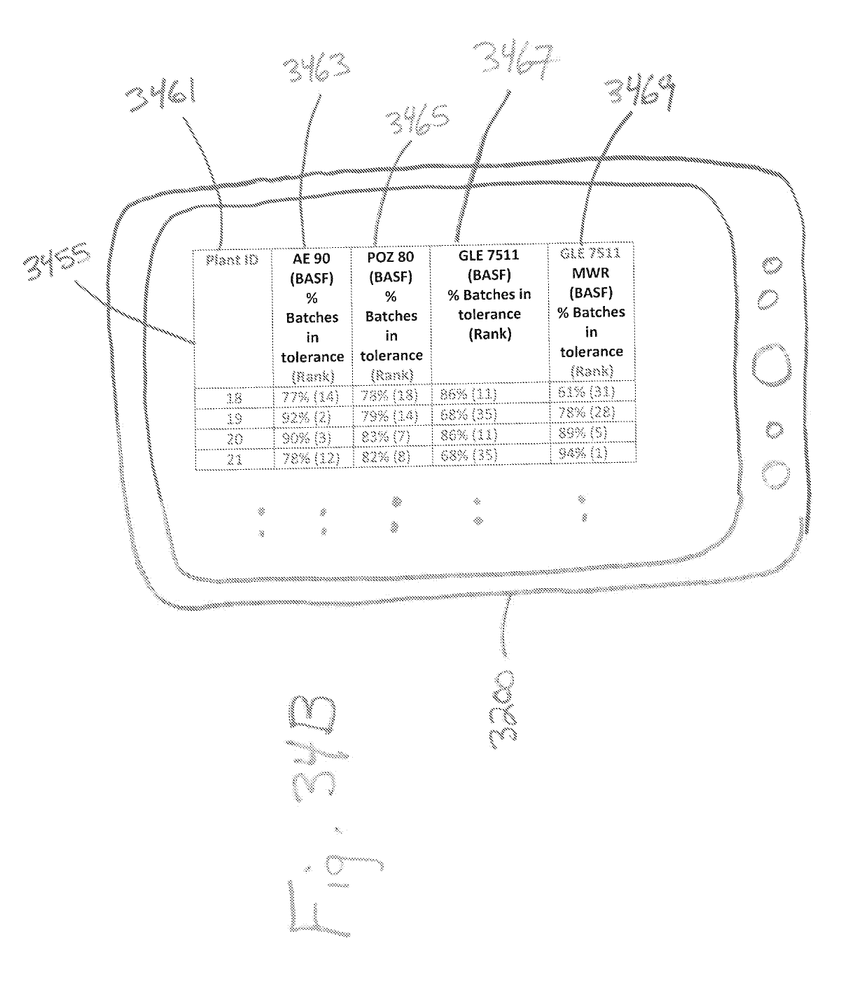

FIG. 33 is a flowchart of a method of providing statistical performance data for a plurality of production facilities in accordance with an embodiment. At step 3310, a request for information relating to a plurality of concrete production facilities is received from a user device. Master database module 11 receives the user's selection of button 3220.

At step 3320, a database storing information relating to a plurality of concrete production facilities is accessed. Master database module 11 retrieves performance data for a plurality of production facilities. Production facilities may be identified using any suitable identifier(s). In the illustrative embodiment, the production facilities are identified by identifiers 1, 2, 3, . . . .

At step 3330, for each respective concrete production facility among the plurality of concrete production facilities: (1) a first value indicating a percentage of batches of concrete that were produced at the respective concrete production facility and that contained an amount of a specified component that was within acceptable tolerances and (2) a second value indicating a ranking of the performance of the respective concrete production facility with respect to the plurality of concrete production facilities are determined, based on the first value, is determined. Master database 11 accordingly determines comparative performance data and benchmarks, including the first and second values of step 3330, in a manner similar to that described herein above. Master database module 11 may retrieve such data from memory or storage (e.g., a database). If necessary, master database module 11 calculates, for each production facility, a percentage of batches of concrete that were produced at the respective concrete production facility and that contained an amount of a specified component that was within acceptable tolerances and a ranking of the performance of the respective concrete production facility with respect to the plurality of concrete production facilities based on the percentage.

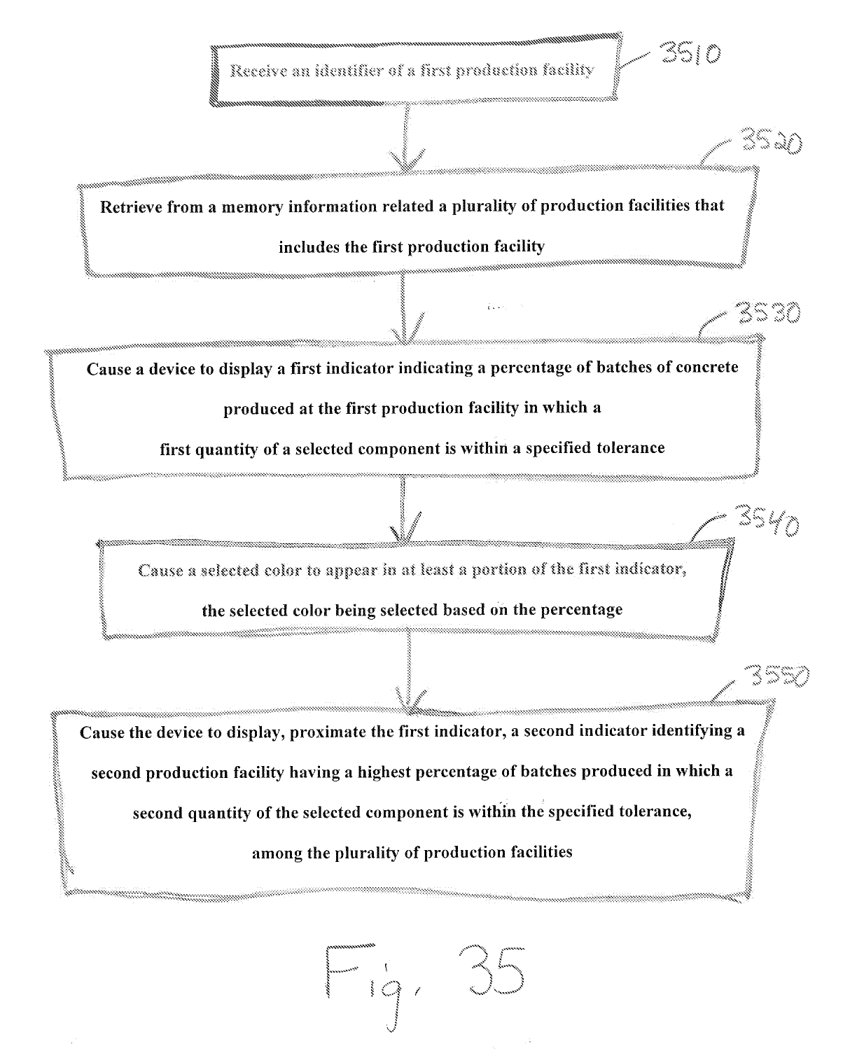

At step 3340, the user device is caused to display, for each respective concrete production facility among the plurality of concrete production facilities, the respective first value and the respective second value. Master database module 11 transmits the comparative performance data to user device 3200 and causes device 3200 to display the data. For example, the comparative performance data may be displayed on user device 3200 in the form of a table, as shown in FIG. 34A. Table 3450 includes a column 3401 which holds identifiers for various production facilities. Table 3450 also includes columns 3403, 3405, 3407, 3409, and 3411, which hold data indicating, for each respective production facility, a percentage of batches produced at the respective production facility that are within tolerances with respect to cement content, water content, cementitious content, course aggregate content, and fine aggregate content, respectively. The table may display information for any desired time period, such as one year, one month, one day, etc. For each component, a ranking of the respective plant among the plurality of plants with respect to the respective category is displayed in parentheses next to the corresponding percentage value. The time period may be selected automatically or by the user.

For example, referring to record 3415, the following performance data is associated with the production facility (Plant) identified by the identifier 18: in 81% of batches produced, cement content was within acceptable tolerances, and Plant 18 is ranked number 1 in this category; in 73% of batches, water content was within acceptable tolerances, and Plant 18 is ranked number 23 in this category; in 75% of batches, cementitious content was within acceptable tolerances, and Plant 18 is ranked number 17 in this category; in 90% of batches, course aggregate content was within acceptable tolerances, and Plant 18 is ranked number 1 in this category; in 64% of batches, fine aggregate content was within acceptable tolerances, and Plant 18 is ranked number 35 in this category.

In another embodiment, the comparative performance data with respect to one or more chemicals may be displayed on user device 3200. FIG. 34B shows a table showing comparative performance data displayed on a user device in accordance with an embodiment. Table 3455 includes a column 3461 which holds identifiers for various production facilities. Table 3455 also includes columns 3463, 3465, 3467, and 3469, which hold data indicating, for each respective production facility, a percentage of batches produced at the respective production facility that are within tolerances with respect to the chemicals known as AE 90, POZ 80, GLE 7511, and GLE 7511 MWR, respectively. The table may display information for any desired time period, such as one year, one month, one day, etc. For each component, a ranking of the respective plant among the plurality of plants with respect to the respective category is displayed in parentheses next to the corresponding percentage value. The time period may be selected automatically or by the user.

In accordance with another embodiment, comparative performance data for a single production facility with respect to a selected component may be displayed on a device. Suppose, for example, that the user now wishes to view the performance data for Plant 18 with respect to water content in more detail. The user accordingly returns to web page 3240 shown in FIG. 32 and selects button 3210 (“DATA—SINGLE PLANT”). Device 3200 generates a request and transmits the request, including the user's selection, to master database module 11.

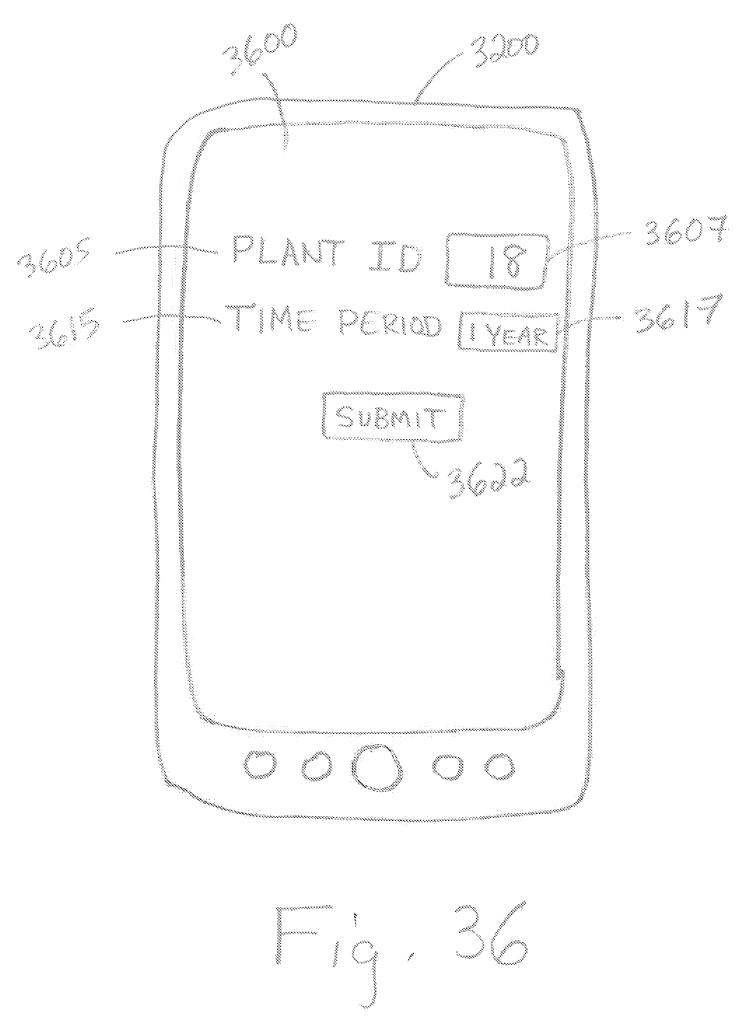

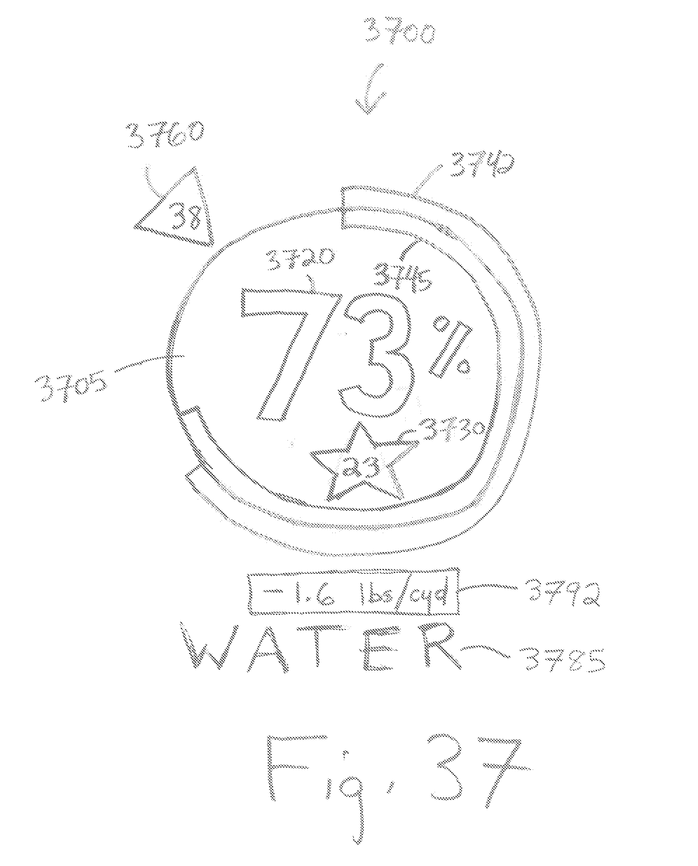

FIG. 35 is a flowchart of a method of providing comparative statistical data for one or more production facilities in accordance with an embodiment. Master database module 11 receives the request and the user's selection and, in response, causes a web page to be displayed on user device 3200. FIG. 36 shows a web page that may be displayed on a user device in accordance with an embodiment. Page 3600 includes a line 3605 prompting the user to provide an identifier of the desired plant (production facility), and a line 3615 prompting the user to specify a time period. The user enters a plant identifier in a field 3607 and a time period in a field 3617. In the illustrative embodiment, the user specifies Plant “18” and “1 YEAR.” The user may submit the information by selecting a SUBMIT button 3622. User device 3200 generates a request and transmits the request, including the user-provided information (including the plant identifier), to master database module 11.

At step 3510, an identifier of a first production facility is received. Master database module 11 receives the request, including the plant identifier provided by the user.

At step 3520, information related a plurality of production facilities that includes the first production facility is retrieved from a memory. Master database module 11 retrieves from memory or storage comparative statistical performance data for a plurality of production facilities, including data for the production facility associated with the specified plant identifier. For example, master database module 11 may retrieve such information from mixture database 801, or from another database.

At step 3530, a device is caused to display a first indicator indicating a percentage of batches of concrete produced at the first production facility in which a first quantity of a selected component is within a specified tolerance. The first indicator may be a graphical indicator, for example. Alternatively, the first indicator may include a graphical component and a numerical component.

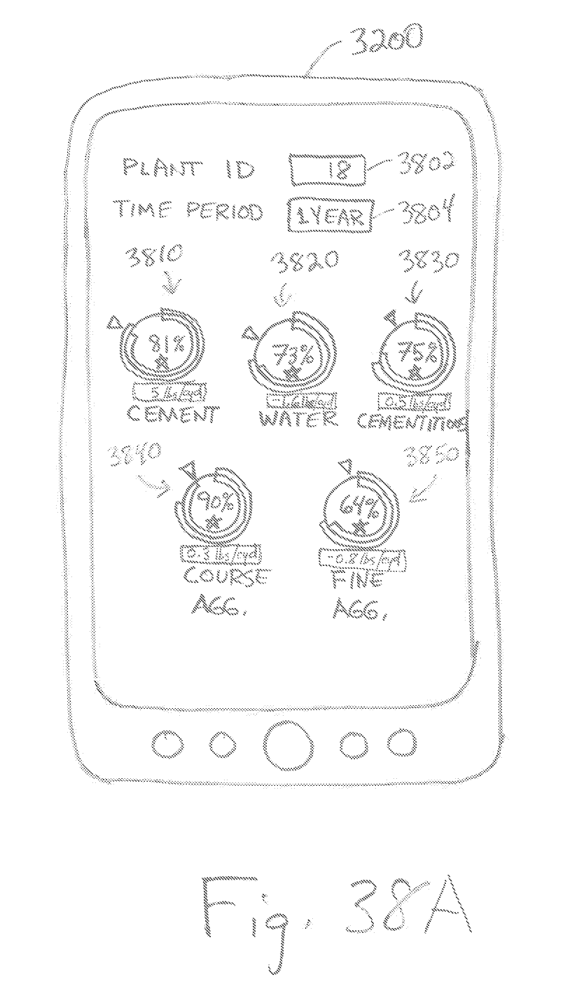

FIG. 37 shows an example of an indicator 3700 that may be displayed on a device (such as user device 3200) in accordance with an embodiment. Thus master database module 11 may cause device 3200 to display an indicator such as indicator 3700, for example, by transmitting one or more instructions to device 3200. Indicator 3700 includes a circular element 3705 which may be displayed in a selected color. Indicator 3700 also includes a percentage value 3720, which represents a percentage of batches produced at the specified plant in which the quantity of a selected component was within specified tolerances. Percentage value 3720 is overlaid on circular element 3705.

An indicator such as indicator 3700 may be used to display information related to performance with respect to any selected component. For illustrative purposes, indicator 3700 as shown in FIG. 37 shows performance data for Plant 18—specifically, data concerning the accuracy of water content in batches produced at Plant 18 during a specified one-year period. As indicated in record 3415 of Table 3450 (of FIG. 34), the accuracy of water content at Plant 18 during the one-year period is seventy-three percent (73%). Therefore, percentage value 3720 indicates seventy-three percent (73%).

At step 3540, a selected color is caused to appear in at least a portion of the first indicator, the selected color being selected based on the percentage. In the illustrative embodiment, master database module 11 selects the color of circular element 3705 based on the percentage value 3720, and causes device 3200 to change the color of circular element 3705 accordingly. For example, the color of circular element 3705 may be selected from among a first color (e.g., RED) associated with a first range of percentage values (e.g., 0%-20%), a second color (e.g., ORANGE) associated with a second range of percentage values (e.g., 21%-40%), a third color (e.g., YELLOW) associated with a third range of percentage values (e.g., 41%-60%), a fourth color (e.g., GREEN) associated with a fourth range of percentage values (e.g., 61%-80%), and a fifth color (e.g., BLUE) associated with a fifth range of percentage values (e.g., 81%-100%). Because the percentage value in the instant example is 73%, the color of circular element 3705 is set to the fourth color (GREEN).

In the illustrative embodiment, additional information is displayed graphically on or proximate to circular element 3705. For example, master database module 11 may cause device 3200 to display a first band 3745, which is overlaid circumferentially around the periphery of circular element 3705. First band 3745 extends around a portion of the circumference of circular element 3705 that corresponds to the percentage value 3720. Thus, for example, in FIG. 37, first band 3745 extends through seventy-three percent (73%) of the circumference of circular element 3705.

In the illustrative embodiment, a second band 3742 is displayed circumferentially on the periphery of element 3705, and graphically illustrates a percentage of batches produced the previous day at the specified plant in which the quantity of the selected component was within specified tolerances. In the illustrative embodiment, band 3742 is disposed at a larger radial distance than band 3745. In the illustrative embodiment, second band 3742 extends through a percentage of the circumference of circular element 3705 that corresponds to a percentage of batches produced the previous day at Plant 18 in which the quantity of water was within specified tolerances.

Another indicator 3730 is also overlaid on element 3705. In the illustrative embodiment, indicator 3730 includes a graphical component and a numerical component. Specifically, indicator 3730 has a shape of a star; however, other shapes may be used. Indicator 3730 displays a value indicating a ranking of the specified production facility's performance with respect to the selected component (as reflected by percentage value 3720) among the plurality of production facilities. As indicated in record 3415 of Table 3450 (of FIG. 34), Plant 18 is ranked twenty-third (23rd) in its accuracy with respect to the water content of batches produced. Accordingly, star-shaped indicator 3730 displays the value twenty-three (23).

Another indicator 3792 is displayed proximate circular element 3705. Indicator 3792 displays a value indicating the average difference (delta) between the actual quantity of the selected component in batches produced at the specified production facility and the quantity required by the mixture formula. In the illustrative embodiment, the average difference (delta) between the actual quantity of water in batches produced at Plant 18 and the quantity of water specified in the mixture formula is −1.6 lbs/cyd.

In another embodiment, an indicator indicating economic and cost information related to the performance of a production facilities may be displayed. For example, an indicator that indicates the cost to the producer or production facility associated with the delta value shown by indicator 3792 (shown in FIG. 37) may be displayed. In the illustrative example, an indicator may indicate the cost associated with the failure to ensure that the quantity of water in each batch is equal to the quantity specified in the mixture formula.

At step 3550, the device is caused to display, proximate the first indicator, a second indicator identifying a second production facility having a highest percentage of batches produced in which a second quantity of the selected component is within the specified tolerance, among the plurality of production facilities. In the illustrative embodiment, master database module 11 causes device 3200 to display a triangular indicator 3760 proximate circular element 3705. Indicator 3760 displays an identifier of a production facility that ranks highest in accuracy with respect to water content of batches produced. As indicated in Table 3450 of FIG. 34, Plant 38 ranks highest in this category. Accordingly, indicator 3760 displays the identifier ‘38’.

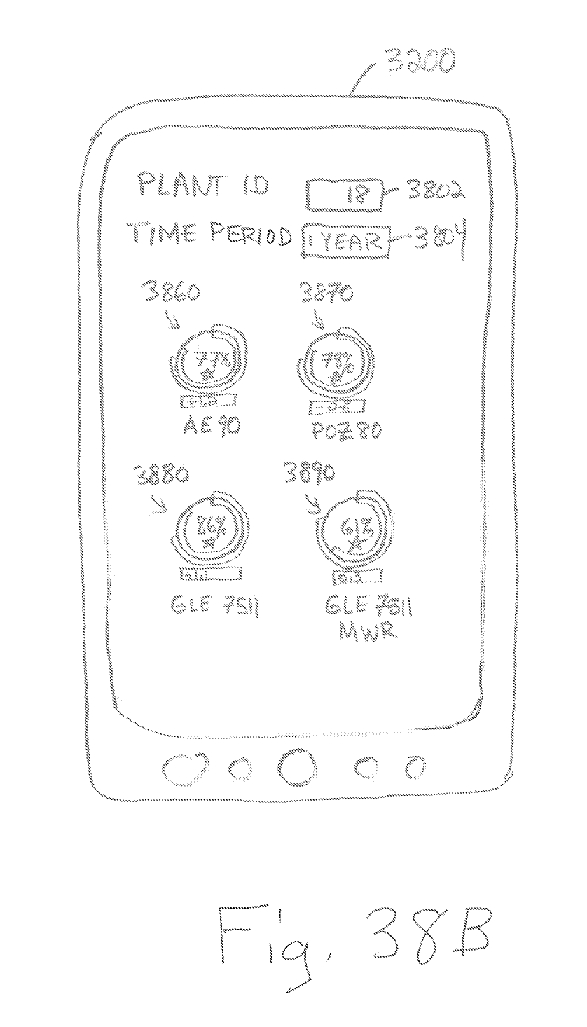

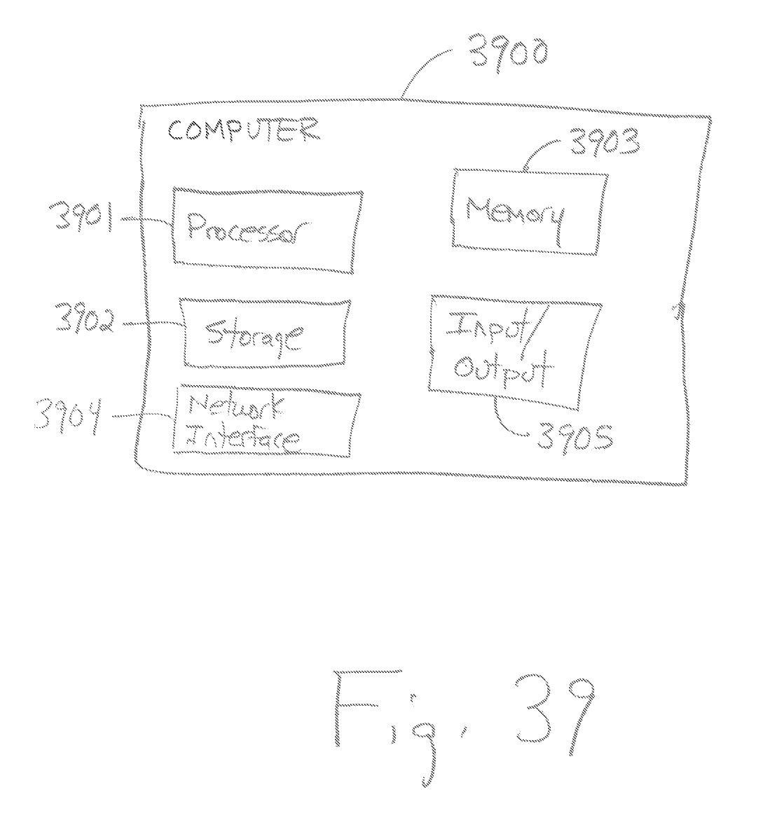

In one embodiment, in response to the request and identifier (specifying Plant 18) received at step 3510, master database module 11 causes user device 3200 to display, simultaneously, a plurality of indicators similar to that shown in FIG. 37, in order to illustrate graphically the statistical performance data for Plant 18 with respect to a plurality of components. FIG. 38A shows a plurality of indicators displayed on device 3200. Fields 3802 and 3804 indicate, respectively, that the displayed information relates to batches produced at Plant 18 and that the data pertains to a specified one-year period. Indicator 3810 displays information related to the accuracy of Plant 18 with respect to cement content in the batches produced. Indicator 3820 displays information related to the accuracy of Plant 18 with respect to water content in the batches produced. (Indicator 3820 is similar to indicator 3700 shown in FIG. 37). Indicator 3830 displays information related to the accuracy of Plant 18 with respect to cementitious content in the batches produced. Indicator 3840 displays information related to the accuracy of Plant 18 with respect to course aggregate content in the batches produced. Indicator 3850 displays information related to the accuracy of Plant 18 with respect to fine aggregate content in the batches produced.

Each of the indicators 3810, 3820, 3830, 3840, 3950 displays statistical performance data and comparative performance information analogous to the various items of information shown by various indicators illustrated in FIG. 37.

In another embodiment, a plurality of indicators similar to the indicator shown in FIG. 37 may be displayed on a user device in order to illustrate graphically the statistical performance data for Plant 18 with respect to a plurality of chemicals. FIG. 38B shows a plurality of indicators displayed on device 3200. Indicators 3860, 3870, 3880, 3990 display statistical performance data for Plant 18 with respect to the chemicals known as AE 90, POZ 80, GLE 7511, and GLE 7511 MWR.

In other embodiments, systems and methods described herein may be used to display indicators related to other chemicals and other materials.

In various embodiments, the method steps described herein, including the method steps described in FIGS. 2, 3, 4, 5, 6, 9, 12, 13A-13B, 16A-16B, 17, 18, 19A-19B, 22, 23, 30, 33, and/or 35, may be performed in an order different from the particular order described or shown. In other embodiments, other steps may be provided, or steps may be eliminated, from the described methods.

Systems, apparatus, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatus, and methods described herein may be implemented using computers operating in a client-server relationship. Typically, in such a system, the client computers are located remotely from the server computer and interact via a network. The client-server relationship may be defined and controlled by computer programs running on the respective client and server computers.

Systems, apparatus, and methods described herein may be used within a network-based cloud computing system. In such a network-based cloud computing system, a server or another processor that is connected to a network communicates with one or more client computers via a network. A client computer may communicate with the server via a network browser application residing and operating on the client computer, for example. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, to display specified data on a screen, etc.

Systems, apparatus, and methods described herein may be implemented using a computer program product tangibly embodied in an information carrier, e.g., in a non-transitory machine-readable storage device, for execution by a programmable processor; and the method steps described herein, including one or more of the steps of FIGS. 2, 3, 4, 5, 6, 9, 12, 13A-13B, 16A-16B, 17, 18, 19A-19B, 22, 23, 30, 33, and/or 35, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

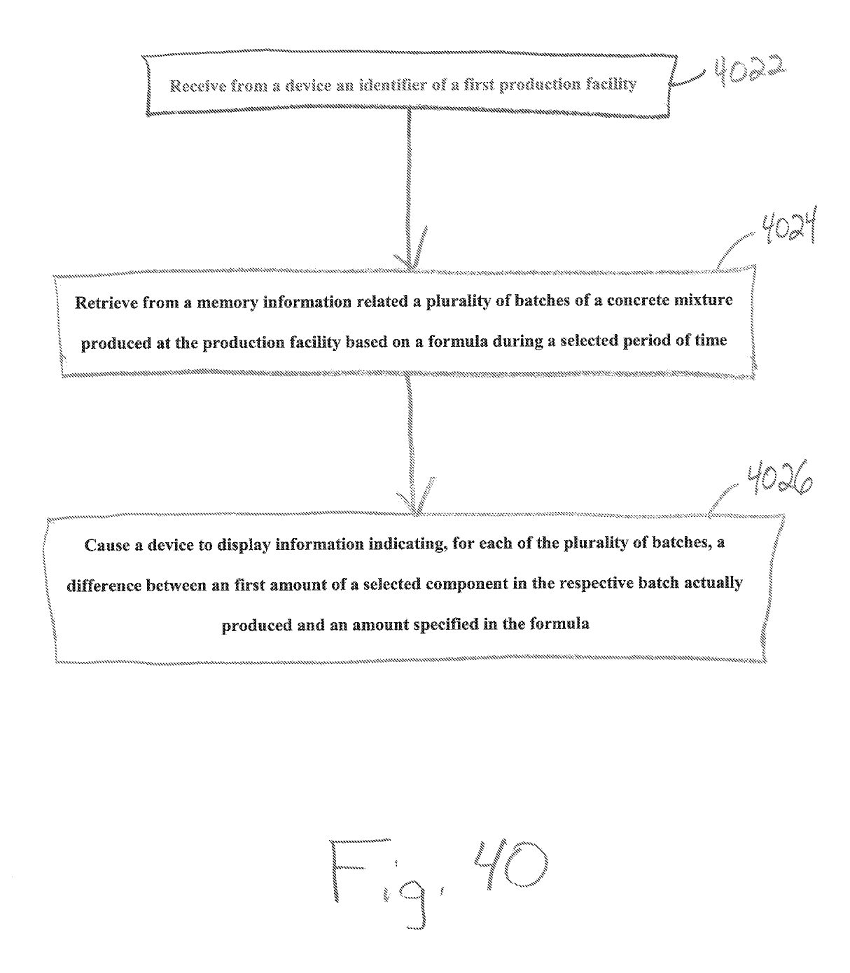

A high-level block diagram of an exemplary computer that may be used to implement systems, apparatus and methods described herein is illustrated in FIG. 39. Computer 3900 includes a processor 3901 operatively coupled to a data storage device 3902 and a memory 3903. Processor 3901 controls the overall operation of computer 3900 by executing computer program instructions that define such operations. The computer program instructions may be stored in data storage device 3902, or other computer readable medium, and loaded into memory 3903 when execution of the computer program instructions is desired. Thus, the method steps of FIG. 2, 3, 4, 5, 6, 9, 12, 13A-13B, 16A-16B, 17, 18, 19A-19B, 22, 23, 30, 33, and/or 35 can be defined by the computer program instructions stored in memory 3903 and/or data storage device 3902 and controlled by the processor 3901 executing the computer program instructions. For example, the computer program instructions can be implemented as computer executable code programmed by one skilled in the art to perform an algorithm defined by the method steps of FIGS. 2, 3, 4, 5, 6, 9, 12, 13A-13B, 16A-16B, 17, 18, 19A-19B, 22, 23, 30, 33, and/or 35. Accordingly, by executing the computer program instructions, the processor 3901 executes an algorithm defined by the method steps of FIGS. 2, 3, 4, 5, 6, 9, 12, 13A-13B, 16A-16B, 17, 18, 19A-19B, 22, 23, 30, 33, and/or 35. Computer 3900 also includes one or more network interfaces 3904 for communicating with other devices via a network. Computer 3900 also includes one or more input/output devices 3905 that enable user interaction with computer 3900 (e.g., display, keyboard, mouse, speakers, buttons, etc.).

Processor 3901 may include both general and special purpose microprocessors, and may be the sole processor or one of multiple processors of computer 3900. Processor 3901 may include one or more central processing units (CPUs), for example. Processor 3901, data storage device 3902, and/or memory 3903 may include, be supplemented by, or incorporated in, one or more application-specific integrated circuits (ASICs) and/or one or more field programmable gate arrays (FPGAs).

Data storage device 3902 and memory 3903 each include a tangible non-transitory computer readable storage medium. Data storage device 3902, and memory 3903, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 3905 may include peripherals, such as a printer, scanner, display screen, etc. For example, input/output devices 3905 may include a display device such as a cathode ray tube (CRT) or liquid crystal display (LCD) monitor for displaying information to the user, a keyboard, and a pointing device such as a mouse or a trackball by which the user can provide input to computer 3900.

Any or all of the systems and apparatus discussed herein, including master database module 11, input module 12, sales module 13, production module 14, transport module 15, site module 16, alert module 17, purchase module 18, localization module 19, comparison module 1520, cloud database 1530, user devices 1540 and 3200, and components thereof, including mixture database 801 and local factors database 802, for example, may be implemented using a computer such as computer 3900.

One skilled in the art will recognize that an implementation of an actual computer or computer system may have other structures and may contain other components as well, and that FIG. 39 is a high level representation of some of the components of such a computer for illustrative purposes.

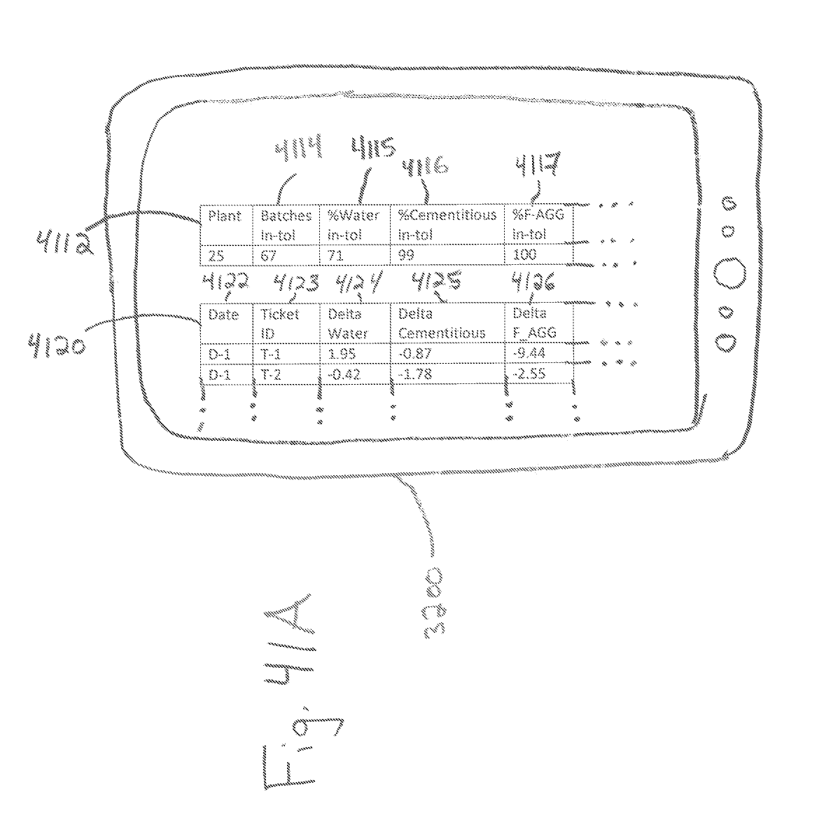

FIG. 40 is a flowchart of a method in accordance with another embodiment. At step 4022, an identifier of a production facility is received from a device. In a manner similar to that described above with reference to FIG. 36, a user may enter a plant identifier into user device 3200 and submit the information by selecting a SUBMIT button. User device 3200 generates a request and transmits the request, including the user-provided information (including the plant identifier), to master database module 11. Master database module 11 receives the request, including the plant identifier provided by the user.

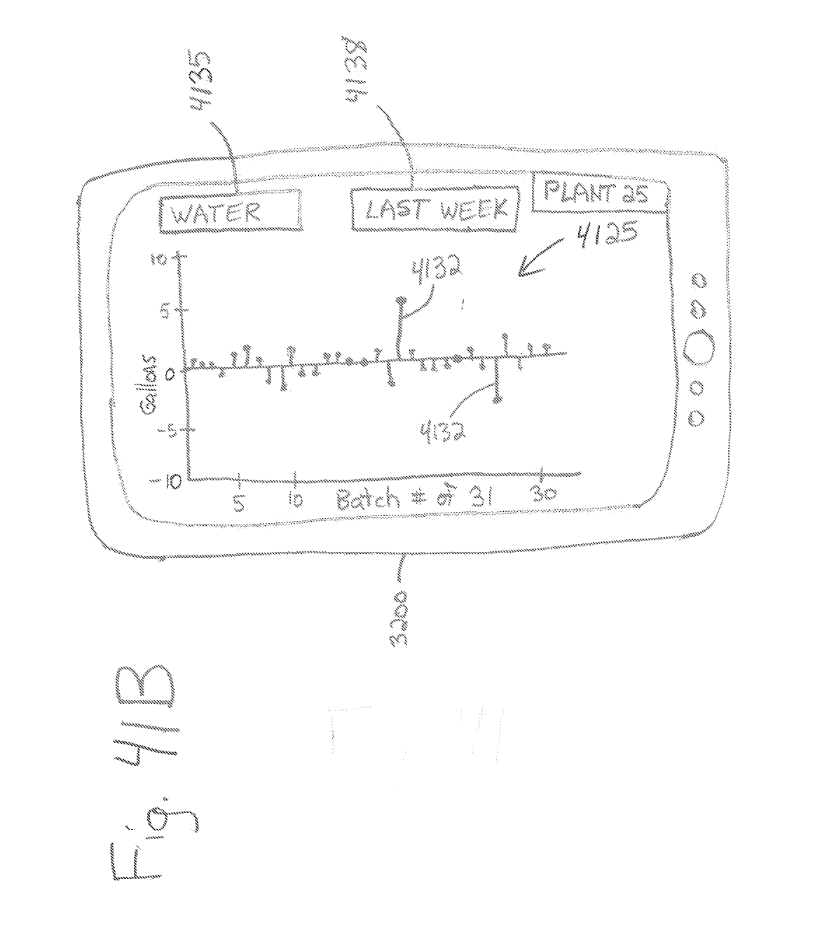

At step 4024, information related to a plurality of batches of a concrete mixture produced at the production facility based on a formula during a selected period of time is retrieved from a memory. Master database module 11 retrieves information relating to the production of various batches at the identified production facility, and provides it to the user in any one of a variety of formats. Referring to FIG. 41, for example, master database module 11 may cause user device 3200 to display a page such as that shown in FIG. 41A. User device 3200 displays a first table 4112 that displays information concerning production at the production facility identified as “Plant 25.” User device 3200 displays a field 4109 in which the user may select a time period for which information is desired (e.g., TODAY, LAST WEEK, LAST MONTH, etc.). In the illustrative embodiment, information relating to batches produced during the last week is shown. Table 4112 includes a column 4114 that includes information indicating how many batches produced at the plant were within tolerances, a column 4115 that includes information indicating a percentage of batches in which the water content was within tolerances, a column 4116 that includes information indicating a percentage of batches in which the cementitious content was within tolerances, and a column 4117 that includes information indicating a percentage of batches in which the fine aggregate content was within tolerances. Performance data for other components may be displayed.

At step 4026, a device is caused to display information indicating, for each of the plurality of batches, a difference between a first amount of a selected component in the respective batch actually produced and an amount specified in the formula. User device 3200 also displays a second table 4120 which shows data pertaining to various batches produced at the production facility. Table 4120 includes a column 4122 indicating the date on which a particular batch was produced, a column 4123 indicating the associated ticket identifier, a column 4124 indicating a delta-water for the respective batch (the difference between the water content in the batch produced and the theoretical quantity of water specified in the formula), a column 4125 indicating the delta-cementitious for the respective batch, and a column 4126 indicating the delta-fine-aggregate for the respective batch. Information relating to other components in the batch may also be displayed.

Performance data for various batches produced at a production facility may also be shown graphically. FIG. 41B shows a user device on which performance data for a production facility is shown in the form of a graph. Graph 4125 shows the delta-water data for various batches produced at the production facility identified as Plant 25 during a specified period of time. A field 4135 allows the user to select a component (water, cementitious, etc.) for which data is desired. A field 4138 allows the user to specify a time period (e.g., TODAY, LAST WEEK, LAST MONTH) for which data is desired.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method of providing information to a user, the method comprising:
receiving, by a processor, an identifier of a first production facility;
retrieving from a memory information related a plurality of production facilities that includes the first production facility;
causing, by the processor, a device to display a first indicator indicating a percentage of batches of concrete produced at the first production facility in which a first quantity of a selected component is within a specified tolerance;
causing a selected color to appear in at least a portion of the first indicator, the selected color being selected based on the percentage; and
causing the device to display, proximate the first indicator, a second indicator identifying a second production facility having a highest percentage of batches produced in which a second quantity of the selected component is within the specified tolerance, among the plurality of production facilities.

2. The method of claim 1, further comprising:
prompting a user, via a page displayed on the device, to enter the identifier of the first production facility; and
receiving, from the device, via a network, the identifier of the first production facility.

3. The method of claim 1, wherein the plurality of production facilities comprises a plurality of plants that produce concrete.

4. The method of claim 1, wherein the first indicator comprises a circular element and a numerical value overlaid on the circular element, the numerical value being equal to the percentage.

5. The method of claim 4, further comprising:
causing the device to display a third indicator that displays the percentage in a graphical manner, the third indicator comprising a band overlaid around a periphery of the circular element.

6. The method of claim 5, further comprising:
causing the device to display a fourth indicator comprising a ranking of the first production facility among the plurality of production facilities, based on the percentage.

7. The method of claim 6, further comprising:
causing the device to display a fifth indicator indicating a percentage of batches of concrete produced at the first production facility, during a previous day, in which the first quantity of the selected component is within the specified tolerance.

8. The method of claim 1, further comprising:
for each of a plurality of components:
causing, by the processor, the device to display a respective first indicator indicating a respective percentage of batches of concrete produced at the first production facility in which a respective first quantity of the respective component is within a respective tolerance;
causing a respective selected color to appear in at least a portion of the respective first indicator, the respective selected color being selected based on the respective percentage; and
causing the device to display, proximate the respective first indicator, a respective second indicator identifying a respective second production facility having a respective highest percentage of batches produced in which a respective second quantity of the respective selected component is within the respective tolerance, among the plurality of production facilities.

9. The method of claim 1, wherein the selected component is one of cement, water, cementitious, course aggregate, and fine aggregate.

10. The method of claim 1, further comprising:
selecting the selected color from among:
a first color is associated with a first range of percentages; and
a second color is associated with a second range of percentages.

11. A system for providing information to a user, the system comprising:
a memory adapted to store information related to a plurality of production facilities that include the first production facility; and
a processor adapted to:
receive an identifier of the first production facility;
retrieve from the memory information related to the plurality of production facilities;
cause a user device to display a first indicator indicating a percentage of batches of concrete produced at the first production facility in which a first quantity of a selected component is within a specified tolerance;
cause a selected color to appear in at least a portion of the first indicator, the selected color being selected based on the percentage; and
cause the user device to display, proximate the first indicator, a second indicator identifying a second production facility having a highest percentage of batches produced in which a second quantity of the selected component is within the specified tolerance, among the plurality of production facilities.

12. The system of claim 11, wherein the processor is further adapted to:
prompt a user, via a page displayed on the user device, to enter the identifier of the first production facility; and
receive, from the user device, the identifier of the first production facility.

13. The system of claim 11, wherein the plurality of production facilities comprises a plurality of plants that produce concrete.

14. The system of claim 11, wherein the first indicator comprises a circular element and a numerical value overlaid on the circular element, the numerical value being equal to the percentage.

15. The system of claim 14, wherein the processor is further adapted to:
cause the user device to display a third indicator that displays the percentage in a graphical manner, the third indicator comprising a band overlaid around a periphery of the circular element.

16. The system of claim 15, wherein the processor is further adapted to:
cause the user device to display a fourth indicator indicating a ranking of the first production facility among the plurality of production facilities, based on the percentage.

17. The system of claim 16, wherein the processor is further adapted to:
cause the user device to display a fifth indicator indicating a percentage of batches of concrete produced at the first production facility, during a previous day, in which the first quantity of the selected component is within the specified tolerance.

18. The system of claim 11, wherein the processor is further adapted to:
for each of a plurality of components:
cause the user device to display a respective first indicator indicating a respective percentage of batches of concrete produced at the first production facility in which a respective first quantity of the respective component is within a respective tolerance;
cause a respective selected color to appear in at least a portion of the respective first indicator, the respective selected color being selected based on the respective percentage; and
cause the user device to display, proximate the respective first indicator, a respective second indicator identifying a respective second production facility having a respective highest percentage of batches produced in which a respective second quantity of the respective selected component is within the respective tolerance, among the plurality of production facilities.

19. The system of claim 11, wherein the selected component is one of cement, water, cementitious, course aggregate, and fine aggregate.

20. The system of claim 11, wherein the processor is further adapted to:
select the selected color from among:
a first color is associated with a first range of percentages; and
a second color is associated with a second range of percentages.

21. A method comprising:
receive an identifier of a production facility from a device;
retrieve information related to a plurality of batches of a concrete mixture produced at the production facility based on a formula during a selected period of time; and
cause the device to display information indicating, for each of the plurality of batches, a difference between a first amount of a selected component in the respective batch actually produced and an amount specified in the formula.
